(19) United States
(12) Patent Application Publication
(10) Pub. No.: US 2026/0253955 A1
(43) Pub. Date: Aug. 27, 2026

(54) PHENYL-BASED CHALCOGENIDE REDOX MEDIATORS FOR LITHIUM-SULFUR BATTERIES

(71) Applicant: Lyten, Inc., San Jose, CA (US)

(72) Inventors: Kiran Mahankali, Milpitas, CA (US); Sanjay Nanda, San Francisco, CA (US); Jared Long, Sunnyvale, CA (US)

(21) Appl. No.: 19/643,630

(22) Filed: Apr. 9, 2026

Related U.S. Application Data
(63) Continuation-in-part of application No. 18/765,011, filed on Jul. 5, 2024.
(60) Provisional application No. 63/562,167, filed on Mar. 6, 2024.

(51) Int. Cl. H01M 10/0567; H01M 10/052; H01M 10/0569

(52) U.S. Cl. CPC H01M 10/0567; H01M 10/052; H01M 10/0569; H01M 2300/0037

(57) ABSTRACT

Electrolyte systems for lithium-based batteries address challenges including polysulfide shuttling, lithium dendrite formation, and strict electrolyte composition requirements through improved solvents, electron withdrawing compounds, lithium ion-transporting compounds, and performance enhancing additives. The electrolyte systems further incorporate phenyl-based chalcogenide compounds, including Diphenyl sulfide, Diphenyl diselenide, and Diphenyl ditelluride, as redox mediators having redox potentials proximate to the Li-S redox potential. The redox mediators undergo reduction at the cathode surface and diffuse through the electrolyte to mediate electron transfer to lithium polysulfides not in direct contact with conductive surfaces, facilitating conversion to Li2S and improving active material utilization. Diphenyl ditelluride demonstrates superior capacity enhancement across discharge rates from 0.1 C to 1 C. These developments provide synergistic benefits including improved charge/discharge capacity, Coulombic efficiency, cycle life, and sulfur utilization while reducing polysulfide shuttling and lithium dendrite formation.

### RELATED APPLICATIONS

The present application is a continuation-in-part of, and claims priority to U.S. patent application Ser. No. 18/765,011, filed Jul. 5, 2024, and entitled “ELECTROLYTE SYSTEMS INCLUDING ELECTRON WITHDRAWING COMPOUNDS WITH AN ALPHA-BETA MOTIF FOR IMPROVING PERFORMANCE OF LITHIUM-BASED SECONDARY BATTERIES”, which in turn is related, and claims priority to, U.S. Provisional Patent Application No. 63/562,167, filed Mar. 6, 2024 and entitled “ELECTROLYTE ADDITIVE FOR IMPROVING PERFORMANCE AND CYCLE LIFE OF LITHIUM-BASED SECONDARY BATTERIES”, the contents of all of which are herein incorporated by reference in their entirety.

### FIELD OF THE INVENTION

The present invention relates to battery technology, and more particularly to novel electrolyte compositions including various components such as solvents, electron withdrawing compounds, and/or additives that, singly or in any combination thereof, reduce cost and complexity of fabrication, as well as having lower mass, higher energy density, and longer cycle life of lithium-based electrochemical cells. Exemplary components include, but are not limited to, chalcogenides, alpha-hydrogenated, selectively beta-functionalized compounds, and/or additive(s).

### BACKGROUND

Batteries, particularly lithium-based batteries, remain of focused interest due to the high theoretical specific energy, low mass, low cost, and other advantages that are well documented in the art. However, issues such as polysulfide shuttling, formation of lithium dendrites and dead lithium during stripping and plating, thermal runaway, volumetric expansion, and strict requirements for electrolyte composition remain challenges for wide scale implementation of lithium-based batteries in diverse applications.

For reasons that are well-known to those having ordinary skill in the art, solvents in lithium-based, particularly lithium-sulfur-based, batteries have more stringent requirements than other battery chemistries, including but not limited to having (1) reductive stability with respect to lithium metal and lithium alloys, which limits suitable solvents to those having a high lowest unoccupied molecular orbital (LUMO) and a low donor number, typically about 1.8V or less; (2) robust oxidative stability against the cathode material (typically a sulfur-based or carbon-based material), which excludes compounds that have a high (about 2.45V or more) highest occupied molecular orbital (HOMO) and is generally accomplished by highly fluorinating solvent components; (3) robust capability to form a solvent/electrolyte interface (SEI), e.g., by forming LiF, Li₃N, and/or Li₂O on surfaces of the anode; (4) a finely-tuned balance between solvation power of the electrolyte toward lithium polysulfides generally versus solvation power of the electrolyte toward the particular species of lithium polysulfide that is/are formed in the electrolyte, which is conventionally achieved by encouraging formation of long chain (e.g., Li₂S₈) over short chain (e.g., Li₂S₂, Li₂S₄, Li₂S₃, etc.) lithium polysulfides in order to ease the pathway to elemental sulfur; (5) high capability to solvate lithium salts (especially lithium nitrate, an important additive for marrying reducing lithium metal with oxidizing polysulfides); (6) low density to minimize the percentage of the battery's weight conferred by the electrolyte; (7) high boiling point (for safety and ease of manufacturing as discussed briefly above); and (8) avoidance of electrophiles (for example carbonates as commonly used in Li-ion batteries) to avoid strong nucleophilic reaction with polysulfides.

As a result of these stringent requirements, typical solvent systems used in lithium-based batteries include at least two solvents (one of which acts as a solvating agent, while the other acts as a diluent), and possibly additional components such as lithium salts, redox mediators, etc., which in turn increases the solvent's contribution to overall battery weight. This exacerbates concerns with fabrication as well as detriments overall efficiency of the battery in use. Moreover, the low boiling point of solvents typically used in lithium-based batteries raises safety concerns due to propensity for flammability or explosiveness, which may be caused by short circuits formed in the battery during use.

In addition, and as is well-known in the art, lithium-based, and particularly lithium-sulfur-based battery chemistry involves the formation of parasitic reactions between the lithium active material of the anode with the sulfur due to the formation of lithium polysulfides. These reactions effectively reduce the amount of active electrode material for the electrochemical cell to perform electrical work, and detrimentally impacts the overall performance (especially energy efficiency) of batteries based on such lithium chemistries. In particular, the practical limits observed for lithium-based, and particularly lithium-sulfur-based batteries are attributed to kinetic limitations of reduction-oxidation (redox) reactions that convert lithium (poly)sulfides from liquid to solid phase and eventually back into elemental lithium. The principal mechanisms for conversion of lithium polysulfides into elemental lithium are presented below in Equations 0 and 1(a)-(d). Moreover, as known in the art, kinetics of solid-solid phase reactions tend to be slower than liquid-solid phase reactions, which tend to be slower than liquid-liquid phase interactions. Accordingly, the rate limiting processes for converting lithium polysulfides tend to be those shown in Equations 1(c) and 1(d).

$${S}_{8 ( s )} \to {Li}_{2} {S}_{8 ( s )} \qquad Eqn . 0$$

$${Li}_{2} {S}_{8 ( s )} + Li \to {Li}_{2} {S}_{6 ( l )} \qquad Eqn . 1 ( a )$$

$${Li}_{2} {S}_{6 ( l )} + Li \to {Li}_{2} {S}_{4 ( l )} \qquad Eqn . 1 ( b )$$

$${Li}_{2} {S}_{4 ( l )} + Li \to {Li}_{2} {S}_{2 ( s )} \qquad Eqn . 1 ( c )$$

$${Li}_{2} {S}_{4 ( l )} + Li \to {Li}_{2} {S}_{( s )} \qquad Eqn . 1 ( d )$$

Mitigating the negative impacts of such parasitic reactions lithium polysulfide conversion of polysulfides into pure lithium is therefore an important obstacle to achieving the ideal performance capabilities presented by lithium-based battery technology.

Conventional approaches to improving specific energy and/or energy density of lithium-based batteries, especially lithium-sulfur batteries, have focused on optimization of the structure and composition of the sulfur-based cathode, adjusting amount of electrolyte used in the electrochemical cell, using well-structured carbon frameworks to improve volumetric energy density, optimizing pore framework geometry to improve sulfur loading within the electrochemical cell, and including additives in the electrolyte to mitigate polysulfide dissolution within the electrochemical cell during cycling.

Focusing on electrolyte composition, Zhao, et al. recently investigated use of chalcogenides (compounds including a chalcogen component such as sulfur, selenium, tellurium, etc., and an electropositive component, as known in the art) as redox comediators to facilitate sulfur redox kinetics in lithium-sulfur batteries. In “An Organoselenide Comediator to Facilitate Sulfur Redox Kinetics in Lithium-Sulfur Batteries” Adv. Mater., 2007798 (2021), Zhao reported including diphenyl diselenide (DPDSe) in an otherwise conventional electrolyte system including 1:1 (v:v) 1,2-dimethoxyethane (DME) and 1,3-dioxolane (DOL) as solvents, 1M lithium bis(trifluoromethane)sulfonimide (LiTFSI) and 2.0 wt % lithium nitrate (LiNO₃) as lithium ion sources, 100 mM DPDSe as a redox comediator. The resulting Li-S electrochemical cells exhibited a rate performance of 817 mAh/g at 2 C and an actual initial energy density of 301 Wh/kg, but were only stable for 30 cycles. Loss of stability is defined as the point (cycle number) at which the cell exhibits 60% or less of initial capacity.

In “Promoting the sulfur redox kinetics by mixed organodiselenides in high-energy-density lithium-sulfur batteries” eScience 1: 44-52 (2021), Zhao reported a similar electrolyte system, but included a mixture of dimethyl diselenide (DMDSe) and DPDSe as the redox comediator. The resulting Li-S pouch cells exhibited capacity retention of 81.6% after 200 cycles at 0.5 C and high initial capacity of 1002 mAh g-1 at 0.1 C with sulfur-loading of about 1.2 mg/cm². At higher loadings, e.g. about 4.9 mg/cm² up to about 6.1 mg/cm², stability is retained for up to 50 cycles (Zhao did not report stability beyond this cycle for the higher loaded embodiments).

Liu, et al., in “An Organodiselenide Comediator to Facilitate Sulfur Redox Kinetics in Lithium-Sulfur Batteries with Encapsulating Lithium Polysulfide Electrolyte” Angewandte Chemi Inter. 62:30 (2023) built on Zhao's work by implementing an electrolyte system that includes 20 mM DMDSe as a redox comediator and a solvent mixture of DME/DOL/1,1,2,2-tetrafluoroethyl 2,2,3,3-tetrafluoropropyl ether (TTE) in volumetric amounts (v/v/v) of 2:2:1, as well as 1M LiTFSi and 2 wt % LiNO3 as lithium ion sources. The cells were characterized by a sulfur loading of 4.0 g/cm2. The DME/DOL/TTE solvent system formed an encapsulating lithium polysulfide electrolyte (EPSE) structure, which alleviated parasitic reactions between lithium polysulfides and the lithium metal anode, but as is known in the art, inevitably also sacrificed cathode sulfur redox kinetics due to the barrier of the outer solvation shell formed by hydrofluoroethers and other outer shell solvents. In addition, the discharge capacity of Liu's cell was sacrificed about 65 mAh/g for the first cycle, and was maintained for 40 cycles (at which point the test was ceased due to failure of the control cell). Liu's cells also were only capable of being charged at up to 0.2 C, above which average discharge capacity was inferior (less than half) to that of the control. Thus, the discharge capacity and the rate performance are sacrificed in Liu's electrolyte, despite improved cycling stability. Overall, Liu reported similar results as Zhao's initial publication, i.e., a Li—S pouch cell with an actual energy density of 359 Wh/kg and stable lifetime of only 37 cycles.

Accordingly, prior art attempts to improve sulfur utilization within lithium-based electrochemical cells by including chalcogenide in the electrolyte formulation suffer from low cycle life (e.g., about 20-50 cycles or less, particularly at sulfur loading of 4.0 g/cm² or more) and low charge rate (e.g. about 0.5 C, typically lower than 0.3 C, and as low as 0.025 C), discharge rate and rate performance (especially when including hydrofluoroether or other similar electron withdrawing compound(s) as described herein or as would be appreciated by a person having ordinary skill in the art upon reading the present disclosure in the solvent component of the electrolyte system).

As such, there is thus a long-felt and ongoing need for improved electrolyte compositions to address the above, and/or other issues associated with the prior art.

### SUMMARY

Compositions of matter, suitable systems implementing said compositions of matter, methods of fabricating such compositions of matter and corresponding systems, as well as various applications for improving, among other characteristics, Coulombic efficiency and cycle life of lithium-based, particularly lithium-sulfur, secondary batteries are disclosed according to various aspects, implementations, and embodiments of the inventive concepts presented herein.

Generally, according to select embodiments, the inventive concepts include electrolyte systems, as well as techniques for making and using electrolyte systems, which include: (1) a solvent system, (2) at least one electron withdrawing compound, (3) one or more lithium ion-transporting compounds, (4) at least one chalcogenide, and/or (5) one or more performance-enhancing additives configured to improve Coulombic efficiency and cycle life of batteries in which the electrolyte system are implemented. Moreover, the electrolyte system generally satisfies the stringent requirements set forth above to optimize operational characteristics while minimizing weight and environmental impact of fabrication and use.

The solvent system may include multiple components serving distinct but related functions, such as solvation capability, dilution (for improved wettability), or to facilitate certain chemical reactions within the electrolyte system, especially redox reactions converting polysulfides into lower redox states and/or elemental lithium.

These components may be selected from the exemplary species described herein, and may be present in any amount suitable to enable a working electrochemical cell, e.g., up to about 100 vol % of the electrolyte system composition, with other components such as lithium ion-transporting compounds and/or performance-enhancing additives being partially or completely solvated therein. Preferably, the components are present in an amount suitable to enable a working electrochemical cell having an anode comprising lithium or a lithium-based material as the active material.

In various approaches, the solvent(s) and electron withdrawing compound(s) may respectively be cumulatively present in amounts ranging from a nonzero amount of up to about 75 vol %. By “cumulatively present”, it is meant that multiple species of a given type of component are present in the cumulative amount stated. For instance, a combination of three different species of solvent may be present in respective amounts of about 5 vol %, about 5 vol %, and about 15 vol % for a cumulative amount of 25 vol % of solvent.

The lithium ion-transporting compound(s) may be cumulatively present in an amount ranging from about 0.1 M to about 10 M, or any value therebetween, according to various embodiments.

The performance-enhancing additive(s), in different implementations, may be cumulatively present in a nonzero amount ranging up to about 0.2 M

The solvent system may include a single solvent or a combination of solvents, which may be independently characterized by different solvating capabilities, according to select approaches. For example, illustrative solvent systems may include a first solvent that has a high solvating capability for salts, such as lithium ion-transporting compounds described herein, while a second solvent may have low solvating activity for lithium ion-transporting compounds, but a high solvating activity for other compounds, such as polar, nonpolar, aqueous, organic, etc. compounds.

Furthermore, combinations of solvents may include multiple solvents with similar solvating capabilities and/or activities, especially where such solvents may act cooperatively or synergistically to solvate appropriate solutes, as would be understood by those having ordinary skill in the art upon reading the present disclosure.

Further still, particular solvent(s) included in a given solvent system may be chosen based on the particular application for the intended electrochemical cell, based on the composition of other components of the electrolyte system, based on the composition of other components of the electrochemical cell (such as the anode, cathode, and/or separator), or other factors as would be understood by those having ordinary skill in the art upon reading the present disclosure.

According to various implementations, suitable solvents may be selected from exemplars such as: dimethoxyethane (DME), dioxolane (DOL), dimethyl sulfoxide (DMSO), dimethyl formamide (DMF), toluene, tetramethyl urea (TMU), tetrabutylammonium hydroxide (TBA), dimethylacetamide (DMA), tetrahydrofuran (THF), diethylene glycol dimethyl ether (diglyme or DEGDME), acetonitrile (ACN), dimethyl trisulfide (DMTS), diisopropyl ether (DIPE), tetrahydrofuran (THF), 1,2-diaminopropane (DAP), triethylene glycol dimethyl ether (Triglyme/trigDME), tetraethylene glycol dimethyl ether (Tetraglyme/TEGDME), sulfolane (SUL), methyl tert-butyl ether (MTBE), 2,2,3,3-tetrafluoro-1,4-dimethoxybutane (FDMB), bis(2,2,2, trifluoroethyl) ether (BTFE), 1H,1H,5H-octafluoropentyl 1,1,2,2-tetrafluoroethyl ether (OFE), (1,1,2,2-tetrafluoroethyl 2,2,3,3-tetrafluoropropyl ether (TTE), 2,2,2-trifluoroethyl 1,1,2,2-tetrafluoroethyl ether (TFETFE), 1,1,2,2-tetrafluoroethyl isobutyl ether (TFEIE), 1,1,2,3,3,3-hexafluoropropyl 2,2,2-trifluoroethyl ether (THE), methoxyperfluorobutane (MPB), bis(2,2-difluoroethyl) ether (DFE), 2,2,2-trifluoroethyl methyl ether (TFEME), bis(2-fluoroethyl) ether (BFE), bis(2,2,2, trifluoroethyl) ether (BTFE), 3-fluoropyridine (3FP), 1,2-(1,1,2,2-tetrafluoroethoxy) ethane (TFEE), 1,2-dimethoxy-1,1,2,2-tetrafluoroethane (DMETF), 2-methyl-1(1,1,2,2-tetrafluoroethoxy) propane (TFEIBE), bis(2,2,3,3,3-pentafluoropropyl) ether (BPFPE), allyl 2,2,3,3,3-pentafluoropropyl ether (APFPE), hydrocarbons such as toluene, benzene, hexane(s), or any combination or equivalent(s) thereof that would be appreciated by skilled artisans upon reading the present disclosure.

According to various exemplary embodiments, the solvent(s) may be cumulatively present in an amount of about 1 vol %, about 2.5 vol %, about 3.33 vol %, about 5 vol %, about 6.66 vol %, about 7.5 vol %, about 10 vol %, about 12.5 vol %, about 15 vol %, about 17.5 vol %, about 20 vol %, about 25 vol %, about 30 vol %, about 33 vol %, about 35 vol %, about 40 vol %, about 50 vol %, about 60 vol %, about 66.6 vol %, about 70 vol %, or about 75 vol %.

The electrolyte system may include a single electron withdrawing compound, or a combination thereof, according to different implementations. Similar to the solvent system, the particular electron withdrawing compound(s) included in a given electrolyte system may be chosen based on the particular application for the electrochemical cell with which the performance enhancing additive(s) are to be utilized, based on chemical activity of the electron withdrawing compound (particularly based on how the electron withdrawing compound(s) may break down during operation of the resulting electrochemical cell in which they are to be implemented, and how such derivatives or the electron withdrawing compound(s) per se may interact with electrodes and form solid-electrolyte interphases (SEIs) therewith), based on the composition of other components of the electrolyte system, based on the composition of other components of the electrochemical cell (such as the anode, cathode, and/or separator), or other factors as would be understood by those having ordinary skill in the art upon reading the present disclosure.

The electron withdrawing compound(s) preferably comprise at least one alpha-hydrogenated, selectively beta-functionalized motif, and more preferably, the at least one alpha-hydrogenated, selectively beta-functionalized motif excludes fluorine. For instance, in various embodiments, the electron withdrawing compound may include 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), or other suitable equivalents that would be understood by a person having ordinary skill in the art upon reading the present descriptions, as well as any permutation or combination of the foregoing.

Moreover, derivative(s) of the electron withdrawing compound preferably comprise lithiated fluoroalkoxides, such as trifluoroethanol and/or Lithium trifluoroacetate.

The electron withdrawing compound(s) may be cumulatively present in an amount of about 1 vol %, about 2.5 vol %, about 3.33 vol %, about 5 vol %, about 6.66 vol %, about 7.5 vol %, about 10 vol %, about 12.5 vol %, about 15 vol %, about 17.5 vol %, about 20 vol %, about 25 vol %, about 30 vol %, about 33 vol %, about 35 vol %, about 40 vol %, about 50 vol %, about 60 vol %, about 66.6 vol %, about 70 vol %, or about 75 vol %, according to various embodiments.

According to select approaches, the solvent(s) and electron withdrawing compound(s) may be present in a particular volumetric ratio with respect to one another. Exemplary ratios may include a ratio of approximately 1:1, a ratio of approximately 1:2, a ratio of approximately 1:3, a ratio of approximately 1:5, a ratio of approximately 1:10, a ratio of approximately 2:1, a ratio of approximately 3:1, a ratio of approximately 5:1, a ratio of approximately 10:1, a ratio of approximately 2:3, a ratio of approximately 3:4, a ratio of approximately 2:5, etc. (vol % solvent: vol % electron withdrawing compound). In implementations where multiple solvent(s) and/or electron withdrawing compound(s) are present, these components may also be present in a particular volumetric ratio with respect to one another, such as the exemplary ratios set forth above regarding solvent electron withdrawing compound.

Of course, it shall be understood that in the context of the presently described inventive concepts, the relative amounts of the solvent(s), and electron withdrawing compound(s) may be any value within the broad range set forth above. Different amounts of the solvent(s) and electron withdrawing compound(s) may be selected based on the particular application and/or composition of other components of the electrochemical cell with which the electrolyte system is to be utilized, based on the composition of other components of the electrochemical cell (such as anode, cathode, and/or separator), and/or based on the composition and/or amount of other components of the electrolyte system, such as composition and/or amount of performance enhancing additive(s), lithium ion-transporting compound(s), etc. as will be understood by those having ordinary skill in the art upon reading the present disclosure.

Various implementations of suitable solvent system compositions are presented by way of example below in Table 2, according to select illustrative embodiments.

Moreover, the electrolyte system, according to different implementations, may (and preferably does) include additional components such as lithium ion-transporting compounds and/or performance-enhancing additives.

The lithium ion-transporting compounds, in various approaches, may include any one or more compounds known in the art to facilitate lithium ion transport under conditions present in lithium-based batteries as disclosed herein. More preferably, the lithium ion-transporting compounds do not conduct polysulfides.

As noted above with regard to solvent(s) and electron withdrawing compound(s), the particular lithium ion-transporting compound(s) included in a given electrolyte system may be chosen based on degree of lithium ion-transporting capability, based on particular species of lithium ion the compound(s) are capable of transporting, based on the particular application for the intended electrochemical cell, based on the composition of other components of the electrolyte system, based on the composition of other components of the electrochemical cell (such as the anode, cathode, and/or separator), or other factors as would be understood by those having ordinary skill in the art upon reading the present disclosure.

For example, suitable lithium ion-transporting compounds may include lithium, and may be salts of lithium. Exemplary species of lithium ion-transporting compounds suitable for use in the context of the presently disclosed inventive concepts include, without limitation, lithium bis(trifluoromethanesulfonyl)imide (LiTFSI), lithium nitrate (LiNO₃), lithium Perchlorate (LiClO₄), lithium difluoro(oxalato)borate (LiDFOB), lithium bis (oxalato)borate (LiBOB), lithium trifilate (LiTf), lithium bis(pentafluoroethanesulfonyl)imide (LiBETi), lithium bis(fluorosulfonyl)imide (LiFSI), Lithium trifluoroacetate (LiTFAc), or any suitable combination(s) and/or equivalent(s) thereof that would be appreciated by a person having ordinary skill in the art upon reading the present disclosure.

Preferably, the lithium ion-transporting compounds are present in an amount ranging from about 0.1 M to about 10 M, or any value therebetween, such as about 0.2 M, about 0.25 M, about 0.33 M, about 0.4 M, about 0.5 M, about 0.66 M, about 0.75 M, about 0.85 M about 0.9 M about 0.95 M about 0.99 M about 1.0 M about 1.25 M about 1.33 M about 1.5 M about 1.66 M about 1.75 M about 2.0 M about 2.25 M about 2.33 M about 2.5 M about 2.66 M about 2.75 M about 3.0 M about 3.25 M about 3.33 M, about 3.5 M, about 3.66 M, about 3.75 M, about 4.0 M, about 4.25 M, about 4.33 M about 4.5 M about 4.66 M about 4.75 M about 5.0 M about 5.25 M about 5.33 M, about 5.5 M, about 5.66 M, about 5.75 M, about 6.0 M, about 6.25 M, about 6.33 M about 6.5 M about 6.66 M about 6.75 M about 7.0 M about 7.25 M about 7.33 M, about 7.5 M, about 7.66 M, about 7.75 M, about 8.0 M, about 8.25 M, about 8.33 M, about 8.5 M, about 8.66 M, about 8.75 M, about 9.0 M, about 925 Mt about 9.33 M, about 9.5 M, about 9.66 M, about 9.75 M, or about 10 M, or any amount therebetween, according to various approaches.

Performance-enhancing additives, according to various aspects of the presently disclosed inventive concepts, include, in any permutation or combination, acetonitrile, azobisisobutyronitrile (AIBN), cyanamide, lithium dicyanamide, dicyandiamide (DCDA), guanine, guanidine nitrate, guanidine thiocyante, guanidine p-tolunesulfonate, guanidine trifluoromethanolate, 2-guanidinobenzimidazole, guanidine hydrochloride, guanidine carbonate, guanidine bromide, guanidine iodide, guanidine acetate, guanidine sulfate, guanidine phosphate, succionitrile, or any suitable equivalent(s) thereof that would be appreciated by those having ordinary skill in the art upon reading the present disclosures.

The performance-enhancing additive(s), in different implementations, may be present in a nonzero amount up to about 0.2 M, e.g., an amount ranging from about 0.01 M to about 0.2 M, and preferably in an amount ranging from about 0.1 M to about 0.15 M. Of course, skilled artisans will appreciate that the performance-enhancing additive may be present in any amount within the broad range set forth above, e.g., an amount of about 0.001 M about 0.005 M, about 0.01 M, about 0.02 M, about 0.05 M about 0.066 M, about 0.075 M, about 0.09 M, about 0.1 M, about 0.125 M, about 0.133 M, about 0.15 M, about 0.166 M, about 0.175 M, about 0.19 M, about 0.195 M, about 0.199 M, about 0.2 M, or any value or range of values from greater than zero to about 0.2 M, without limitation unless expressly stated otherwise herein. Notably, when the performance-enhancing additive was DCDA, resistance within the electrochemical cell increased dramatically at amounts of about 0.2 M or more, to the extent that the electrochemical cell would not function properly.

As noted above with regard to solvent(s) and electron withdrawing compound(s), the particular performance enhancing additive(s) included in a given electrolyte system may be chosen based on the particular application for the electrochemical cell with which the performance enhancing additive(s) are to be utilized, based on the composition of other components of the electrolyte system, based on the composition of other components of the electrochemical cell (such as the anode, cathode, and/or separator), or other factors as would be understood by those having ordinary skill in the art upon reading the present disclosure.

Suitable species and amounts of lithium ion-transporting compounds and performance-enhancing additives of exemplary electrolyte system compositions are detailed below in Table 3, according to various illustrative embodiments.

Accordingly, in preferred approaches the electrolyte system as a whole includes at least one solvent, at least one electron withdrawing compound, at least one performance-enhancing additive, and at least one lithium ion-transporting compound, in accordance with the parameters set forth hereinabove. The particular combination of species making up the foregoing components, or the particular combination of components, may be chosen based on various factors such as desired performance characteristics of electrochemical cells with which they are to be implemented (such as specific energy, cycle life, power, charge/discharge rate, etc., based on the particular application and/or composition of other components of the electrochemical cell with which the electrolyte system is to be utilized, based on the composition of other components of the electrochemical cell (such as anode, cathode, and/or separator), etc. as described hereinabove and as would be appreciated by skilled artisans informed of the contents of this disclosure.

According to further implementations, the electrolyte system may be implemented in an electrochemical cell including a lithium-based anode. The lithium-based anode preferably includes an interphase formed on surface(s) thereof, wherein the interphase is formed by interaction between an active material of the lithium-based anode, the performance enhancing additive(s), and/or derivative(s) of the solvent(s), the electron withdrawing compound(s), the performance-enhancing additive(s), or any permutation or combination thereof.

The active material of the lithium-based anode preferably comprises elemental lithium or a lithium alloy. For instance, the lithium alloy may include lithium-magnesium, lithium-sulfur, or a combination thereof.

According to still further implementations, the electrolyte system may be implemented in an electrochemical cell including a cathode having a sulfur composite composition. The cathode preferably includes an interphase formed on surface(s) thereof, wherein the interphase is formed by interaction between an active material of the cathode, the performance enhancing additive(s), and/or derivative(s) of the solvent(s), the electron withdrawing compound(s), the performance-enhancing additive(s), or any permutation or combination thereof.

According to more embodiments, electrochemical cells may comprise the aforementioned electrolyte system(s), anode(s), cathode(s), and a separator having a composition compatible therewith, as would be appreciated by a person having ordinary skill in the art upon reading the present disclosure. The electrochemical cell may be characterized by a coin configuration, a cylindrical configuration, a prismatic configuration, a pouch configuration, or any other suitable configuration or arrangement that would be appreciated by skilled artisans informed of the contents of these descriptions.

Additional features and advantages of the various inventive aspects will be appreciated upon a full review of the descriptions presented herein, along with the accompanying figures. It shall be understood that these inventive concepts may be combined in any suitable manner unless expressly stated otherwise in this disclosure. Accordingly, the inventive aspects are to be considered modular, and may be rearranged, combined, synthesized, or otherwise utilized in any manner that would be appreciated by those having ordinary skill in the art upon reading this disclosure. Moreover, suitable equivalent compounds, formulations, structural arrangements, etc. that would be appreciated as suitable by skilled artisans in the context of the invention as a whole upon completing a review of the full contents of this application are to be understood as part of the invention, without limitation, unless absent express disclaimer clearly indicating the contrary.

According to an aspect of the present disclosure, an electrolyte system for a lithium-sulfur battery is provided. The electrolyte system includes a solvent system. The electrolyte system includes at least one redox mediator comprising a phenyl-based chalcogenide compound selected from the group consisting of Diphenyl sulfide (Ph2S), Diphenyl diselenide (Ph2Se2), and Diphenyl ditelluride (Ph2Te2). The electrolyte system includes at least one lithium ion-transporting compound. The redox mediator facilitates conversion of lithium polysulfides to Li2S.

According to other aspects of the present disclosure, the electrolyte system may include one or more of the following features. The phenyl-based chalcogenide compound may comprise Diphenyl ditelluride (Ph2Te2). The phenyl-based chalcogenide compound may comprise Diphenyl diselenide (Ph2Se2). The phenyl-based chalcogenide compound may comprise Diphenyl sulfide (Ph2S). The redox mediator may have a redox potential between about 2.0V and 2.3V vs. Li/Li+. The redox mediator may be soluble in the solvent system. The lithium ion-transporting compound may comprise a lithium salt. The redox mediator may be present at a concentration between about 0.10 M and 0.30 M. The redox mediator may act as an electron transfer agent between a conductive cathode surface and lithium polysulfides. The redox mediator may undergo reduction to form a reduced species that diffuses through the solvent system to reduce lithium polysulfides. The Diphenyl ditelluride may undergo reduction at the cathode surface to form a reduced telluride species that mediates electron transfer to lithium polysulfides. The redox mediator may be soluble in the solvent system and may undergo reversible oxidation and reduction during battery cycling. The solvent system may comprise an ether-based solvent and the lithium ion-transporting compound may comprise lithium bis(trifluoromethanesulfonyl)imide (LiTFSI). The reduced species of the redox mediator may diffuse through the solvent system to contact lithium polysulfides not in direct contact with a current collector. The redox mediator may increase active material utilization by facilitating electron transfer to isolated Li2S particles. The solvent system may comprise 1,3-dioxolane (DOL), 1,2-dimethoxyethane (DME), or a combination thereof. The redox mediator may reduce accumulation of inactive Li2S on a cathode during discharge and may improve reaction kinetics of lithium polysulfide conversion. The solvent system may comprise an ether-based solvent and the redox mediator may remain electrochemically active across multiple charge-discharge cycles. The electrolyte system may maintain capacity enhancement across discharge rates ranging from 0.1 C to 1 C. The electrolyte system may further comprise a cathode in contact with the electrolyte system, wherein the cathode comprises a sulfur-based active material, a carbon-based conductive material, and a portion of the phenyl-based chalcogenide compound incorporated into the cathode during fabrication, such that the redox mediator is distributed both within the cathode and dissolved in the solvent system.

The foregoing general description of the illustrative embodiments and the following detailed description thereof are merely exemplary aspects of the teachings of this disclosure and are not restrictive.

### BRIEF DESCRIPTION OF THE DRAWINGS

FIGS. 1A-1B are simplified schematics of the chemical structure of the inventive motif characteristic of compounds included in the inventive electrolyte systems described herein, according to various embodiments.

FIGS. 2A-1 through 2B-3 are simplified schematics of the chemical structures of several exemplary species of alpha-hydrogenated, selectively beta-functionalized compounds, according to different approaches.

FIG. 3 illustrates a simplified schematic of a reaction pathway for chalcogenide materials to form free radicals that facilitate conversion of lithium polysulfides, in accordance with one embodiment.

FIGS. 4A-4E are simplified graphs showing performance characteristics of an electrolyte system 401 including an inventive electrolyte system as disclosed herein and in accordance with one embodiment with reference to a control electrolyte system 404 implementing an electrolyte system otherwise identical to the inventive electrolyte system, but omitting any chalcogenide.

FIG. 4A is a plot showing discharge capacity versus cycle number for the inventive electrolyte system 401 and the control electrolyte system 404, according to one embodiment.

FIG. 4B is a plot showing columbic efficiency versus cycle number for the inventive electrolyte system 401 and the control electrolyte system 404, according to the same embodiment.

FIG. 4C is a plot showing rating capacity for the inventive electrolyte system 401 and the control electrolyte system 404, according to the same embodiment.

FIG. 4D is a plot showing discharge capacity versus charge rate for the inventive electrolyte system 401 and the control electrolyte system 404, according to the same embodiment.

FIG. 4E is a plot showing potential versus capacity for the inventive electrolyte system 401 and the control electrolyte system 404, according to the same embodiment.

FIG. 5A is a plot showing cycle life versus fluoroether concentration for inventive electrolyte systems 401, 411, and 421 and corresponding control electrolyte systems 402, 412, and 422, according to several exemplary embodiments.

FIG. 5B is a plot showing cycle life versus fluoroether concentration for inventive electrolyte systems 401, 411, and 421 and corresponding control electrolyte systems 402, 412, and 422, according to several exemplary embodiments.

FIGS. 6A-6D are simplified schematics of the chemical structures of performance-enhancing additives, in accordance with several embodiments.

FIG. 7A is a plot comparing capacity retention over cycle life of a lithium-sulfur electrochemical cell having a baseline electrolyte composition (control) versus a lithium-sulfur electrochemical cell having a baseline electrolyte composition but also including DCDA additive (+DCDA), in accordance with one embodiment.

FIG. 7B is a plot comparing Coulombic efficiency of a lithium-sulfur electrochemical cell having a baseline electrolyte composition (control) versus a lithium-sulfur electrochemical cell having a baseline electrolyte composition but also including DCDA additive (+DCDA), in accordance with one embodiment.

FIG. 7C is a plot showing Fourier-Transform Infrared (FTIR) spectra of the solid-electrolyte interphase (SEI) of two lithium-sulfur electrochemical cells having a baseline electrolyte composition (control) in comparison to the SEI of two lithium-sulfur electrochemical cells having a baseline electrolyte composition but also including DCDA additive (+DCDA), in accordance with one embodiment.

FIG. 8A shows a simplified schematic cross-sectional view of an electrochemical cell characterized by a pouch cell arrangement, according to one embodiment of the presently disclosed inventive concepts.

FIG. 8B is a simplified schematic external view of the electrochemical cell shown in FIG. 8A, according to one embodiment of the presently disclosed inventive concepts.

FIG. 8C depicts a simplified schematic of the pouch cell arrangement shown in FIG. 8B, wrapped into a jelly-roll configuration, according to one approach of the presently disclosed inventive concepts.

FIG. 9A is a simplified schematic of an electrochemical cell characterized by a coin cell arrangement, according to one implementation of the presently disclosed inventive concepts.

FIG. 9B depicts various components of the coin cell arrangement shown in FIG. 9A, according to a simplified schematic exploded view.

FIG. 10A is a simplified schematic of an electrochemical cell characterized by a cylindrical cell arrangement, according to one aspect of the presently disclosed inventive concepts.

FIG. 10B is a simplified schematic cut-out view of exemplary components of the cylindrical cell arrangement shown in FIG. 10A, according to one implementation of the presently disclosed inventive concepts.

FIG. 11 is a simplified schematic of an electrochemical cell characterized by a cylindrical cell arrangement, according to one aspect of the presently disclosed inventive concepts.

FIG. 12 is a chart showing various forms of carbonaceous material, and methods of producing the same from elemental carbon (e.g., charcoal), which may be included in various components of electrochemical cells such as shown in the foregoing Figures.

FIG. 13 illustrates a schematic diagram of a redox mediator system showing electron transfer between a conductive surface and lithium polysulfides, according to aspects of the present disclosure.

FIG. 14 depicts a bar chart showing cell capacity enhancement with different chalcogenide redox mediators versus a baseline, according to an embodiment.

FIG. 15 depicts a concentration dependency graph showing the relationship between Ph2Te2 concentration and cell capacity at various discharge rates, according to aspects of the present disclosure.

FIG. 16 illustrates a cross-sectional schematic of a lithium-sulfur battery cell showing the arrangement of components and distribution of redox mediator, according to an embodiment.

FIG. 17-1 depicts a chemical structure diagram of Diphenyl Disulfide, according to aspects of the present disclosure.

FIG. 17-2 depicts a chemical structure diagram of Diphenyl Diselenide, according to aspects of the present disclosure.

FIG. 17-3 depicts a chemical structure diagram of Diphenyl Ditelluride, according to aspects of the present disclosure.

### DETAILED DESCRIPTION

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

To address the problems highlighted hereinabove regarding safety and efficiency of electrolyte systems for lithium-based batteries with suitable performance, one principal aspect of the presently disclosed inventive concepts includes an electrolyte system including compounds that contain a motif referred-to herein as an “alpha-hydrogenated, selectively beta-functionalized” (or, equivalently, an “alpha-hydrogenated, selectively beta functionalized”) structure. Preferably, the solvent system is capable of satisfying the multitude of stringent requirements for lithium-based batteries noted above.

The inventors propose the exemplary class of alpha-hydrogenated, selectively beta-functionalized compounds advantageously exhibit similar or superior performance because the beta position is not sterically hindered from participating in desired chemical reactions (e.g., facilitating lithium polysulfide conversion via redox reactions, preferential formation of short-chain lithium polysulfide species, robust formation of a SEI, high solvation capability with respect to lithium salts, etc.), while simultaneously preserving the electron density of the electron withdrawing group adjacent to the alpha carbon of the motif. As described in greater detail hereinbelow, without such selective beta modification, solvent compounds otherwise exhibiting a similar (e.g., alpha-hydrogenated but not beta modified) motif undesirably tend to break down into gases in a cascade of reductive decomposition reactions and ultimately evaporate away from the solvent system.

Similarly, the inventive concepts presented herein relate to the use of such electrolyte systems with a lithium-based anode material in an electrochemical cell. As utilized herein, the term “lithium-based” shall be understood as referring to pure lithium metal, as well as lithium alloys or composites (such as Li—Mg, Li—S, Li—C, Li—Al, Li—Fe, and any other suitable equivalent(s) thereof that would be appreciated by skilled artisans upon reading the present descriptions) or combination(s) thereof.

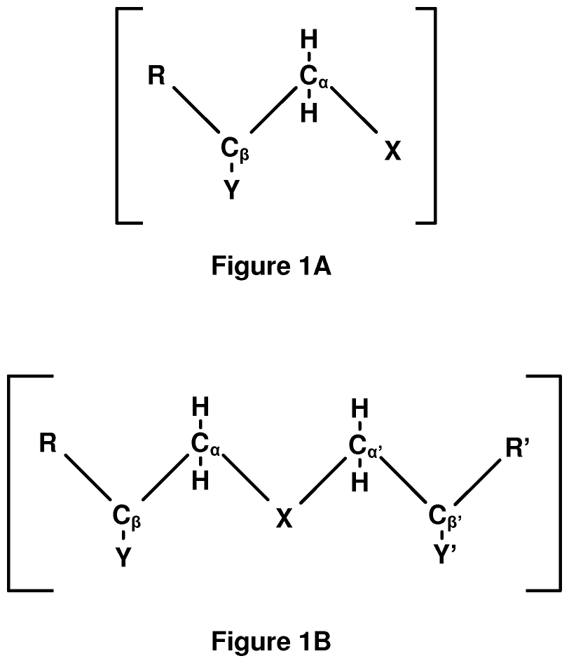

FIGS. 1A-1B are simplified schematics of chemical structures of the motif characteristic of compounds included in the inventive electrolyte systems described herein, according to various embodiments. As an option, the motifs shown in FIGS. 1A-1B may be implemented in the context of any one or more of the embodiments set forth in any previous and/or subsequent figure(s) and/or description thereof. Of course, however, the motifs may be implemented in the context of any desired environment. For instance, solvent systems including amides such as dimethylacetamide (DMA), dimethylformamide (DMF), or any other suitable equivalent(s) thereof that would be appreciated by those having ordinary skill in the art upon reading the present disclosure. Further, the aforementioned definitions may equally apply to the description below.

As shown in FIG. 1A, the motif generally includes an alpha carbon C that is hydrogenated (i.e., has at least one hydrogen bonded thereto, preferably is saturated with hydrogen, and more preferably is not directly bonded to another electron withdrawing group other than X), and directly bonded to a beta carbon Cp and an electron withdrawing group X. According to various embodiments, the electron withdrawing group is characterized by an electronegativity greater than carbon, and preferably by an electronegativity characterized by an electronegativity greater than the alpha carbon to which X is bonded. Preferably, X is not a halogen. Accordingly, in preferred implementations X may be selected from a group consisting of nitrogen, oxygen, and sulfur.

With continuing reference to FIG. 1A, In embodiments where C is not saturated with hydrogen, C may be doubly bonded to X, such as for a terminal aldehyde in which C is bonded to a single hydrogen and doubly bonded to X, and X is oxygen.

In addition to being bonded to the alpha carbon C_{α}, the beta carbon C_{β} is bonded to a modifying group Y and an aliphatic or aromatic side chain R. Whether R is aliphatic or aromatic, shorter chains, e.g. C1-C20, are preferred to minimize the overall mass of the molecule. Moreover, the backbone of R may, in various implementations, include elements other than carbon, including but not limited to phosphorus, sulfur, oxygen, nitrogen, etc., as would be understood by a person having ordinary skill in the art upon reading the present disclosures. In some approaches, R may be functionalized, such as with halogen(s), amine(s), amide(s), oxide(s), thiol(s), etc., as would be understood by a person having ordinary skill in the art upon reading the present disclosures.

Optionally, depending on the identity of Y and R, and bonding between the beta carbon C_{β}, Y, and R, the beta carbon Cp may optionally be bonded to a hydrogen (not shown), or doubly bonded to either Y or R.

In accordance with the embodiment depicted in FIG. 1A, the electron withdrawing group X is a terminal functional group of the molecule containing the alpha-hydrogenated, selectively beta-functionalized motif.

Of course, in alternative embodiments, such as shown in FIG. 1B, the electron withdrawing group X may be part of the backbone of the molecule, such as for a secondary or tertiary amine (where X is nitrogen), an ether (where X is oxygen), or an organosulfur (where X is sulfur), etc., as will be appreciated by those having ordinary skill in the art upon reading the present descriptions.

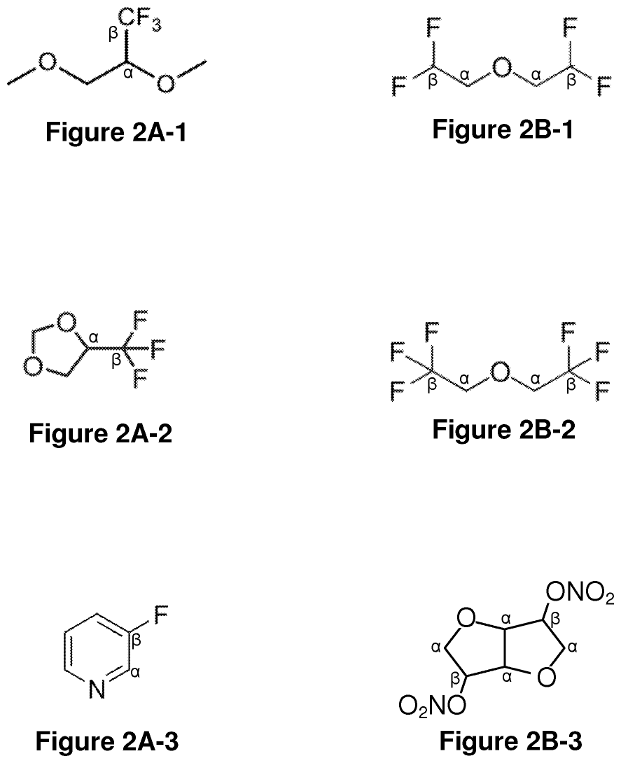

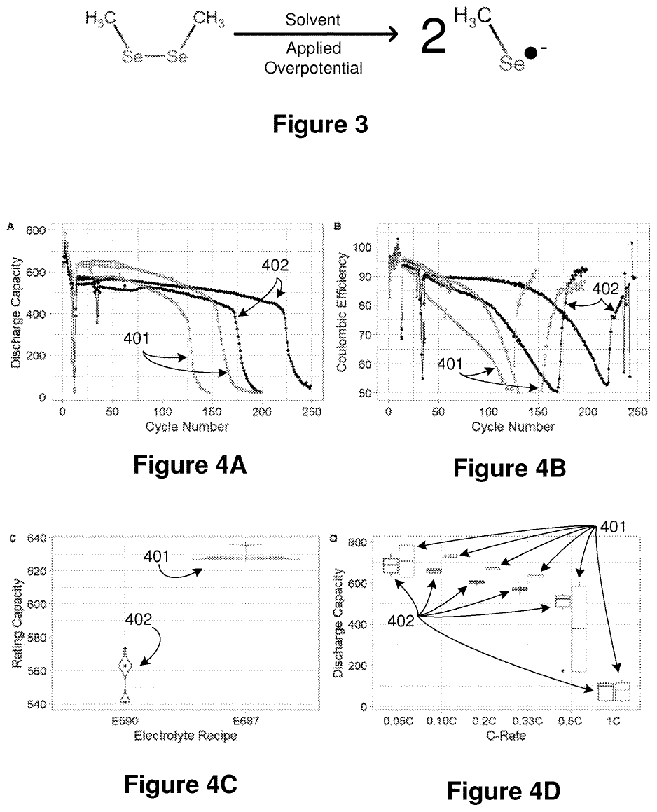

With continuing reference to FIG. 1B, and except as noted immediately hereinabove, the same considerations with respect to bonding and identity of C_{α}, C_{β}, Y, and R as described with respect to FIG. 1A apply to the motif as shown in FIG. 1B. In addition, similar considerations apply with respect to C_{α′}, C_{β′}, Y′, and R′, with the exception that in certain arrangements R and R′ may be part of the same aromatic structure connecting the molecule into a ring (or multi-ring) structure. For instance, and as described in greater detail below with respect to FIG. 2B-3, R and R′ may form a connected double-ring structure. Of course, it shall be understood that C_{α}, C_{β}, Y, R, C_{α′}, C_{β′}, Y′, and R′ may each independently be defined according to any suitable combination of characteristics (identity, bonding, etc.) described hereinabove, according to various embodiments.

FIGS. 2A-1 through 2A-3 are simplified schematics of the chemical structures of several exemplary species of alpha-hydrogenated, selectively beta-functionalized compounds, where the beta modifications are fluorine (i.e., Y═F), while FIG. 2B-3 depicts an exemplary alpha-hydrogenated, selectively beta-functionalized compound where the beta modification is not fluorine (i.e., Y═ONO₂), according to different approaches. As an option, the exemplary compounds may be implemented in the context of any one or more of the embodiments set forth in any previous and/or subsequent figure(s) and/or description thereof. Of course, however, the compounds may be implemented in the context of any desired environment. Further, the aforementioned definitions may equally apply to the description below.

As shown in FIGS. 2A-1, 2A-2, and 2A-3, the exemplary electron-withdrawing compounds (1,1,1-trifluoro-2,3-dimethyoxypropane (TFDMP), 4-(trifluoromethyl)-1,3-dioxolane (TFDOL), and (3-fluoropyridine) (3F-P), respectively) fit the motif shown in FIG. 1A. In FIG. 2A-3, R forms an aromatic ring that connects back to C.. For the structures shown in FIGS. 2A-1 and 2A-2, X is oxygen, meanwhile for the structure shown in FIG. 2A-3, X is nitrogen.

The exemplary electron withdrawing compounds shown in FIGS. 2B-1, 2B-2, and 2B-3 (monofluoride bis(2-fluoroethyl) ether (BFE), bis(2,2,2-trifluoroethyl) ether (BTFE), and isosorbide dinitrate (ISDN), respectively); fit the motif as shown in FIG. 1B. For the electron withdrawing compounds shown in FIGS. 2B-1, 2B-2, and 2B-3, X is oxygen. For the electron withdrawing compounds shown in FIGS. 2B-1 and 2B-2, Y is fluorine. For the electron withdrawing compound shown in FIG. 2B-3 only, Y is ONO₂.

Of course, the exemplary structures shown in FIGS. 2A-1 through 2B-3 are to be understood as illustrative of the scope of electron withdrawing compounds according to various embodiments of the inventive concepts presented herein. Other compounds including the motifs shown in FIG. 1A and/or 1B may also be suitable electron withdrawing compounds, according to different implementations, such as detailed below with reference to Table 2. In particular, exemplary suitable electron withdrawing compounds such as 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, or other suitable equivalents and combinations thereof as would be appreciated by those having ordinary skill in the art upon reading the present disclosures may be employed as electron-withdrawing compounds without departing from the scope of the inventive concepts set forth herein. Moreover, combinations of electron withdrawing groups may be employed without departing from the scope of the presently described inventive concepts.

Further still, those having ordinary skill in the art will appreciate that compounds such as shown in FIG. 2B-3, which excludes any fluorine or other halogen, are particularly preferred species of electron withdrawing compounds as they do not raise the environmental concerns associated with heavily halogenated, particularly heavily fluorinated, compounds. Indeed, according to certain approaches, the exemplary electron withdrawing groups discussed hereinabove, analogs thereof, and/or derivatives thereof, may be modified to substitute halide functional groups with —ONO₂ functional groups to form nitrate esters, and mitigate or eliminate environmental concerns associated with PFAS and other so-called “forever chemicals”.

Similarly, in particularly preferred embodiments the inventive electrolyte solvent systems may include lithiated salts that do not include any halogen component, such as LiClO₄, or other suitable equivalents (and combinations) thereof that would be appreciated by a person having ordinary skill in the art upon reading the present disclosure.

Still yet even further, the R and/or R′ groups of preferred electron withdrawing compounds in the context of the inventive concepts are characterized by minimal length, again to minimize the mass contribution of the electron withdrawing compound to the electrolyte system overall, and electrochemical cells including such electrolyte systems.

FIG. 3 illustrates a simplified schematic of a reaction pathway for chalcogenide materials to form free radicals that facilitate conversion of lithium polysulfides, in accordance with one embodiment.

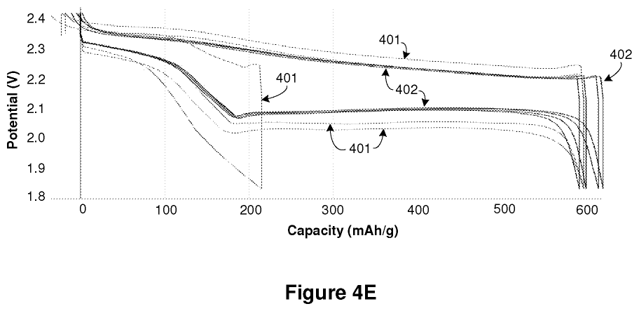

FIGS. 4A-4E are simplified graphs showing performance characteristics of an electrolyte system 401 including an inventive electrolyte system as disclosed herein and in accordance with one embodiment with reference to a control electrolyte system 402 implementing an electrolyte system otherwise identical to the inventive electrolyte system, but omitting any chalcogenide.

FIG. 4A is a plot showing discharge capacity versus cycle number for the inventive electrolyte system 401 and the control electrolyte system 402, according to one embodiment.

FIG. 4B is a plot showing columbic efficiency versus cycle number for the inventive electrolyte system 401 and the control electrolyte system 402, according to the same embodiment.

FIG. 4C is a plot showing rating capacity for the inventive electrolyte system 401 and the control electrolyte system 402, according to the same embodiment.

FIG. 4D is a plot showing discharge capacity versus charge/discharge rate for the inventive electrolyte system 401 and the control electrolyte system 402, according to the same embodiment.

FIG. 4E is a plot showing potential versus capacity for the inventive electrolyte system 401 and the control electrolyte system 402, according to the same embodiment.

The inventive electrolyte system 401 and control electrolyte system 402 each respectively include two solvents, an electron withdrawing compound, and two lithium ion-transporting compounds, in the same amount. The inventive electrolyte system 401 further includes about 1 wt % of a chalcogenide DMDSe.

As can be seen from FIGS. 4A-4E, the inventive electrolyte system 401 exhibits a more pronounced feature corresponding to presence/creation of Li₂S₍ₛ₎ relative to the control electrochemical cell 402. Moreover, capacity of the inventive electrochemical cell 401 is reversibly increased at every rate. Without wishing to be bound to any particular theory, the inventors propose the improved performance of the inventive electrochemical cell may, at least in part, be attributed to increased capacity through the second discharge plateau, owing to improved liquid-solid reaction kinetics of polysulfide conversion (Equation 1(c), above).

Similar experiments including a second inventive electrolyte system 403 which employs an identical formulation as inventive electrolyte system 401, but including DPDSe rather than DMDSe as the chalcogenide component, exhibited improved performance with respect to the control electrolyte system 402, but lesser performance on all metrics relative to inventive electrolyte system 401. Again without wishing to be bound to any particular theory, the inventors propose that DPDSe assists kinetics of liquid-liquid conversion reactions (Equations 1(a)-1(b)), which are not the rate limiting step until removal of the greater barrier presented by liquid-solid conversion (Equation 1(c)), and alleviated by inclusion of DMDSe.

In further experiments the inventors varied the amount of DMDSe in the inventive electrolyte system 401, testing embodiments including 0.5 wt % DMDSe, 1.0 wt % DMDSe, and 2.0 wt % DMDSe, but otherwise being identical to the formulation described hereinabove for inventive electrolyte system 401.

Despite expectations for further increased performance with increasing DMDSe concentration beyond 1 wt %, the opposite relationship was observed, with notable losses in discharge capacity, coulombic efficiency, and rating capacity in amounts greater than 1 wt %. Despite expecting increased improvement of lithium polysulfide conversion reaction kinetics with higher amount of available free radicals (i.e., higher concentration of DMDSe), the inventors postulate that increased DMDSe achieves optimal improvement of liquid-to-solid (and, to a lesser degree, solid-solid) reaction kinetics to the point of no longer being the rate limiting step in the overall pathway when included in an amount of about 1 wt %. Above this concentration, lithium polysulfide shuttling thus may increase without any corresponding benefit to discharge capacity. Put another way, including DMDSe as the chalcogenide improves kinetics of the lower plateau (liquid-to-solid reactions), while including DPDSe improves kinetics of the upper plateau (solid-liquid reaction). When the electrolyte system includes certain electron-withdrawing compounds (such as BTFE) which independently assist with reactions going into liquid state, addition of a chalcogenide that facilitates liquid-to-solid reactions provides a synergistic improvement to overall lithium polysulfide conversion and thus improves sulfur utilization in the resulting electrochemical cell.

The above is merely one example of the aforementioned observations that particular electrolyte system compositions may not necessarily follow conventional trends and expectations with respect to reaction kinetics and corresponding performance characteristics.

In still further experiments, the inventors tested formulations of an inventive electrolyte system similar to inventive electrolyte system 401, but including a combination of DMDSe and DPDSe in equal amounts of 0.5 wt % each, and 1.0 wt % each, since these concentration ranges produced the best results for similar inventive electrolyte systems as shown with reference to FIGS. 4A-4E, and described hereinabove.

In general, the mixed diselenide electrolyte formulation exhibited little difference with respect to cycle life, and a slight improvement to capacity and Coulombic efficiency at 1 wt % concentration, despite expectations for lower Coulombic efficiency due to presence of greater amount of selenide (i.e., a system including 1 wt % each DMDSe and DPDSe is comparable in terms of selenide concentration to a system including 2 wt % DMDSe, which was observed to exhibit poor Coulombic efficiency relative to 1 wt % DMDSe alone, but the combined 1 wt % each of DMDSe and DPDSe did not exhibit the same loss, indeed a slight increase was observed).

In addition to testing various species of chalcogenide, the inventors investigated different electron withdrawing compounds (particularly hydrofluoroethers TTE, BTFE, or FDMB) at different concentrations, in formulations otherwise similar to inventive electrolyte system 401 shown and described hereinabove regarding FIGS. 4A-4E.

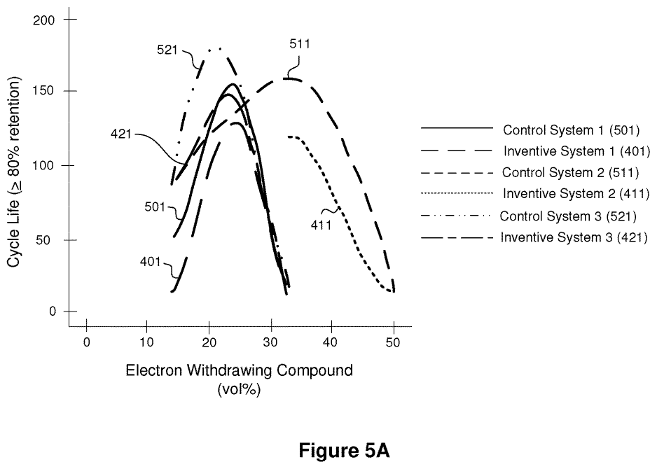

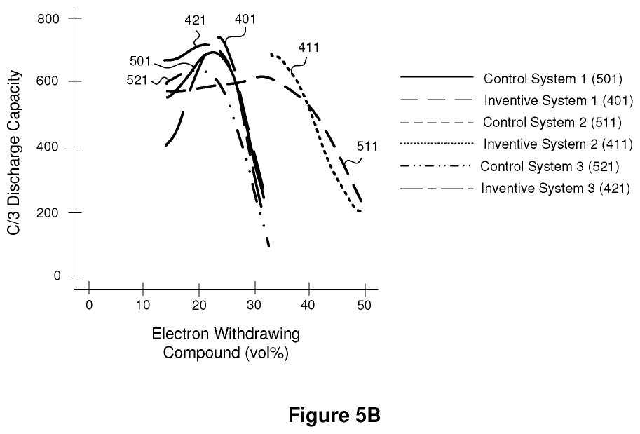

The results of these experiments are summarized in Table 1 and FIGS. 5A-5B.

TABLE 1
Lithium-based battery performance as a function
of hydrofluoroether composition

| Electron | | Control | DMDSe | Control | DMDSe |
|---|---|---|---|---|---|
| Withdrawing | Conc | C/3 | C/3 | Cycle | Cycle |
| Compound | (vol %) | Capacity | Capacity | Life | Life |
| TTE | 14% | 600 | 660 | 110 | 90 |
| TTE | 25% | 620 | 660 | 170 | 140 |
| TTE | 33% | 150 | 140 | 14 | 0 |
| BTFE | 14% | 550 | 400 | 50 | 14 |
| BTFE | 25% | 660 | 710 | 150 | 125 |
| BTFE | 33% | 200 | 200 | 14 | 0 |
| FDMB | 14% | 565 | Not tested | 90 | Not tested |
| FDMB | 25% | 590 | Not tested | 140 | Not tested |
| FDMB | 33% | 610 | 680 | 160 | 120 |
| FDMB | 50% | 200 | 200 | 14 | 0 |

Note that the capacities shown in Table 1 are reported on an electrode basis rather than on a sulfur basis.

FIGS. 5A-5B depict exemplary curves for the inventive electrolyte systems 401, 411, and 421 and corresponding control electrolyte systems 501, 511, and 521. Per Table 1, the various electrolyte systems included two solvents, one electron withdrawing compound (respectively, BTFE for electrolyte systems 401 and 501, FDMB for electrolyte systems 411 and 511, and TTE for electrolyte systems 421 and 521), two lithium ion-transporting compounds (LITFSI and LiNO₃), and a chalcogenide component (DMDSe), in the same amounts, respectively, and within the ranges described herein.

FIG. 5A depicts performance of the cells with respect to cycle life (defined, in accordance with these experiments, by retention of at least 80% capacity following discharge) as a function of hydrofluoroether concentration, while FIG. 5B depicts performance with respect to capacity as a function of hydrofluoroether concentration.

As mentioned briefly above, testing the different hydrofluoroethers, and concentrations thereof, produced surprising results that do not follow the conventional wisdom regarding role of hydrofluoroether (and indeed, fluorine generally) in lithium-based batteries. In general, addition of fluorine in an electrolyte system of a lithium-based battery is correlated with increased life cycle of the resulting battery. This is because, conventionally, it has been understood that added fluorine corresponds to decreased solvation capability and wettability of (typically concentrated, and highly viscous) electrolyte toward electrode surfaces.

Moreover, hydrofluoroethers and similar electron withdrawing compounds are conventionally understood (and indeed designed) to be inert towards both electrodes of lithium-based batteries. Moreover still, for lithium-sulfur battery chemistries, strict limitations on the amount of salt that can be included due to limited solubility in the remaining components of the electrolyte system, and the battery as a whole.

The presently disclosed inventive concepts employ these electron withdrawing compounds in electrolytes with low salt concentration due to lower Lewis acid-base interaction with polysulfides (less solubility), and previous presumptions that these compounds, particularly hydrofluoroethers, were “known” to be inert towards the notoriously reactive, lithium-based anode material.

The presently disclosed inventive concepts employ these electron withdrawing compounds in electrolytes with low salt concentration due to lower Lewis acid-base interaction with polysulfides (less solubility), and previous presumptions that these compounds, particularly hydrofluoroethers, were “known” to be inert towards the notoriously reactive, lithium-based anode material.

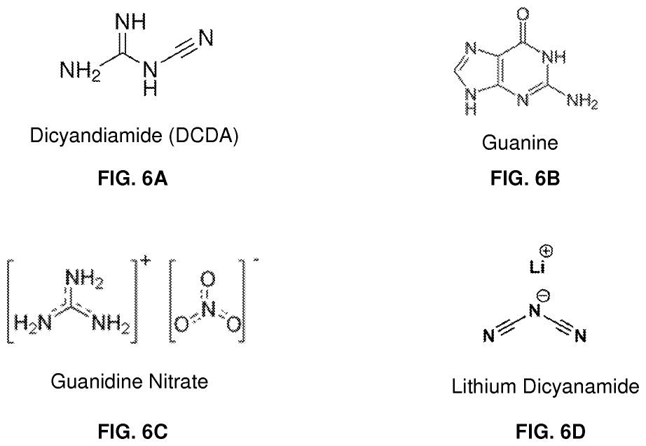

FIGS. 6A-6D are simplified schematics of the chemical structures of performance-enhancing additives, in accordance with several embodiments. FIG. 6A shows the structure of dicyandiamide, while FIG. 6B shows the structure of guanine, FIG. 6C shows the chemical structure of guanidine nitrate, and FIG. 6D depicts the chemical structure of lithium dicyanamide, according to illustrative embodiments. Without wishing to be bound to any particular theory, the inventors propose that the inventive electrolyte systems described herein form a protective solid-electrolyte interphase (SEI) on surfaces of both the cathode and anode of the lithium-based electrochemical cells into which the electrolyte systems are introduced.

With respect to the contribution of the solvent(s) and electron withdrawing compound(s) to the SEI, refer to U.S. Provisional Patent Application No. 63/624,202 and its progeny for a detailed investigation and discussion of the mechanism and chemical structure of components of the SEI formed therewith.

With respect to the performance-enhancing additive, and again without wishing to be bound to any particular theory, the inventors propose suitable additives, such as acetonitrile, azobisisobutyronitrile (AIBN), cyanamide, lithium dicyanamide, dicyandiamide (DCDA), guanine, guanidine nitrate, guanidine thiocyante, guanidine p-tolunesulfonate, guanidine trifluoromethanolate, 2-guanidinobenzimidazole, guanidine hydrochloride, guanidine carbonate, guanidine bromide, guanidine iodide, guanidine acetate, guanidine sulfate, guanidine phosphate, succionitrile, or any combination thereof, form a protective thin film polymer on or around surface(s) of the electrodes, and this protective film both mitigates the well-known polysulfide shuttling effect and its detrimental effects as well as protects the anode in particular from delithiation (stripping) during cycling of the electrochemical cell.

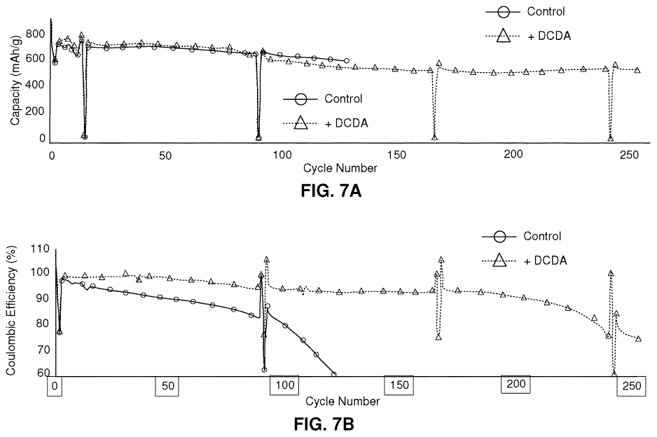

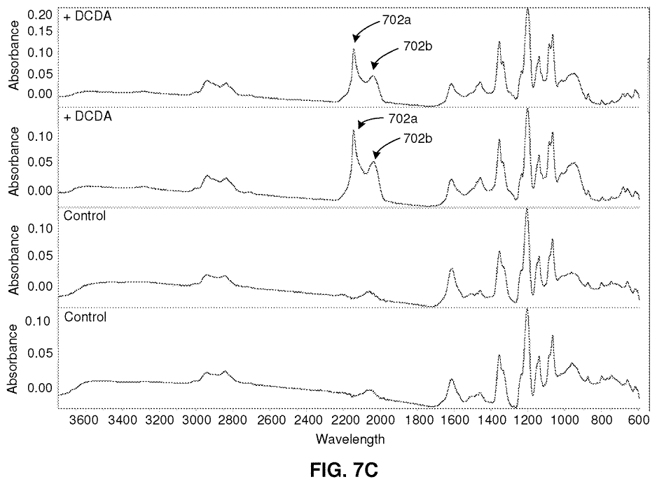

As a result, and as reflected in the data shown in FIGS. 7A-7B, both cycle life (FIGS. 7A-7B) and Coulombic efficiency (FIG. 7B) of lithium-based electrochemical cells implementing the inventive electrolyte system are dramatically improved.

For instance, referring again to FIGS. 7A-7B, it is evident that the control electrochemical cell (control, circular data points), which included an electrolyte system without any performance-enhancing additive, experienced dramatic reduction in Coulombic efficiency at around 90 cycles, and failed after about 100 cycles.

By comparison, lithium-based electrochemical cells including the inventive electrolyte system exhibit substantially improved retention of Coulombic efficiency, remaining above 80% for over 225 cycles. Indeed, select embodiments of lithium-based electrochemical cells implementing the inventive electrolyte system presently disclosed remained active (above 80% CE) for over 300 cycles.

Notably, and as shown in FIG. 7A in particular, these benefits were not associated with loss of specific capacity, which remained similar to the control, and stable over the longer cycle life of the inventive electrochemical cells.

Moreover, the electrochemical cell embodiments used to produce the comparative data shown in FIGS. 7A-7B were charged and discharged at a rate of C/3, but additional embodiments showed similar performance characteristics when charged at rates up to about 1 C, indicating the inventive electrolyte system described herein also may facilitate higher charge/discharge rates than typically achievable (e.g., about C/3) using similar electrochemical cells without the inventive electrolyte system described herein.

FIG. 7C is a plot showing Fourier-Transform Infrared (FTIR) spectra of the solid-electrolyte interphase (SEI) of two lithium-sulfur electrochemical cells having a baseline electrolyte composition (control) in comparison to the SEI of two inventive lithium-sulfur electrochemical cells having a baseline electrolyte composition but also including DCDA additive (+DCDA), in accordance with one embodiment.

As is apparent from the spectra, the inventive electrochemical cell SEIs exhibit two distinct peaks 702a, 702b in the vicinity of wavelength 2000-2200. Without wishing to be bound to any particular theory, the inventors postulate these peaks correspond to presence of lithium cyanate and lithium thiocyanate in or on the SEI. These compounds are proposed to form from decomposition of DCDA at the electron supplying anode in the presence of oxidative species such as polysulfides and nitrate in a synergistic manner.

Moreover, in view of the double-ended nature of the cyanate and thiocyanate anions, which each have both an ‘anion’ end with a Lewis basic negative charge and the other end has a Lewis basic nitrogen with a lone pair, the inventors propose these species are enhancing Li⁺ transport, and/or increasing Li⁺ concentration in the SEI, which advantageously enhances robustness against degradation of the interphase, and correspondingly extending cycle life of the electrochemical cell. Put another way, the cyanate and thiocyanate facilitate Li⁺ ion transport without (or at least with significantly less) degradation of the SEI, allowing Li⁺ present in the cell to be dedicated to normal cycling rather than rebuilding the SEI. This mechanism is particularly effective in later cycles, thus significantly extending the life of the electrochemical cell.

While FIGS. 6-7C and corresponding descriptions presented hereinabove feature an inventive electrolyte system including one or more compounds selected from acetonitrile, azobisisobutyronitrile (AIBN), cyanamide, lithium dicyanamide, dicyandiamide (DCDA), guanine, guanidine nitrate, guanidine thiocyante, guanidine p-tolunesulfonate, guanidine trifluoromethanolate, 2-guanidinobenzimidazole, guanidine hydrochloride, guanidine carbonate, guanidine bromide, guanidine iodide, guanidine acetate, guanidine sulfate, guanidine phosphate, succionitrile, or any combination thereof as the performance-enhancing additive, those having ordinary skill in the art will appreciate, upon reading the present descriptions, that other suitable equivalent(s) thereof may be implemented as performance-enhancing additive(s), in any suitable permutation, combination or amount, without departing from the scope of the inventive concepts disclosed herein.

For instance, derivatives of performance enhancing additive(s) that may form in the presence of other components of electrolyte systems described herein, isomers of performance enhancing additive(s), compounds with similar chemical motifs and/or structures, larger molecules including performance enhancing additive(s) or substantially similar structures as a portion of the larger molecular structure, etc. may be implemented as performance-enhancing additives while remaining within the scope of the inventive concepts presented herein.

Additionally or alternatively, compounds capable of forming a thin film protective polymer layer with a composition similar to the thin film formed by performance enhancing additive(s) or derivatives thereof (singly, or in combination with other components of the electrolyte system, in various approaches) may be utilized as performance-enhancing additives in the context of the presently disclosed inventive concepts.

Tables 2 and 3 below summarize various suitable compositions of the solvent system and additional components of the inventive electrolyte systems described hereinabove, respectively and according to several exemplary embodiments. It shall be understood that the exemplary embodiments set forth in the tables are provided by way of illustration rather than limitation, and other compositions falling within the scope of the disclosure provided herein may be employed without departing from the scope of the inventive concepts presented herein.

Moreover, for brevity and organizational simplicity, the tables describe different components and suitable amounts individually, and in select combinations, but it shall be understood that any combination of different species may be employed in suitable amounts as informed by the broad ranges presented above may be employed without departing from the scope of the presently described inventive concepts.

For instance, any number of different species of solvent(s) electron withdrawing compound(s) lithium ion-transporting compound(s), and/or performance-enhancing additive(s), may be included in an electrolyte system composition with the only limitation being that the total amount of solvent(s), electron withdrawing compound(s), lithium ion-transporting compound(s), and performance-enhancing additive(s), respectively, fall within the broad ranges set forth hereinabove for the respective component.

TABLE 2
Exemplary Solvent System Components

| | Vol % | | Vol % | Electron | |
|---|---|---|---|---|---|
| Solvent | Solvent | Solvent | Solvent | Withdrawing | Vol % |
| 1 | 1 | 2 | 2 | Compound (EWC) | EWC |
| dimethoxy- | 25.00 | none | 0 | bis(2-fluoroethyl) | 75.00 |
| ethane | | | | ether (BFE) | |
| (DME) | | | | | |
| DME | 25.00 | none | 0 | 3-fluoropyridine | 75.00 |
| | | | | (3FP) | |
| DME | 25.00 | none | 0 | bis(2,2,2, | 75.00 |
| | | | | trifluoroethyl) ether | |
| | | | | (BTFE) | |
| DME | 25.00 | none | 0 | fluorinated 1,4- | 75.00 |
| | | | | dimethoxylbutane | |
| | | | | (FDMB) | |
| DME | 25.00 | none | 0 | isosorbide dinitrate | 75.00 |
| | | | | (ISDN) | |
| DME | 25.00 | none | 0 | 1,1,2,2- | 75.00 |
| | | | | tetrafluoroethyl | |
| | | | | 2,2,3,3- | |
| | | | | tetrafluororopyl | |
| | | | | ether (TTE) | |
| DME | 33.00 | none | 0 | BFE | 67.00 |
| DME | 33.00 | none | 0 | 3FP | 67.00 |
| DME | 33.00 | none | 0 | BFTE | 67.00 |
| DME | 33.00 | none | 0 | FDMB | 67.00 |
| DME | 33.00 | none | 0 | ISDN | 67.00 |
| DME | 33.00 | none | 0 | TTE | 67.00 |
| DME | 50.00 | none | 0 | BFE | 50.00 |
| DME | 50.00 | none | 0 | 3FP | 50.00 |
| DME | 50.00 | none | 0 | BFTE | 50.00 |
| DME | 50.00 | none | 0 | FDMB | 50.00 |
| DME | 50.00 | none | 0 | ISDN | 50.00 |
| DME | 50.00 | none | 0 | TTE | 50.00 |
| DME | 75.00 | none | 0 | BFE | 25.00 |
| DME | 75.00 | none | 0 | 3FP | 25.00 |
| DME | 75.00 | none | 0 | BFTE | 25.00 |
| DME | 75.00 | none | 0 | FDMB | 25.00 |
| DME | 75.00 | none | 0 | ISDN | 25.00 |
| DME | 75.00 | none | 0 | TTE | 25.00 |
| DME | 10.00 | dioxo- | 15.00 | BFE | 75.00 |
| | | lane | | | |
| | | (DOL) | | | |
| DME | 10.00 | DOL | 25.00 | BFE | 65.00 |
| DME | 10.00 | DOL | 33.00 | BFE | 57.00 |
| DME | 10.00 | DOL | 50.00 | BFE | 40.00 |
| DME | 10.00 | DOL | 65.00 | BFE | 25.00 |
| DME | 10.00 | DOL | 15.00 | 3FP | 75.00 |
| DME | 10.00 | DOL | 25.00 | 3FP | 65.00 |
| DME | 10.00 | DOL | 33.00 | 3FP | 57.00 |
| DME | 10.00 | DOL | 50.00 | 3FP | 40.00 |
| DME | 10.00 | DOL | 65.00 | 3FP | 25.00 |
| DME | 10.00 | DOL | 15.00 | BFTE | 75.00 |
| DME | 10.00 | DOL | 25.00 | BFTE | 65.00 |
| DME | 10.00 | DOL | 33.00 | BFTE | 57.00 |
| DME | 10.00 | DOL | 50.00 | BFTE | 40.00 |
| DME | 10.00 | DOL | 65.00 | BFTE | 25.00 |
| DME | 10.00 | DOL | 15.00 | FDMB | 75.00 |
| DME | 10.00 | DOL | 25.00 | FDMB | 65.00 |
| DME | 10.00 | DOL | 33.00 | FDMB | 57.00 |
| DME | 10.00 | DOL | 50.00 | FDMB | 40.00 |
| DME | 10.00 | DOL | 65.00 | FDMB | 25.00 |
| DME | 10.00 | DOL | 15.00 | ISDN | 75.00 |
| DME | 10.00 | DOL | 25.00 | ISDN | 65.00 |
| DME | 10.00 | DOL | 33.00 | ISDN | 57.00 |
| DME | 10.00 | DOL | 50.00 | ISDN | 40.00 |
| DME | 10.00 | DOL | 65.00 | ISDN | 25.00 |
| DME | 10.00 | DOL | 15.00 | TTE | 75.00 |
| DME | 10.00 | DOL | 25.00 | TTE | 65.00 |
| DME | 10.00 | DOL | 33.00 | TTE | 57.00 |
| DME | 10.00 | DOL | 50.00 | TTE | 40.00 |
| DME | 10.00 | DOL | 65.00 | TTE | 25.00 |
| DME | 10.00 | toluene | 15.00 | BFE | 75.00 |
| | | (TOL) | | | |
| DME | 10.00 | TOL | 25.00 | BFE | 65.00 |
| DME | 10.00 | TOL | 33.00 | BFE | 57.00 |
| DME | 10.00 | TOL | 50.00 | BFE | 40.00 |
| DME | 10.00 | TOL | 65.00 | BFE | 25.00 |
| DME | 10.00 | TOL | 15.00 | 3FP | 75.00 |
| DME | 10.00 | TOL | 25.00 | 3FP | 65.00 |
| DME | 10.00 | TOL | 33.00 | 3FP | 57.00 |
| DME | 10.00 | TOL | 50.00 | 3FP | 40.00 |
| DME | 10.00 | TOL | 65.00 | 3FP | 25.00 |
| DME | 10.00 | TOL | 15.00 | BFTE | 75.00 |
| DME | 10.00 | TOL | 25.00 | BFTE | 65.00 |
| DME | 10.00 | TOL | 33.00 | BFTE | 57.00 |
| DME | 10.00 | TOL | 50.00 | BFTE | 40.00 |
| DME | 10.00 | TOL | 65.00 | BFTE | 25.00 |
| DME | 10.00 | TOL | 15.00 | FDMB | 75.00 |
| DME | 10.00 | TOL | 25.00 | FDMB | 65.00 |
| DME | 10.00 | TOL | 33.00 | FDMB | 57.00 |
| DME | 10.00 | TOL | 50.00 | FDMB | 40.00 |
| DME | 10.00 | TOL | 65.00 | FDMB | 25.00 |
| DME | 10.00 | TOL | 15.00 | ISDN | 75.00 |
| DME | 10.00 | TOL | 25.00 | ISDN | 65.00 |
| DME | 10.00 | TOL | 33.00 | ISDN | 57.00 |
| DME | 10.00 | TOL | 50.00 | ISDN | 40.00 |
| DME | 10.00 | TOL | 65.00 | ISDN | 25.00 |
| DME | 10.00 | TOL | 15.00 | TTE | 75.00 |
| DME | 10.00 | TOL | 25.00 | TTE | 65.00 |
| DME | 10.00 | TOL | 33.00 | TTE | 57.00 |
| DME | 10.00 | TOL | 50.00 | TTE | 40.00 |
| DME | 10.00 | TOL | 65.00 | TTE | 25.00 |
| DME | 10.00 | sul- | 15.00 | BFE | 75.00 |
| | | folane | | | |
| | | (SUL) | | | |
| DME | 10.00 | SUL | 25.00 | BFE | 65.00 |
| DME | 10.00 | SUL | 33.00 | BFE | 57.00 |
| DME | 10.00 | SUL | 50.00 | BFE | 40.00 |
| DME | 10.00 | SUL | 65.00 | BFE | 25.00 |
| DME | 10.00 | SUL | 15.00 | 3FP | 75.00 |
| DME | 10.00 | SUL | 25.00 | 3FP | 65.00 |
| DME | 10.00 | SUL | 33.00 | 3FP | 57.00 |
| DME | 10.00 | SUL | 50.00 | 3FP | 40.00 |
| DME | 10.00 | SUL | 65.00 | 3FP | 25.00 |
| DME | 10.00 | SUL | 15.00 | BFTE | 75.00 |
| DME | 10.00 | SUL | 25.00 | BFTE | 65.00 |
| DME | 10.00 | SUL | 33.00 | BFTE | 57.00 |
| DME | 10.00 | SUL | 50.00 | BFTE | 40.00 |
| DME | 10.00 | SUL | 65.00 | BFTE | 25.00 |
| DME | 10.00 | SUL | 15.00 | FDMB | 75.00 |
| DME | 10.00 | SUL | 25.00 | FDMB | 65.00 |
| DME | 10.00 | SUL | 33.00 | FDMB | 57.00 |
| DME | 10.00 | SUL | 50.00 | FDMB | 40.00 |
| DME | 10.00 | SUL | 65.00 | FDMB | 25.00 |
| DME | 10.00 | SUL | 15.00 | ISDN | 75.00 |
| DME | 10.00 | SUL | 25.00 | ISDN | 65.00 |
| DME | 10.00 | SUL | 33.00 | ISDN | 57.00 |
| DME | 10.00 | SUL | 50.00 | ISDN | 40.00 |
| DME | 10.00 | SUL | 65.00 | ISDN | 25.00 |
| DME | 10.00 | SUL | 15.00 | TTE | 75.00 |
| DME | 10.00 | SUL | 25.00 | TTE | 65.00 |
| DME | 10.00 | SUL | 33.00 | TTE | 57.00 |
| DME | 10.00 | SUL | 50.00 | TTE | 40.00 |
| DME | 10.00 | SUL | 65.00 | TTE | 25.00 |
| DME | 25.00 | DOL | 15.00 | BFE | 60.00 |
| DME | 25.00 | DOL | 25.00 | BFE | 50.00 |
| DME | 25.00 | DOL | 33.00 | BFE | 42.00 |
| DME | 25.00 | DOL | 50.00 | BFE | 25.00 |
| DME | 25.00 | DOL | 15.00 | 3FP | 60.00 |
| DME | 25.00 | DOL | 25.00 | 3FP | 50.00 |
| DME | 25.00 | DOL | 33.00 | 3FP | 42.00 |
| DME | 25.00 | DOL | 50.00 | 3FP | 25.00 |
| DME | 25.00 | DOL | 15.00 | BFTE | 60.00 |
| DME | 25.00 | DOL | 25.00 | BFTE | 50.00 |
| DME | 25.00 | DOL | 33.00 | BFTE | 42.00 |
| DME | 25.00 | DOL | 50.00 | BFTE | 25.00 |
| DME | 25.00 | DOL | 15.00 | FDMB | 60.00 |
| DME | 25.00 | DOL | 25.00 | FDMB | 50.00 |
| DME | 25.00 | DOL | 33.00 | FDMB | 42.00 |
| DME | 25.00 | DOL | 50.00 | FDMB | 25.00 |
| DME | 25.00 | DOL | 15.00 | ISDN | 60.00 |
| DME | 25.00 | DOL | 25.00 | ISDN | 50.00 |
| DME | 25.00 | DOL | 33.00 | ISDN | 42.00 |
| DME | 25.00 | DOL | 50.00 | ISDN | 25.00 |
| DME | 25.00 | DOL | 15.00 | TTE | 60.00 |
| DME | 25.00 | DOL | 25.00 | TTE | 50.00 |
| DME | 25.00 | DOL | 33.00 | TTE | 42.00 |
| DME | 25.00 | DOL | 50.00 | TTE | 25.00 |
| DME | 25.00 | TOL | 15.00 | BFE | 60.00 |
| DME | 25.00 | TOL | 25.00 | BFE | 50.00 |
| DME | 25.00 | TOL | 33.00 | BFE | 42.00 |
| DME | 25.00 | TOL | 50.00 | BFE | 25.00 |
| DME | 25.00 | TOL | 15.00 | 3FP | 60.00 |
| DME | 25.00 | TOL | 25.00 | 3FP | 50.00 |
| DME | 25.00 | TOL | 33.00 | 3FP | 42.00 |
| DME | 25.00 | TOL | 50.00 | 3FP | 25.00 |
| DME | 25.00 | TOL | 15.00 | BFTE | 60.00 |
| DME | 25.00 | TOL | 25.00 | BFTE | 50.00 |
| DME | 25.00 | TOL | 33.00 | BFTE | 42.00 |
| DME | 25.00 | TOL | 50.00 | BFTE | 25.00 |
| DME | 25.00 | TOL | 15.00 | FDMB | 60.00 |
| DME | 25.00 | TOL | 25.00 | FDMB | 50.00 |
| DME | 25.00 | TOL | 33.00 | FDMB | 42.00 |
| DME | 25.00 | TOL | 50.00 | FDMB | 25.00 |
| DME | 25.00 | TOL | 15.00 | ISDN | 60.00 |
| DME | 25.00 | TOL | 25.00 | ISDN | 50.00 |
| DME | 25.00 | TOL | 33.00 | ISDN | 42.00 |
| DME | 25.00 | TOL | 50.00 | ISDN | 25.00 |
| DME | 25.00 | TOL | 15.00 | TTE | 60.00 |
| DME | 25.00 | TOL | 25.00 | TTE | 50.00 |
| DME | 25.00 | TOL | 33.00 | TTE | 42.00 |
| DME | 25.00 | TOL | 50.00 | TTE | 25.00 |
| DME | 25.00 | SUL | 15.00 | BFE | 60.00 |
| DME | 25.00 | SUL | 25.00 | BFE | 50.00 |
| DME | 25.00 | SUL | 33.00 | BFE | 42.00 |
| DME | 25.00 | SUL | 50.00 | BFE | 25.00 |
| DME | 25.00 | SUL | 15.00 | 3FP | 60.00 |
| DME | 25.00 | SUL | 25.00 | 3FP | 50.00 |
| DME | 25.00 | SUL | 33.00 | 3FP | 42.00 |
| DME | 25.00 | SUL | 50.00 | 3FP | 25.00 |
| DME | 25.00 | SUL | 15.00 | BFTE | 60.00 |
| DME | 25.00 | SUL | 25.00 | BFTE | 50.00 |
| DME | 25.00 | SUL | 33.00 | BFTE | 42.00 |
| DME | 25.00 | SUL | 50.00 | BFTE | 25.00 |
| DME | 25.00 | SUL | 15.00 | FDMB | 60.00 |
| DME | 25.00 | SUL | 25.00 | FDMB | 50.00 |
| DME | 25.00 | SUL | 33.00 | FDMB | 42.00 |
| DME | 25.00 | SUL | 50.00 | FDMB | 25.00 |
| DME | 25.00 | SUL | 15.00 | ISDN | 60.00 |
| DME | 25.00 | SUL | 25.00 | ISDN | 50.00 |
| DME | 25.00 | SUL | 33.00 | ISDN | 42.00 |
| DME | 25.00 | SUL | 50.00 | ISDN | 25.00 |
| DME | 25.00 | SUL | 15.00 | TTE | 60.00 |
| DME | 25.00 | SUL | 25.00 | TTE | 50.00 |
| DME | 25.00 | SUL | 33.00 | TTE | 42.00 |
| DME | 25.00 | SUL | 50.00 | TTE | 25.00 |
| DME | 33.00 | DOL | 15.00 | BFE | 52.00 |
| DME | 33.00 | DOL | 25.00 | BFE | 42.00 |
| DME | 33.00 | DOL | 33.00 | BFE | 34.00 |
| DME | 33.00 | DOL | 50.00 | BFE | 17.00 |
| DME | 33.00 | DOL | 15.00 | 3FP | 52.00 |
| DME | 33.00 | DOL | 25.00 | 3FP | 42.00 |
| DME | 33.00 | DOL | 33.00 | 3FP | 34.00 |
| DME | 33.00 | DOL | 50.00 | 3FP | 17.00 |
| DME | 33.00 | DOL | 15.00 | BFTE | 52.00 |
| DME | 33.00 | DOL | 25.00 | BFTE | 42.00 |
| DME | 33.00 | DOL | 33.00 | BFTE | 34.00 |
| DME | 33.00 | DOL | 50.00 | BFTE | 17.00 |
| DME | 33.00 | DOL | 15.00 | FDMB | 52.00 |
| DME | 33.00 | DOL | 25.00 | FDMB | 42.00 |
| DME | 33.00 | DOL | 33.00 | FDMB | 34.00 |
| DME | 33.00 | DOL | 50.00 | FDMB | 17.00 |
| DME | 33.00 | DOL | 15.00 | ISDN | 52.00 |
| DME | 33.00 | DOL | 25.00 | ISDN | 42.00 |
| DME | 33.00 | DOL | 33.00 | ISDN | 34.00 |
| DME | 33.00 | DOL | 50.00 | ISDN | 17.00 |
| DME | 33.00 | DOL | 15.00 | TTE | 52.00 |
| DME | 33.00 | DOL | 25.00 | TTE | 42.00 |
| DME | 33.00 | DOL | 33.00 | TTE | 34.00 |
| DME | 33.00 | DOL | 50.00 | TTE | 17.00 |
| DME | 33.00 | TOL | 15.00 | BFE | 52.00 |
| DME | 33.00 | TOL | 25.00 | BFE | 42.00 |
| DME | 33.00 | TOL | 33.00 | BFE | 34.00 |
| DME | 33.00 | TOL | 50.00 | BFE | 17.00 |
| DME | 33.00 | TOL | 15.00 | 3FP | 52.00 |
| DME | 33.00 | TOL | 25.00 | 3FP | 42.00 |
| DME | 33.00 | TOL | 33.00 | 3FP | 34.00 |
| DME | 33.00 | TOL | 50.00 | 3FP | 17.00 |
| DME | 33.00 | TOL | 15.00 | BFTE | 52.00 |
| DME | 33.00 | TOL | 25.00 | BFTE | 42.00 |
| DME | 33.00 | TOL | 33.00 | BFTE | 34.00 |
| DME | 33.00 | TOL | 50.00 | BFTE | 17.00 |
| DME | 33.00 | TOL | 15.00 | FDMB | 52.00 |
| DME | 33.00 | TOL | 25.00 | FDMB | 42.00 |
| DME | 33.00 | TOL | 33.00 | FDMB | 34.00 |
| DME | 33.00 | TOL | 50.00 | FDMB | 17.00 |
| DME | 33.00 | TOL | 15.00 | ISDN | 52.00 |
| DME | 33.00 | TOL | 25.00 | ISDN | 42.00 |
| DME | 33.00 | TOL | 33.00 | ISDN | 34.00 |
| DME | 33.00 | TOL | 50.00 | ISDN | 17.00 |
| DME | 33.00 | TOL | 15.00 | TTE | 52.00 |
| DME | 33.00 | TOL | 25.00 | TTE | 42.00 |
| DME | 33.00 | TOL | 33.00 | TTE | 34.00 |
| DME | 33.00 | TOL | 50.00 | TTE | 17.00 |
| DME | 33.00 | SUL | 15.00 | BFE | 52.00 |
| DME | 33.00 | SUL | 25.00 | BFE | 42.00 |
| DME | 33.00 | SUL | 33.00 | BFE | 34.00 |
| DME | 33.00 | SUL | 50.00 | BFE | 17.00 |
| DME | 33.00 | SUL | 15.00 | 3FP | 52.00 |
| DME | 33.00 | SUL | 25.00 | 3FP | 42.00 |
| DME | 33.00 | SUL | 33.00 | 3FP | 34.00 |
| DME | 33.00 | SUL | 50.00 | 3FP | 17.00 |
| DME | 33.00 | SUL | 15.00 | BFTE | 52.00 |
| DME | 33.00 | SUL | 25.00 | BFTE | 42.00 |
| DME | 33.00 | SUL | 33.00 | BFTE | 34.00 |
| DME | 33.00 | SUL | 50.00 | BFTE | 17.00 |
| DME | 33.00 | SUL | 15.00 | FDMB | 52.00 |
| DME | 33.00 | SUL | 25.00 | FDMB | 42.00 |
| DME | 33.00 | SUL | 33.00 | FDMB | 34.00 |
| DME | 33.00 | SUL | 50.00 | FDMB | 17.00 |
| DME | 33.00 | SUL | 15.00 | ISDN | 52.00 |
| DME | 33.00 | SUL | 25.00 | ISDN | 42.00 |
| DME | 33.00 | SUL | 33.00 | ISDN | 34.00 |
| DME | 33.00 | SUL | 50.00 | ISDN | 17.00 |
| DME | 33.00 | SUL | 15.00 | TTE | 52.00 |
| DME | 33.00 | SUL | 25.00 | TTE | 42.00 |
| DME | 33.00 | SUL | 33.00 | TTE | 34.00 |
| DME | 33.00 | SUL | 50.00 | TTE | 17.00 |
| DME | 50.00 | DOL | 10.00 | BFE | 40.00 |
| DME | 50.00 | DOL | 25.00 | BFE | 25.00 |
| DME | 50.00 | DOL | 33.00 | BFE | 17.00 |
| DME | 50.00 | DOL | 15.00 | 3FP | 35.00 |
| DME | 50.00 | DOL | 25.00 | 3FP | 25.00 |
| DME | 50.00 | DOL | 33.00 | 3FP | 17.00 |
| DME | 50.00 | DOL | 15.00 | BFTE | 35.00 |
| DME | 50.00 | DOL | 25.00 | BFTE | 25.00 |
| DME | 50.00 | DOL | 33.00 | BFTE | 17.00 |
| DME | 50.00 | DOL | 15.00 | FDMB | 35.00 |
| DME | 50.00 | DOL | 25.00 | FDMB | 25.00 |
| DME | 50.00 | DOL | 33.00 | FDMB | 17.00 |
| DME | 50.00 | DOL | 15.00 | ISDN | 35.00 |
| DME | 50.00 | DOL | 25.00 | ISDN | 25.00 |
| DME | 50.00 | DOL | 33.00 | ISDN | 17.00 |
| DME | 50.00 | DOL | 15.00 | TTE | 35.00 |
| DME | 50.00 | DOL | 25.00 | TTE | 25.00 |
| DME | 50.00 | DOL | 33.00 | TTE | 17.00 |
| DME | 50.00 | TOL | 15.00 | BFE | 35.00 |
| DME | 50.00 | TOL | 25.00 | BFE | 25.00 |
| DME | 50.00 | TOL | 33.00 | BFE | 17.00 |
| DME | 50.00 | TOL | 15.00 | 3FP | 35.00 |
| DME | 50.00 | TOL | 25.00 | 3FP | 25.00 |
| DME | 50.00 | TOL | 33.00 | 3FP | 17.00 |
| DME | 50.00 | TOL | 15.00 | BFTE | 35.00 |
| DME | 50.00 | TOL | 25.00 | BFTE | 25.00 |
| DME | 50.00 | TOL | 33.00 | BFTE | 17.00 |
| DME | 50.00 | TOL | 15.00 | FDMB | 35.00 |
| DME | 50.00 | TOL | 25.00 | FDMB | 25.00 |
| DME | 50.00 | TOL | 33.00 | FDMB | 17.00 |
| DME | 50.00 | TOL | 15.00 | ISDN | 35.00 |
| DME | 50.00 | TOL | 25.00 | ISDN | 25.00 |
| DME | 50.00 | TOL | 33.00 | ISDN | 17.00 |
| DME | 50.00 | TOL | 15.00 | TTE | 35.00 |
| DME | 50.00 | TOL | 25.00 | TTE | 25.00 |
| DME | 50.00 | TOL | 33.00 | TTE | 17.00 |
| DME | 50.00 | SUL | 15.00 | BFE | 35.00 |
| DME | 50.00 | SUL | 25.00 | BFE | 25.00 |
| DME | 50.00 | SUL | 33.00 | BFE | 17.00 |
| DME | 50.00 | SUL | 15.00 | 3FP | 35.00 |
| DME | 50.00 | SUL | 25.00 | 3FP | 25.00 |
| DME | 50.00 | SUL | 33.00 | 3FP | 17.00 |
| DME | 50.00 | SUL | 15.00 | BFTE | 35.00 |
| DME | 50.00 | SUL | 25.00 | BFTE | 25.00 |
| DME | 50.00 | SUL | 33.00 | BFTE | 17.00 |
| DME | 50.00 | SUL | 15.00 | FDMB | 35.00 |
| DME | 50.00 | SUL | 25.00 | FDMB | 25.00 |
| DME | 50.00 | SUL | 33.00 | FDMB | 17.00 |
| DME | 50.00 | SUL | 15.00 | ISDN | 35.00 |
| DME | 50.00 | SUL | 25.00 | ISDN | 25.00 |
| DME | 50.00 | SUL | 33.00 | ISDN | 17.00 |
| DME | 50.00 | SUL | 15.00 | TTE | 35.00 |
| DME | 50.00 | SUL | 25.00 | TTE | 25.00 |
| DME | 50.00 | SUL | 33.00 | TTE | 17.00 |
| DOL | 25.00 | none | 0 | BFE | 75.00 |
| DOL | 25.00 | none | 0 | 3FP | 75.00 |
| DOL | 25.00 | none | 0 | BFTE | 75.00 |
| DOL | 25.00 | none | 0 | FDMB | 75.00 |
| DOL | 25.00 | none | 0 | ISDN | 75.00 |
| DOL | 25.00 | none | 0 | TTE | 75.00 |
| DOL | 33.00 | none | 0 | BFE | 67.00 |
| DOL | 33.00 | none | 0 | 3FP | 67.00 |
| DOL | 33.00 | none | 0 | BFTE | 67.00 |
| DOL | 33.00 | none | 0 | FDMB | 67.00 |
| DOL | 33.00 | none | 0 | ISDN | 67.00 |
| DOL | 33.00 | none | 0 | TTE | 67.00 |
| DOL | 50.00 | none | 0 | BFE | 50.00 |
| DOL | 50.00 | none | 0 | 3FP | 50.00 |
| DOL | 50.00 | none | 0 | BFTE | 50.00 |
| DOL | 50.00 | none | 0 | FDMB | 50.00 |
| DOL | 50.00 | none | 0 | ISDN | 50.00 |
| DOL | 50.00 | none | 0 | TTE | 50.00 |
| DOL | 75.00 | none | 0 | BFE | 25.00 |
| DOL | 75.00 | none | 0 | 3FP | 25.00 |
| DOL | 75.00 | none | 0 | BFTE | 25.00 |
| DOL | 75.00 | none | 0 | FDMB | 25.00 |
| DOL | 75.00 | none | 0 | ISDN | 25.00 |
| DOL | 75.00 | none | 0 | TTE | 25.00 |
| DOL | 10.00 | DME | 15.00 | BFE | 75.00 |
| DOL | 10.00 | DME | 25.00 | BFE | 65.00 |
| DOL | 10.00 | DME | 33.00 | BFE | 57.00 |
| DOL | 10.00 | DME | 50.00 | BFE | 40.00 |
| DOL | 10.00 | DME | 65.00 | BFE | 25.00 |
| DOL | 10.00 | DME | 15.00 | 3FP | 75.00 |
| DOL | 10.00 | DME | 25.00 | 3FP | 65.00 |
| DOL | 10.00 | DME | 33.00 | 3FP | 57.00 |
| DOL | 10.00 | DME | 50.00 | 3FP | 40.00 |
| DOL | 10.00 | DME | 65.00 | 3FP | 25.00 |
| DOL | 10.00 | DME | 15.00 | BFTE | 75.00 |
| DOL | 10.00 | DME | 25.00 | BFTE | 65.00 |
| DOL | 10.00 | DME | 33.00 | BFTE | 57.00 |
| DOL | 10.00 | DME | 50.00 | BFTE | 40.00 |
| DOL | 10.00 | DME | 65.00 | BFTE | 25.00 |
| DOL | 10.00 | DME | 15.00 | FDMB | 75.00 |
| DOL | 10.00 | DME | 25.00 | FDMB | 65.00 |
| DOL | 10.00 | DME | 33.00 | FDMB | 57.00 |
| DOL | 10.00 | DME | 50.00 | FDMB | 40.00 |
| DOL | 10.00 | DME | 65.00 | FDMB | 25.00 |
| DOL | 10.00 | DME | 15.00 | ISDN | 75.00 |
| DOL | 10.00 | DME | 25.00 | ISDN | 65.00 |
| DOL | 10.00 | DME | 33.00 | ISDN | 57.00 |
| DOL | 10.00 | DME | 50.00 | ISDN | 40.00 |
| DOL | 10.00 | DME | 65.00 | ISDN | 25.00 |
| DOL | 10.00 | DME | 15.00 | TTE | 75.00 |
| DOL | 10.00 | DME | 25.00 | TTE | 65.00 |
| DOL | 10.00 | DME | 33.00 | TTE | 57.00 |
| DOL | 10.00 | DME | 50.00 | TTE | 40.00 |
| DOL | 10.00 | DME | 65.00 | TTE | 25.00 |
| DOL | 10.00 | TOL | 15.00 | BFE | 75.00 |
| DOL | 10.00 | TOL | 25.00 | BFE | 65.00 |
| DOL | 10.00 | TOL | 33.00 | BFE | 57.00 |
| DOL | 10.00 | TOL | 50.00 | BFE | 40.00 |
| DOL | 10.00 | TOL | 65.00 | BFE | 25.00 |
| DOL | 10.00 | TOL | 15.00 | 3FP | 75.00 |
| DOL | 10.00 | TOL | 25.00 | 3FP | 65.00 |
| DOL | 10.00 | TOL | 33.00 | 3FP | 57.00 |
| DOL | 10.00 | TOL | 50.00 | 3FP | 40.00 |
| DOL | 10.00 | TOL | 65.00 | 3FP | 25.00 |
| DOL | 10.00 | TOL | 15.00 | BFTE | 75.00 |
| DOL | 10.00 | TOL | 25.00 | BFTE | 65.00 |
| DOL | 10.00 | TOL | 33.00 | BFTE | 57.00 |
| DOL | 10.00 | TOL | 50.00 | BFTE | 40.00 |
| DOL | 10.00 | TOL | 65.00 | BFTE | 25.00 |
| DOL | 10.00 | TOL | 15.00 | FDMB | 75.00 |
| DOL | 10.00 | TOL | 25.00 | FDMB | 65.00 |
| DOL | 10.00 | TOL | 33.00 | FDMB | 57.00 |
| DOL | 10.00 | TOL | 50.00 | FDMB | 40.00 |
| DOL | 10.00 | TOL | 65.00 | FDMB | 25.00 |
| DOL | 10.00 | TOL | 15.00 | ISDN | 75.00 |
| DOL | 10.00 | TOL | 25.00 | ISDN | 65.00 |
| DOL | 10.00 | TOL | 33.00 | ISDN | 57.00 |
| DOL | 10.00 | TOL | 50.00 | ISDN | 40.00 |
| DOL | 10.00 | TOL | 65.00 | ISDN | 25.00 |
| DOL | 10.00 | TOL | 15.00 | TTE | 75.00 |
| DOL | 10.00 | TOL | 25.00 | TTE | 65.00 |
| DOL | 10.00 | TOL | 33.00 | TTE | 57.00 |
| DOL | 10.00 | TOL | 50.00 | TTE | 40.00 |
| DOL | 10.00 | TOL | 65.00 | TTE | 25.00 |
| DOL | 10.00 | SUL | 15.00 | BFE | 75.00 |
| DOL | 10.00 | SUL | 25.00 | BFE | 65.00 |
| DOL | 10.00 | SUL | 33.00 | BFE | 57.00 |
| DOL | 10.00 | SUL | 50.00 | BFE | 40.00 |
| DOL | 10.00 | SUL | 65.00 | BFE | 25.00 |
| DOL | 10.00 | SUL | 15.00 | 3FP | 75.00 |
| DOL | 10.00 | SUL | 25.00 | 3FP | 65.00 |
| DOL | 10.00 | SUL | 33.00 | 3FP | 57.00 |
| DOL | 10.00 | SUL | 50.00 | 3FP | 40.00 |
| DOL | 10.00 | SUL | 65.00 | 3FP | 25.00 |
| DOL | 10.00 | SUL | 15.00 | BFTE | 75.00 |
| DOL | 10.00 | SUL | 25.00 | BFTE | 65.00 |
| DOL | 10.00 | SUL | 33.00 | BFTE | 57.00 |
| DOL | 10.00 | SUL | 50.00 | BFTE | 40.00 |
| DOL | 10.00 | SUL | 65.00 | BFTE | 25.00 |
| DOL | 10.00 | SUL | 15.00 | FDMB | 75.00 |
| DOL | 10.00 | SUL | 25.00 | FDMB | 65.00 |
| DOL | 10.00 | SUL | 33.00 | FDMB | 57.00 |
| DOL | 10.00 | SUL | 50.00 | FDMB | 40.00 |
| DOL | 10.00 | SUL | 65.00 | FDMB | 25.00 |
| DOL | 10.00 | SUL | 15.00 | ISDN | 75.00 |
| DOL | 10.00 | SUL | 25.00 | ISDN | 65.00 |
| DOL | 10.00 | SUL | 33.00 | ISDN | 57.00 |
| DOL | 10.00 | SUL | 50.00 | ISDN | 40.00 |
| DOL | 10.00 | SUL | 65.00 | ISDN | 25.00 |
| DOL | 10.00 | SUL | 15.00 | TTE | 75.00 |
| DOL | 10.00 | SUL | 25.00 | TTE | 65.00 |
| DOL | 10.00 | SUL | 33.00 | TTE | 57.00 |
| DOL | 10.00 | SUL | 50.00 | TTE | 40.00 |
| DOL | 10.00 | SUL | 65.00 | TTE | 25.00 |
| DOL | 25.00 | DME | 15.00 | BFE | 60.00 |
| DOL | 25.00 | DME | 25.00 | BFE | 50.00 |
| DOL | 25.00 | DME | 33.00 | BFE | 42.00 |
| DOL | 25.00 | DME | 50.00 | BFE | 25.00 |
| DOL | 25.00 | DME | 15.00 | 3FP | 60.00 |
| DOL | 25.00 | DME | 25.00 | 3FP | 50.00 |
| DOL | 25.00 | DME | 33.00 | 3FP | 42.00 |
| DOL | 25.00 | DME | 50.00 | 3FP | 25.00 |
| DOL | 25.00 | DME | 15.00 | BFTE | 60.00 |
| DOL | 25.00 | DME | 25.00 | BFTE | 50.00 |
| DOL | 25.00 | DME | 33.00 | BFTE | 42.00 |
| DOL | 25.00 | DME | 50.00 | BFTE | 25.00 |
| DOL | 25.00 | DME | 15.00 | FDMB | 60.00 |
| DOL | 25.00 | DME | 25.00 | FDMB | 50.00 |
| DOL | 25.00 | DME | 33.00 | FDMB | 42.00 |
| DOL | 25.00 | DME | 50.00 | FDMB | 25.00 |
| DOL | 25.00 | DME | 15.00 | ISDN | 60.00 |
| DOL | 25.00 | DME | 25.00 | ISDN | 50.00 |
| DOL | 25.00 | DME | 33.00 | ISDN | 42.00 |
| DOL | 25.00 | DME | 50.00 | ISDN | 25.00 |
| DOL | 25.00 | DME | 15.00 | TTE | 60.00 |
| DOL | 25.00 | DME | 25.00 | TTE | 50.00 |
| DOL | 25.00 | DME | 33.00 | TTE | 42.00 |
| DOL | 25.00 | DME | 50.00 | TTE | 25.00 |
| DOL | 25.00 | TOL | 15.00 | BFE | 60.00 |
| DOL | 25.00 | TOL | 25.00 | BFE | 50.00 |
| DOL | 25.00 | TOL | 33.00 | BFE | 42.00 |
| DOL | 25.00 | TOL | 50.00 | BFE | 25.00 |
| DOL | 25.00 | TOL | 15.00 | 3FP | 60.00 |
| DOL | 25.00 | TOL | 25.00 | 3FP | 50.00 |
| DOL | 25.00 | TOL | 33.00 | 3FP | 42.00 |
| DOL | 25.00 | TOL | 50.00 | 3FP | 25.00 |
| DOL | 25.00 | TOL | 15.00 | BFTE | 60.00 |
| DOL | 25.00 | TOL | 25.00 | BFTE | 50.00 |
| DOL | 25.00 | TOL | 33.00 | BFTE | 42.00 |
| DOL | 25.00 | TOL | 50.00 | BFTE | 25.00 |
| DOL | 25.00 | TOL | 15.00 | FDMB | 60.00 |
| DOL | 25.00 | TOL | 25.00 | FDMB | 50.00 |
| DOL | 25.00 | TOL | 33.00 | FDMB | 42.00 |
| DOL | 25.00 | TOL | 50.00 | FDMB | 25.00 |
| DOL | 25.00 | TOL | 15.00 | ISDN | 60.00 |
| DOL | 25.00 | TOL | 25.00 | ISDN | 50.00 |
| DOL | 25.00 | TOL | 33.00 | ISDN | 42.00 |
| DOL | 25.00 | TOL | 50.00 | ISDN | 25.00 |
| DOL | 25.00 | TOL | 15.00 | TTE | 60.00 |
| DOL | 25.00 | TOL | 25.00 | TTE | 50.00 |
| DOL | 25.00 | TOL | 33.00 | TTE | 42.00 |
| DOL | 25.00 | TOL | 50.00 | TTE | 25.00 |
| DOL | 25.00 | SUL | 15.00 | BFE | 60.00 |
| DOL | 25.00 | SUL | 25.00 | BFE | 50.00 |
| DOL | 25.00 | SUL | 33.00 | BFE | 42.00 |
| DOL | 25.00 | SUL | 50.00 | BFE | 25.00 |
| DOL | 25.00 | SUL | 15.00 | 3FP | 60.00 |
| DOL | 25.00 | SUL | 25.00 | 3FP | 50.00 |
| DOL | 25.00 | SUL | 33.00 | 3FP | 42.00 |
| DOL | 25.00 | SUL | 50.00 | 3FP | 25.00 |
| DOL | 25.00 | SUL | 15.00 | BFTE | 60.00 |
| DOL | 25.00 | SUL | 25.00 | BFTE | 50.00 |
| DOL | 25.00 | SUL | 33.00 | BFTE | 42.00 |
| DOL | 25.00 | SUL | 50.00 | BFTE | 25.00 |
| DOL | 25.00 | SUL | 15.00 | FDMB | 60.00 |
| DOL | 25.00 | SUL | 25.00 | FDMB | 50.00 |
| DOL | 25.00 | SUL | 33.00 | FDMB | 42.00 |
| DOL | 25.00 | SUL | 50.00 | FDMB | 25.00 |
| DOL | 25.00 | SUL | 15.00 | ISDN | 60.00 |
| DOL | 25.00 | SUL | 25.00 | ISDN | 50.00 |
| DOL | 25.00 | SUL | 33.00 | ISDN | 42.00 |
| DOL | 25.00 | SUL | 50.00 | ISDN | 25.00 |
| DOL | 25.00 | SUL | 15.00 | TTE | 60.00 |
| DOL | 25.00 | SUL | 25.00 | TTE | 50.00 |
| DOL | 25.00 | SUL | 33.00 | TTE | 42.00 |
| DOL | 25.00 | SUL | 50.00 | TTE | 25.00 |
| DOL | 33.00 | DME | 15.00 | BFE | 52.00 |
| DOL | 33.00 | DME | 25.00 | BFE | 42.00 |
| DOL | 33.00 | DME | 33.00 | BFE | 34.00 |
| DOL | 33.00 | DME | 50.00 | BFE | 17.00 |
| DOL | 33.00 | DME | 15.00 | 3FP | 52.00 |
| DOL | 33.00 | DME | 25.00 | 3FP | 42.00 |
| DOL | 33.00 | DME | 33.00 | 3FP | 34.00 |
| DOL | 33.00 | DME | 50.00 | 3FP | 17.00 |
| DOL | 33.00 | DME | 15.00 | BFTE | 52.00 |
| DOL | 33.00 | DME | 25.00 | BFTE | 42.00 |
| DOL | 33.00 | DME | 33.00 | BFTE | 34.00 |
| DOL | 33.00 | DME | 50.00 | BFTE | 17.00 |
| DOL | 33.00 | DME | 15.00 | FDMB | 52.00 |
| DOL | 33.00 | DME | 25.00 | FDMB | 42.00 |
| DOL | 33.00 | DME | 33.00 | FDMB | 34.00 |
| DOL | 33.00 | DME | 50.00 | FDMB | 17.00 |
| DOL | 33.00 | DME | 15.00 | ISDN | 52.00 |
| DOL | 33.00 | DME | 25.00 | ISDN | 42.00 |
| DOL | 33.00 | DME | 33.00 | ISDN | 34.00 |
| DOL | 33.00 | DME | 50.00 | ISDN | 17.00 |
| DOL | 33.00 | DME | 15.00 | TTE | 52.00 |
| DOL | 33.00 | DME | 25.00 | TTE | 42.00 |
| DOL | 33.00 | DME | 33.00 | TTE | 34.00 |
| DOL | 33.00 | DME | 50.00 | TTE | 17.00 |
| DOL | 33.00 | TOL | 15.00 | BFE | 52.00 |
| DOL | 33.00 | TOL | 25.00 | BFE | 42.00 |
| DOL | 33.00 | TOL | 33.00 | BFE | 34.00 |
| DOL | 33.00 | TOL | 50.00 | BFE | 17.00 |
| DOL | 33.00 | TOL | 15.00 | 3FP | 52.00 |
| DOL | 33.00 | TOL | 25.00 | 3FP | 42.00 |
| DOL | 33.00 | TOL | 33.00 | 3FP | 34.00 |
| DOL | 33.00 | TOL | 50.00 | 3FP | 17.00 |
| DOL | 33.00 | TOL | 15.00 | BFTE | 52.00 |
| DOL | 33.00 | TOL | 25.00 | BFTE | 42.00 |
| DOL | 33.00 | TOL | 33.00 | BFTE | 34.00 |
| DOL | 33.00 | TOL | 50.00 | BFTE | 17.00 |
| DOL | 33.00 | TOL | 15.00 | FDMB | 52.00 |
| DOL | 33.00 | TOL | 25.00 | FDMB | 42.00 |
| DOL | 33.00 | TOL | 33.00 | FDMB | 34.00 |
| DOL | 33.00 | TOL | 50.00 | FDMB | 17.00 |
| DOL | 33.00 | TOL | 15.00 | ISDN | 52.00 |
| DOL | 33.00 | TOL | 25.00 | ISDN | 42.00 |
| DOL | 33.00 | TOL | 33.00 | ISDN | 34.00 |
| DOL | 33.00 | TOL | 50.00 | ISDN | 17.00 |
| DOL | 33.00 | TOL | 15.00 | TTE | 52.00 |
| DOL | 33.00 | TOL | 25.00 | TTE | 42.00 |
| DOL | 33.00 | TOL | 33.00 | TTE | 34.00 |
| DOL | 33.00 | TOL | 50.00 | TTE | 17.00 |
| DOL | 33.00 | SUL | 15.00 | BFE | 52.00 |
| DOL | 33.00 | SUL | 25.00 | BFE | 42.00 |
| DOL | 33.00 | SUL | 33.00 | BFE | 34.00 |
| DOL | 33.00 | SUL | 50.00 | BFE | 17.00 |
| DOL | 33.00 | SUL | 15.00 | 3FP | 52.00 |
| DOL | 33.00 | SUL | 25.00 | 3FP | 42.00 |
| DOL | 33.00 | SUL | 33.00 | 3FP | 34.00 |
| DOL | 33.00 | SUL | 50.00 | 3FP | 17.00 |
| DOL | 33.00 | SUL | 15.00 | BFTE | 52.00 |
| DOL | 33.00 | SUL | 25.00 | BFTE | 42.00 |
| DOL | 33.00 | SUL | 33.00 | BFTE | 34.00 |
| DOL | 33.00 | SUL | 50.00 | BFTE | 17.00 |
| DOL | 33.00 | SUL | 15.00 | FDMB | 52.00 |
| DOL | 33.00 | SUL | 25.00 | FDMB | 42.00 |
| DOL | 33.00 | SUL | 33.00 | FDMB | 34.00 |
| DOL | 33.00 | SUL | 50.00 | FDMB | 17.00 |
| DOL | 33.00 | SUL | 15.00 | ISDN | 52.00 |
| DOL | 33.00 | SUL | 25.00 | ISDN | 42.00 |
| DOL | 33.00 | SUL | 33.00 | ISDN | 34.00 |
| DOL | 33.00 | SUL | 50.00 | ISDN | 17.00 |
| DOL | 33.00 | SUL | 15.00 | TTE | 52.00 |
| DOL | 33.00 | SUL | 25.00 | TTE | 42.00 |
| DOL | 33.00 | SUL | 33.00 | TTE | 34.00 |
| DOL | 33.00 | SUL | 50.00 | TTE | 17.00 |
| DOL | 50.00 | DME | 10.00 | BFE | 40.00 |
| DOL | 50.00 | DME | 25.00 | BFE | 25.00 |
| DOL | 50.00 | DME | 33.00 | BFE | 17.00 |
| DOL | 50.00 | DME | 15.00 | 3FP | 35.00 |
| DOL | 50.00 | DME | 25.00 | 3FP | 25.00 |
| DOL | 50.00 | DME | 33.00 | 3FP | 17.00 |
| DOL | 50.00 | DME | 15.00 | BFTE | 35.00 |
| DOL | 50.00 | DME | 25.00 | BFTE | 25.00 |
| DOL | 50.00 | DME | 33.00 | BFTE | 17.00 |
| DOL | 50.00 | DME | 15.00 | FDMB | 35.00 |
| DOL | 50.00 | DME | 25.00 | FDMB | 25.00 |
| DOL | 50.00 | DME | 33.00 | FDMB | 17.00 |
| DOL | 50.00 | DME | 15.00 | ISDN | 35.00 |
| DOL | 50.00 | DME | 25.00 | ISDN | 25.00 |
| DOL | 50.00 | DME | 33.00 | ISDN | 17.00 |
| DOL | 50.00 | DME | 15.00 | TTE | 35.00 |
| DOL | 50.00 | DME | 25.00 | TTE | 25.00 |
| DOL | 50.00 | DME | 33.00 | TTE | 17.00 |
| DOL | 50.00 | TOL | 15.00 | BFE | 35.00 |
| DOL | 50.00 | TOL | 25.00 | BFE | 25.00 |
| DOL | 50.00 | TOL | 33.00 | BFE | 17.00 |
| DOL | 50.00 | TOL | 15.00 | 3FP | 35.00 |
| DOL | 50.00 | TOL | 25.00 | 3FP | 25.00 |
| DOL | 50.00 | TOL | 33.00 | 3FP | 17.00 |
| DOL | 50.00 | TOL | 15.00 | BFTE | 35.00 |
| DOL | 50.00 | TOL | 25.00 | BFTE | 25.00 |
| DOL | 50.00 | TOL | 33.00 | BFTE | 17.00 |
| DOL | 50.00 | TOL | 15.00 | FDMB | 35.00 |
| DOL | 50.00 | TOL | 25.00 | FDMB | 25.00 |
| DOL | 50.00 | TOL | 33.00 | FDMB | 17.00 |
| DOL | 50.00 | TOL | 15.00 | ISDN | 35.00 |
| DOL | 50.00 | TOL | 25.00 | ISDN | 25.00 |
| DOL | 50.00 | TOL | 33.00 | ISDN | 17.00 |
| DOL | 50.00 | TOL | 15.00 | TTE | 35.00 |
| DOL | 50.00 | TOL | 25.00 | TTE | 25.00 |
| DOL | 50.00 | TOL | 33.00 | TTE | 17.00 |
| DOL | 50.00 | SUL | 15.00 | BFE | 35.00 |
| DOL | 50.00 | SUL | 25.00 | BFE | 25.00 |
| DOL | 50.00 | SUL | 33.00 | BFE | 17.00 |
| DOL | 50.00 | SUL | 15.00 | 3FP | 35.00 |
| DOL | 50.00 | SUL | 25.00 | 3FP | 25.00 |
| DOL | 50.00 | SUL | 33.00 | 3FP | 17.00 |
| DOL | 50.00 | SUL | 15.00 | BFTE | 35.00 |
| DOL | 50.00 | SUL | 25.00 | BFTE | 25.00 |
| DOL | 50.00 | SUL | 33.00 | BFTE | 17.00 |
| DOL | 50.00 | SUL | 15.00 | FDMB | 35.00 |
| DOL | 50.00 | SUL | 25.00 | FDMB | 25.00 |
| DOL | 50.00 | SUL | 33.00 | FDMB | 17.00 |
| DOL | 50.00 | SUL | 15.00 | ISDN | 35.00 |
| DOL | 50.00 | SUL | 25.00 | ISDN | 25.00 |
| DOL | 50.00 | SUL | 33.00 | ISDN | 17.00 |
| DOL | 50.00 | SUL | 15.00 | TTE | 35.00 |
| DOL | 50.00 | SUL | 25.00 | TTE | 25.00 |
| DOL | 50.00 | SUL | 33.00 | TTE | 17.00 |
| SUL | 10.00 | DOL | 15.00 | BFE | 75.00 |
| SUL | 10.00 | DOL | 25.00 | BFE | 65.00 |
| SUL | 10.00 | DOL | 33.00 | BFE | 57.00 |
| SUL | 10.00 | DOL | 50.00 | BFE | 40.00 |
| SUL | 10.00 | DOL | 65.00 | BFE | 25.00 |
| SUL | 10.00 | DOL | 15.00 | 3FP | 75.00 |
| SUL | 10.00 | DOL | 25.00 | 3FP | 65.00 |
| SUL | 10.00 | DOL | 33.00 | 3FP | 57.00 |
| SUL | 10.00 | DOL | 50.00 | 3FP | 40.00 |
| SUL | 10.00 | DOL | 65.00 | 3FP | 25.00 |
| SUL | 10.00 | DOL | 15.00 | BFTE | 75.00 |
| SUL | 10.00 | DOL | 25.00 | BFTE | 65.00 |
| SUL | 10.00 | DOL | 33.00 | BFTE | 57.00 |
| SUL | 10.00 | DOL | 50.00 | BFTE | 40.00 |
| SUL | 10.00 | DOL | 65.00 | BFTE | 25.00 |
| SUL | 10.00 | DOL | 15.00 | FDMB | 75.00 |
| SUL | 10.00 | DOL | 25.00 | FDMB | 65.00 |
| SUL | 10.00 | DOL | 33.00 | FDMB | 57.00 |
| SUL | 10.00 | DOL | 50.00 | FDMB | 40.00 |
| SUL | 10.00 | DOL | 65.00 | FDMB | 25.00 |
| SUL | 10.00 | DOL | 15.00 | ISDN | 75.00 |
| SUL | 10.00 | DOL | 25.00 | ISDN | 65.00 |
| SUL | 10.00 | DOL | 33.00 | ISDN | 57.00 |
| SUL | 10.00 | DOL | 50.00 | ISDN | 40.00 |
| SUL | 10.00 | DOL | 65.00 | ISDN | 25.00 |
| SUL | 10.00 | DOL | 15.00 | TTE | 75.00 |
| SUL | 10.00 | DOL | 25.00 | TTE | 65.00 |
| SUL | 10.00 | DOL | 33.00 | TTE | 57.00 |
| SUL | 10.00 | DOL | 50.00 | TTE | 40.00 |
| SUL | 10.00 | DOL | 65.00 | TTE | 25.00 |
| SUL | 10.00 | TOL | 15.00 | BFE | 75.00 |
| SUL | 10.00 | TOL | 25.00 | BFE | 65.00 |
| SUL | 10.00 | TOL | 33.00 | BFE | 57.00 |
| SUL | 10.00 | TOL | 50.00 | BFE | 40.00 |
| SUL | 10.00 | TOL | 65.00 | BFE | 25.00 |
| SUL | 10.00 | TOL | 15.00 | 3FP | 75.00 |
| SUL | 10.00 | TOL | 25.00 | 3FP | 65.00 |
| SUL | 10.00 | TOL | 33.00 | 3FP | 57.00 |
| SUL | 10.00 | TOL | 50.00 | 3FP | 40.00 |
| SUL | 10.00 | TOL | 65.00 | 3FP | 25.00 |
| SUL | 10.00 | TOL | 15.00 | BFTE | 75.00 |
| SUL | 10.00 | TOL | 25.00 | BFTE | 65.00 |
| SUL | 10.00 | TOL | 33.00 | BFTE | 57.00 |
| SUL | 10.00 | TOL | 50.00 | BFTE | 40.00 |
| SUL | 10.00 | TOL | 65.00 | BFTE | 25.00 |
| SUL | 10.00 | TOL | 15.00 | FDMB | 75.00 |
| SUL | 10.00 | TOL | 25.00 | FDMB | 65.00 |
| SUL | 10.00 | TOL | 33.00 | FDMB | 57.00 |
| SUL | 10.00 | TOL | 50.00 | FDMB | 40.00 |
| SUL | 10.00 | TOL | 65.00 | FDMB | 25.00 |
| SUL | 10.00 | TOL | 15.00 | ISDN | 75.00 |
| SUL | 10.00 | TOL | 25.00 | ISDN | 65.00 |
| SUL | 10.00 | TOL | 33.00 | ISDN | 57.00 |
| SUL | 10.00 | TOL | 50.00 | ISDN | 40.00 |
| SUL | 10.00 | TOL | 65.00 | ISDN | 25.00 |
| SUL | 10.00 | TOL | 15.00 | TTE | 75.00 |
| SUL | 10.00 | TOL | 25.00 | TTE | 65.00 |
| SUL | 10.00 | TOL | 33.00 | TTE | 57.00 |
| SUL | 10.00 | TOL | 50.00 | TTE | 40.00 |
| SUL | 10.00 | TOL | 65.00 | TTE | 25.00 |
| SUL | 25.00 | DME | 15.00 | BFE | 60.00 |
| SUL | 25.00 | DME | 25.00 | BFE | 50.00 |
| SUL | 25.00 | DME | 33.00 | BFE | 42.00 |
| SUL | 25.00 | DME | 50.00 | BFE | 25.00 |
| SUL | 25.00 | DME | 15.00 | 3FP | 60.00 |
| SUL | 25.00 | DME | 25.00 | 3FP | 50.00 |
| SUL | 25.00 | DME | 33.00 | 3FP | 42.00 |
| SUL | 25.00 | DME | 50.00 | 3FP | 25.00 |
| SUL | 25.00 | DME | 15.00 | BFTE | 60.00 |
| SUL | 25.00 | DME | 25.00 | BFTE | 50.00 |
| SUL | 25.00 | DME | 33.00 | BFTE | 42.00 |
| SUL | 25.00 | DME | 50.00 | BFTE | 25.00 |
| SUL | 25.00 | DME | 15.00 | FDMB | 60.00 |
| SUL | 25.00 | DME | 25.00 | FDMB | 50.00 |
| SUL | 25.00 | DME | 33.00 | FDMB | 42.00 |
| SUL | 25.00 | DME | 50.00 | FDMB | 25.00 |
| SUL | 25.00 | DME | 15.00 | ISDN | 60.00 |
| SUL | 25.00 | DME | 25.00 | ISDN | 50.00 |
| SUL | 25.00 | DME | 33.00 | ISDN | 42.00 |
| SUL | 25.00 | DME | 50.00 | ISDN | 25.00 |
| SUL | 25.00 | DME | 15.00 | TTE | 60.00 |
| SUL | 25.00 | DME | 25.00 | TTE | 50.00 |
| SUL | 25.00 | DME | 33.00 | TTE | 42.00 |
| SUL | 25.00 | DME | 50.00 | TTE | 25.00 |
| SUL | 25.00 | DOL | 15.00 | BFE | 60.00 |
| SUL | 25.00 | DOL | 25.00 | BFE | 50.00 |
| SUL | 25.00 | DOL | 33.00 | BFE | 42.00 |
| SUL | 25.00 | DOL | 50.00 | BFE | 25.00 |
| SUL | 25.00 | DOL | 15.00 | 3FP | 60.00 |
| SUL | 25.00 | DOL | 25.00 | 3FP | 50.00 |
| SUL | 25.00 | DOL | 33.00 | 3FP | 42.00 |
| SUL | 25.00 | DOL | 50.00 | 3FP | 25.00 |
| SUL | 25.00 | DOL | 15.00 | BFTE | 60.00 |
| SUL | 25.00 | DOL | 25.00 | BFTE | 50.00 |
| SUL | 25.00 | DOL | 33.00 | BFTE | 42.00 |
| SUL | 25.00 | DOL | 50.00 | BFTE | 25.00 |
| SUL | 25.00 | DOL | 15.00 | FDMB | 60.00 |
| SUL | 25.00 | DOL | 25.00 | FDMB | 50.00 |
| SUL | 25.00 | DOL | 33.00 | FDMB | 42.00 |
| SUL | 25.00 | DOL | 50.00 | FDMB | 25.00 |
| SUL | 25.00 | DOL | 15.00 | ISDN | 60.00 |
| SUL | 25.00 | DOL | 25.00 | ISDN | 50.00 |
| SUL | 25.00 | DOL | 33.00 | ISDN | 42.00 |
| SUL | 25.00 | DOL | 50.00 | ISDN | 25.00 |
| SUL | 25.00 | DOL | 15.00 | TTE | 60.00 |
| SUL | 25.00 | DOL | 25.00 | TTE | 50.00 |
| SUL | 25.00 | DOL | 33.00 | TTE | 42.00 |
| SUL | 25.00 | DOL | 50.00 | TTE | 25.00 |
| SUL | 25.00 | TOL | 15.00 | BFE | 60.00 |
| SUL | 25.00 | TOL | 25.00 | BFE | 50.00 |
| SUL | 25.00 | TOL | 33.00 | BFE | 42.00 |
| SUL | 25.00 | TOL | 50.00 | BFE | 25.00 |
| SUL | 25.00 | TOL | 15.00 | 3FP | 60.00 |
| SUL | 25.00 | TOL | 25.00 | 3FP | 50.00 |
| SUL | 25.00 | TOL | 33.00 | 3FP | 42.00 |
| SUL | 25.00 | TOL | 50.00 | 3FP | 25.00 |
| SUL | 25.00 | TOL | 15.00 | BFTE | 60.00 |
| SUL | 25.00 | TOL | 25.00 | BFTE | 50.00 |
| SUL | 25.00 | TOL | 33.00 | BFTE | 42.00 |
| SUL | 25.00 | TOL | 50.00 | BFTE | 25.00 |
| SUL | 25.00 | TOL | 15.00 | FDMB | 60.00 |
| SUL | 25.00 | TOL | 25.00 | FDMB | 50.00 |
| SUL | 25.00 | TOL | 33.00 | FDMB | 42.00 |
| SUL | 25.00 | TOL | 50.00 | FDMB | 25.00 |
| SUL | 25.00 | TOL | 15.00 | ISDN | 60.00 |
| SUL | 25.00 | TOL | 25.00 | ISDN | 50.00 |
| SUL | 25.00 | TOL | 33.00 | ISDN | 42.00 |
| SUL | 25.00 | TOL | 50.00 | ISDN | 25.00 |
| SUL | 25.00 | TOL | 15.00 | TTE | 60.00 |
| SUL | 25.00 | TOL | 25.00 | TTE | 50.00 |
| SUL | 25.00 | TOL | 33.00 | TTE | 42.00 |
| SUL | 25.00 | TOL | 50.00 | TTE | 25.00 |
| SUL | 33.00 | DME | 15.00 | BFE | 52.00 |
| SUL | 33.00 | DME | 25.00 | BFE | 42.00 |
| SUL | 33.00 | DME | 33.00 | BFE | 34.00 |
| SUL | 33.00 | DME | 50.00 | BFE | 17.00 |
| SUL | 33.00 | DME | 15.00 | 3FP | 52.00 |
| SUL | 33.00 | DME | 25.00 | 3FP | 42.00 |
| SUL | 33.00 | DME | 33.00 | 3FP | 34.00 |
| SUL | 33.00 | DME | 50.00 | 3FP | 17.00 |
| SUL | 33.00 | DME | 15.00 | BFTE | 52.00 |
| SUL | 33.00 | DME | 25.00 | BFTE | 42.00 |
| SUL | 33.00 | DME | 33.00 | BFTE | 34.00 |
| SUL | 33.00 | DME | 50.00 | BFTE | 17.00 |
| SUL | 33.00 | DME | 15.00 | FDMB | 52.00 |
| SUL | 33.00 | DME | 25.00 | FDMB | 42.00 |
| SUL | 33.00 | DME | 33.00 | FDMB | 34.00 |
| SUL | 33.00 | DME | 50.00 | FDMB | 17.00 |
| SUL | 33.00 | DME | 15.00 | ISDN | 52.00 |
| SUL | 33.00 | DME | 25.00 | ISDN | 42.00 |
| SUL | 33.00 | DME | 33.00 | ISDN | 34.00 |
| SUL | 33.00 | DME | 50.00 | ISDN | 17.00 |
| SUL | 33.00 | DME | 15.00 | TTE | 52.00 |
| SUL | 33.00 | DME | 25.00 | TTE | 42.00 |
| SUL | 33.00 | DME | 33.00 | TTE | 34.00 |
| SUL | 33.00 | DME | 50.00 | TTE | 17.00 |
| SUL | 33.00 | DOL | 15.00 | BFE | 52.00 |
| SUL | 33.00 | DOL | 25.00 | BFE | 42.00 |
| SUL | 33.00 | DOL | 33.00 | BFE | 34.00 |
| SUL | 33.00 | DOL | 50.00 | BFE | 17.00 |
| SUL | 33.00 | DOL | 15.00 | 3FP | 52.00 |
| SUL | 33.00 | DOL | 25.00 | 3FP | 42.00 |
| SUL | 33.00 | DOL | 33.00 | 3FP | 34.00 |
| SUL | 33.00 | DOL | 50.00 | 3FP | 17.00 |
| SUL | 33.00 | DOL | 15.00 | BFTE | 52.00 |
| SUL | 33.00 | DOL | 25.00 | BFTE | 42.00 |
| SUL | 33.00 | DOL | 33.00 | BFTE | 34.00 |
| SUL | 33.00 | DOL | 50.00 | BFTE | 17.00 |
| SUL | 33.00 | DOL | 15.00 | FDMB | 52.00 |
| SUL | 33.00 | DOL | 25.00 | FDMB | 42.00 |
| SUL | 33.00 | DOL | 33.00 | FDMB | 34.00 |
| SUL | 33.00 | DOL | 50.00 | FDMB | 17.00 |
| SUL | 33.00 | DOL | 15.00 | ISDN | 52.00 |
| SUL | 33.00 | DOL | 25.00 | ISDN | 42.00 |
| SUL | 33.00 | DOL | 33.00 | ISDN | 34.00 |
| SUL | 33.00 | DOL | 50.00 | ISDN | 17.00 |
| SUL | 33.00 | DOL | 15.00 | TTE | 52.00 |
| SUL | 33.00 | DOL | 25.00 | TTE | 42.00 |
| SUL | 33.00 | DOL | 33.00 | TTE | 34.00 |
| SUL | 33.00 | DOL | 50.00 | TTE | 17.00 |
| SUL | 33.00 | TOL | 15.00 | BFE | 52.00 |
| SUL | 33.00 | TOL | 25.00 | BFE | 42.00 |
| SUL | 33.00 | TOL | 33.00 | BFE | 34.00 |
| SUL | 33.00 | TOL | 50.00 | BFE | 17.00 |
| SUL | 33.00 | TOL | 15.00 | 3FP | 52.00 |
| SUL | 33.00 | TOL | 25.00 | 3FP | 42.00 |
| SUL | 33.00 | TOL | 33.00 | 3FP | 34.00 |
| SUL | 33.00 | TOL | 50.00 | 3FP | 17.00 |
| SUL | 33.00 | TOL | 15.00 | BFTE | 52.00 |
| SUL | 33.00 | TOL | 25.00 | BFTE | 42.00 |
| SUL | 33.00 | TOL | 33.00 | BFTE | 34.00 |
| SUL | 33.00 | TOL | 50.00 | BFTE | 17.00 |
| SUL | 33.00 | TOL | 15.00 | FDMB | 52.00 |
| SUL | 33.00 | TOL | 25.00 | FDMB | 42.00 |
| SUL | 33.00 | TOL | 33.00 | FDMB | 34.00 |
| SUL | 33.00 | TOL | 50.00 | FDMB | 17.00 |
| SUL | 33.00 | TOL | 15.00 | ISDN | 52.00 |
| SUL | 33.00 | TOL | 25.00 | ISDN | 42.00 |
| SUL | 33.00 | TOL | 33.00 | ISDN | 34.00 |
| SUL | 33.00 | TOL | 50.00 | ISDN | 17.00 |
| SUL | 33.00 | TOL | 15.00 | TTE | 52.00 |
| SUL | 33.00 | TOL | 25.00 | TTE | 42.00 |
| SUL | 33.00 | TOL | 33.00 | TTE | 34.00 |
| SUL | 33.00 | TOL | 50.00 | TTE | 17.00 |
| SUL | 50.00 | DME | 10.00 | BFE | 40.00 |
| SUL | 50.00 | DME | 25.00 | BFE | 25.00 |
| SUL | 50.00 | DME | 33.00 | BFE | 17.00 |
| SUL | 50.00 | DME | 15.00 | 3FP | 35.00 |
| SUL | 50.00 | DME | 25.00 | 3FP | 25.00 |
| SUL | 50.00 | DME | 33.00 | 3FP | 17.00 |
| SUL | 50.00 | DME | 15.00 | BFTE | 35.00 |
| SUL | 50.00 | DME | 25.00 | BFTE | 25.00 |
| SUL | 50.00 | DME | 33.00 | BFTE | 17.00 |
| SUL | 50.00 | DME | 15.00 | FDMB | 35.00 |
| SUL | 50.00 | DME | 25.00 | FDMB | 25.00 |
| SUL | 50.00 | DME | 33.00 | FDMB | 17.00 |
| SUL | 50.00 | DME | 15.00 | ISDN | 35.00 |
| SUL | 50.00 | DME | 25.00 | ISDN | 25.00 |
| SUL | 50.00 | DME | 33.00 | ISDN | 17.00 |
| SUL | 50.00 | DME | 15.00 | TTE | 35.00 |
| SUL | 50.00 | DME | 25.00 | TTE | 25.00 |
| SUL | 50.00 | DME | 33.00 | TTE | 17.00 |
| SUL | 50.00 | DOL | 15.00 | BFE | 35.00 |
| SUL | 50.00 | DOL | 25.00 | BFE | 25.00 |
| SUL | 50.00 | DOL | 33.00 | BFE | 17.00 |
| SUL | 50.00 | DOL | 15.00 | 3FP | 35.00 |
| SUL | 50.00 | DOL | 25.00 | 3FP | 25.00 |
| SUL | 50.00 | DOL | 33.00 | 3FP | 17.00 |
| SUL | 50.00 | DOL | 15.00 | BFTE | 35.00 |
| SUL | 50.00 | DOL | 25.00 | BFTE | 25.00 |
| SUL | 50.00 | DOL | 33.00 | BFTE | 17.00 |
| SUL | 50.00 | DOL | 15.00 | FDMB | 35.00 |
| SUL | 50.00 | DOL | 25.00 | FDMB | 25.00 |
| SUL | 50.00 | DOL | 33.00 | FDMB | 17.00 |
| SUL | 50.00 | DOL | 15.00 | ISDN | 35.00 |
| SUL | 50.00 | DOL | 25.00 | ISDN | 25.00 |
| SUL | 50.00 | DOL | 33.00 | ISDN | 17.00 |
| SUL | 50.00 | DOL | 15.00 | TTE | 35.00 |
| SUL | 50.00 | DOL | 25.00 | TTE | 25.00 |
| SUL | 50.00 | DOL | 33.00 | TTE | 17.00 |
| SUL | 50.00 | TOL | 15.00 | BFE | 35.00 |
| SUL | 50.00 | TOL | 25.00 | BFE | 25.00 |
| SUL | 50.00 | TOL | 33.00 | BFE | 17.00 |
| SUL | 50.00 | TOL | 15.00 | 3FP | 35.00 |
| SUL | 50.00 | TOL | 25.00 | 3FP | 25.00 |
| SUL | 50.00 | TOL | 33.00 | 3FP | 17.00 |
| SUL | 50.00 | TOL | 15.00 | BFTE | 35.00 |
| SUL | 50.00 | TOL | 25.00 | BFTE | 25.00 |
| SUL | 50.00 | TOL | 33.00 | BFTE | 17.00 |
| SUL | 50.00 | TOL | 15.00 | FDMB | 35.00 |
| SUL | 50.00 | TOL | 25.00 | FDMB | 25.00 |
| SUL | 50.00 | TOL | 33.00 | FDMB | 17.00 |
| SUL | 50.00 | TOL | 15.00 | ISDN | 35.00 |
| SUL | 50.00 | TOL | 25.00 | ISDN | 25.00 |
| SUL | 50.00 | TOL | 33.00 | ISDN | 17.00 |
| SUL | 50.00 | TOL | 15.00 | TTE | 35.00 |
| SUL | 50.00 | TOL | 25.00 | TTE | 25.00 |
| SUL | 50.00 | TOL | 33.00 | TTE | 17.00 |
| TOL | 25.00 | none | 0 | BFE | 75.00 |
| TOL | 25.00 | none | 0 | 3FP | 75.00 |
| TOL | 25.00 | none | 0 | BFTE | 75.00 |
| TOL | 25.00 | none | 0 | FDMB | 75.00 |
| TOL | 25.00 | none | 0 | ISDN | 75.00 |
| TOL | 25.00 | none | 0 | TTE | 75.00 |
| TOL | 33.00 | none | 0 | BFE | 67.00 |
| TOL | 33.00 | none | 0 | 3FP | 67.00 |
| TOL | 33.00 | none | 0 | BFTE | 67.00 |
| TOL | 33.00 | none | 0 | FDMB | 67.00 |
| TOL | 33.00 | none | 0 | ISDN | 67.00 |
| TOL | 33.00 | none | 0 | TTE | 67.00 |
| TOL | 50.00 | none | 0 | BFE | 50.00 |
| TOL | 50.00 | none | 0 | 3FP | 50.00 |
| TOL | 50.00 | none | 0 | BFTE | 50.00 |
| TOL | 50.00 | none | 0 | FDMB | 50.00 |
| TOL | 50.00 | none | 0 | ISDN | 50.00 |
| TOL | 50.00 | none | 0 | TTE | 50.00 |
| TOL | 75.00 | none | 0 | BFE | 25.00 |
| TOL | 75.00 | none | 0 | 3FP | 25.00 |
| TOL | 75.00 | none | 0 | BFTE | 25.00 |
| TOL | 75.00 | none | 0 | FDMB | 25.00 |
| TOL | 75.00 | none | 0 | ISDN | 25.00 |
| TOL | 75.00 | none | 0 | TTE | 25.00 |
| TOL | 10.00 | DME | 15.00 | BFE | 75.00 |
| TOL | 10.00 | DME | 25.00 | BFE | 65.00 |
| TOL | 10.00 | DME | 33.00 | BFE | 57.00 |
| TOL | 10.00 | DME | 50.00 | BFE | 40.00 |
| TOL | 10.00 | DME | 65.00 | BFE | 25.00 |
| TOL | 10.00 | DME | 15.00 | 3FP | 75.00 |
| TOL | 10.00 | DME | 25.00 | 3FP | 65.00 |
| TOL | 10.00 | DME | 33.00 | 3FP | 57.00 |
| TOL | 10.00 | DME | 50.00 | 3FP | 40.00 |
| TOL | 10.00 | DME | 65.00 | 3FP | 25.00 |
| TOL | 10.00 | DME | 15.00 | BFTE | 75.00 |
| TOL | 10.00 | DME | 25.00 | BFTE | 65.00 |
| TOL | 10.00 | DME | 33.00 | BFTE | 57.00 |
| TOL | 10.00 | DME | 50.00 | BFTE | 40.00 |
| TOL | 10.00 | DME | 65.00 | BFTE | 25.00 |
| TOL | 10.00 | DME | 15.00 | FDMB | 75.00 |
| TOL | 10.00 | DME | 25.00 | FDMB | 65.00 |
| TOL | 10.00 | DME | 33.00 | FDMB | 57.00 |
| TOL | 10.00 | DME | 50.00 | FDMB | 40.00 |
| TOL | 10.00 | DME | 65.00 | FDMB | 25.00 |
| TOL | 10.00 | DME | 15.00 | ISDN | 75.00 |
| TOL | 10.00 | DME | 25.00 | ISDN | 65.00 |
| TOL | 10.00 | DME | 33.00 | ISDN | 57.00 |
| TOL | 10.00 | DME | 50.00 | ISDN | 40.00 |
| TOL | 10.00 | DME | 65.00 | ISDN | 25.00 |
| TOL | 10.00 | DME | 15.00 | TTE | 75.00 |
| TOL | 10.00 | DME | 25.00 | TTE | 65.00 |
| TOL | 10.00 | DME | 33.00 | TTE | 57.00 |
| TOL | 10.00 | DME | 50.00 | TTE | 40.00 |
| TOL | 10.00 | DME | 65.00 | TTE | 25.00 |
| TOL | 10.00 | DOL | 15.00 | BFE | 75.00 |
| TOL | 10.00 | DOL | 25.00 | BFE | 65.00 |
| TOL | 10.00 | DOL | 33.00 | BFE | 57.00 |
| TOL | 10.00 | DOL | 50.00 | BFE | 40.00 |
| TOL | 10.00 | DOL | 65.00 | BFE | 25.00 |
| TOL | 10.00 | DOL | 15.00 | 3FP | 75.00 |
| TOL | 10.00 | DOL | 25.00 | 3FP | 65.00 |
| TOL | 10.00 | DOL | 33.00 | 3FP | 57.00 |
| TOL | 10.00 | DOL | 50.00 | 3FP | 40.00 |
| TOL | 10.00 | DOL | 65.00 | 3FP | 25.00 |
| TOL | 10.00 | DOL | 15.00 | BFTE | 75.00 |
| TOL | 10.00 | DOL | 25.00 | BFTE | 65.00 |
| TOL | 10.00 | DOL | 33.00 | BFTE | 57.00 |
| TOL | 10.00 | DOL | 50.00 | BFTE | 40.00 |
| TOL | 10.00 | DOL | 65.00 | BFTE | 25.00 |
| TOL | 10.00 | DOL | 15.00 | FDMB | 75.00 |
| TOL | 10.00 | DOL | 25.00 | FDMB | 65.00 |
| TOL | 10.00 | DOL | 33.00 | FDMB | 57.00 |
| TOL | 10.00 | DOL | 50.00 | FDMB | 40.00 |
| TOL | 10.00 | DOL | 65.00 | FDMB | 25.00 |
| TOL | 10.00 | DOL | 15.00 | ISDN | 75.00 |
| TOL | 10.00 | DOL | 25.00 | ISDN | 65.00 |
| TOL | 10.00 | DOL | 33.00 | ISDN | 57.00 |
| TOL | 10.00 | DOL | 50.00 | ISDN | 40.00 |
| TOL | 10.00 | DOL | 65.00 | ISDN | 25.00 |
| TOL | 10.00 | DOL | 15.00 | TTE | 75.00 |
| TOL | 10.00 | DOL | 25.00 | TTE | 65.00 |
| TOL | 10.00 | DOL | 33.00 | TTE | 57.00 |
| TOL | 10.00 | DOL | 50.00 | TTE | 40.00 |
| TOL | 10.00 | DOL | 65.00 | TTE | 25.00 |
| TOL | 10.00 | SUL | 15.00 | BFE | 75.00 |
| TOL | 10.00 | SUL | 25.00 | BFE | 65.00 |
| TOL | 10.00 | SUL | 33.00 | BFE | 57.00 |
| TOL | 10.00 | SUL | 50.00 | BFE | 40.00 |
| TOL | 10.00 | SUL | 65.00 | BFE | 25.00 |
| TOL | 10.00 | SUL | 15.00 | 3FP | 75.00 |
| TOL | 10.00 | SUL | 25.00 | 3FP | 65.00 |
| TOL | 10.00 | SUL | 33.00 | 3FP | 57.00 |
| TOL | 10.00 | SUL | 50.00 | 3FP | 40.00 |
| TOL | 10.00 | SUL | 65.00 | 3FP | 25.00 |
| TOL | 10.00 | SUL | 15.00 | BFTE | 75.00 |
| TOL | 10.00 | SUL | 25.00 | BFTE | 65.00 |
| TOL | 10.00 | SUL | 33.00 | BFTE | 57.00 |
| TOL | 10.00 | SUL | 50.00 | BFTE | 40.00 |
| TOL | 10.00 | SUL | 65.00 | BFTE | 25.00 |
| TOL | 10.00 | SUL | 15.00 | FDMB | 75.00 |
| TOL | 10.00 | SUL | 25.00 | FDMB | 65.00 |
| TOL | 10.00 | SUL | 33.00 | FDMB | 57.00 |
| TOL | 10.00 | SUL | 50.00 | FDMB | 40.00 |
| TOL | 10.00 | SUL | 65.00 | FDMB | 25.00 |
| TOL | 10.00 | SUL | 15.00 | ISDN | 75.00 |
| TOL | 10.00 | SUL | 25.00 | ISDN | 65.00 |
| TOL | 10.00 | SUL | 33.00 | ISDN | 57.00 |
| TOL | 10.00 | SUL | 50.00 | ISDN | 40.00 |
| TOL | 10.00 | SUL | 65.00 | ISDN | 25.00 |
| TOL | 10.00 | SUL | 15.00 | TTE | 75.00 |
| TOL | 10.00 | SUL | 25.00 | TTE | 65.00 |
| TOL | 10.00 | SUL | 33.00 | TTE | 57.00 |
| TOL | 10.00 | SUL | 50.00 | TTE | 40.00 |
| TOL | 10.00 | SUL | 65.00 | TTE | 25.00 |
| TOL | 25.00 | DME | 15.00 | BFE | 60.00 |
| TOL | 25.00 | DME | 25.00 | BFE | 50.00 |
| TOL | 25.00 | DME | 33.00 | BFE | 42.00 |
| TOL | 25.00 | DME | 50.00 | BFE | 25.00 |
| TOL | 25.00 | DME | 15.00 | 3FP | 60.00 |
| TOL | 25.00 | DME | 25.00 | 3FP | 50.00 |
| TOL | 25.00 | DME | 33.00 | 3FP | 42.00 |
| TOL | 25.00 | DME | 50.00 | 3FP | 25.00 |
| TOL | 25.00 | DME | 15.00 | BFTE | 60.00 |
| TOL | 25.00 | DME | 25.00 | BFTE | 50.00 |
| TOL | 25.00 | DME | 33.00 | BFTE | 42.00 |
| TOL | 25.00 | DME | 50.00 | BFTE | 25.00 |
| TOL | 25.00 | DME | 15.00 | FDMB | 60.00 |
| TOL | 25.00 | DME | 25.00 | FDMB | 50.00 |
| TOL | 25.00 | DME | 33.00 | FDMB | 42.00 |
| TOL | 25.00 | DME | 50.00 | FDMB | 25.00 |
| TOL | 25.00 | DME | 15.00 | ISDN | 60.00 |
| TOL | 25.00 | DME | 25.00 | ISDN | 50.00 |
| TOL | 25.00 | DME | 33.00 | ISDN | 42.00 |
| TOL | 25.00 | DME | 50.00 | ISDN | 25.00 |
| TOL | 25.00 | DME | 15.00 | TTE | 60.00 |
| TOL | 25.00 | DME | 25.00 | TTE | 50.00 |
| TOL | 25.00 | DME | 33.00 | TTE | 42.00 |
| TOL | 25.00 | DME | 50.00 | TTE | 25.00 |
| TOL | 25.00 | DOL | 15.00 | BFE | 60.00 |
| TOL | 25.00 | DOL | 25.00 | BFE | 50.00 |
| TOL | 25.00 | DOL | 33.00 | BFE | 42.00 |
| TOL | 25.00 | DOL | 50.00 | BFE | 25.00 |
| TOL | 25.00 | DOL | 15.00 | 3FP | 60.00 |
| TOL | 25.00 | DOL | 25.00 | 3FP | 50.00 |
| TOL | 25.00 | DOL | 33.00 | 3FP | 42.00 |
| TOL | 25.00 | DOL | 50.00 | 3FP | 25.00 |
| TOL | 25.00 | DOL | 15.00 | BFTE | 60.00 |
| TOL | 25.00 | DOL | 25.00 | BFTE | 50.00 |
| TOL | 25.00 | DOL | 33.00 | BFTE | 42.00 |
| TOL | 25.00 | DOL | 50.00 | BFTE | 25.00 |
| TOL | 25.00 | DOL | 15.00 | FDMB | 60.00 |
| TOL | 25.00 | DOL | 25.00 | FDMB | 50.00 |
| TOL | 25.00 | DOL | 33.00 | FDMB | 42.00 |
| TOL | 25.00 | DOL | 50.00 | FDMB | 25.00 |
| TOL | 25.00 | DOL | 15.00 | ISDN | 60.00 |
| TOL | 25.00 | DOL | 25.00 | ISDN | 50.00 |
| TOL | 25.00 | DOL | 33.00 | ISDN | 42.00 |
| TOL | 25.00 | DOL | 50.00 | ISDN | 25.00 |
| TOL | 25.00 | DOL | 15.00 | TTE | 60.00 |
| TOL | 25.00 | DOL | 25.00 | TTE | 50.00 |
| TOL | 25.00 | DOL | 33.00 | TTE | 42.00 |
| TOL | 25.00 | DOL | 50.00 | TTE | 25.00 |
| TOL | 25.00 | SUL | 15.00 | BFE | 60.00 |
| TOL | 25.00 | SUL | 25.00 | BFE | 50.00 |
| TOL | 25.00 | SUL | 33.00 | BFE | 42.00 |
| TOL | 25.00 | SUL | 50.00 | BFE | 25.00 |
| TOL | 25.00 | SUL | 15.00 | 3FP | 60.00 |
| TOL | 25.00 | SUL | 25.00 | 3FP | 50.00 |
| TOL | 25.00 | SUL | 33.00 | 3FP | 42.00 |
| TOL | 25.00 | SUL | 50.00 | 3FP | 25.00 |
| TOL | 25.00 | SUL | 15.00 | BFTE | 60.00 |
| TOL | 25.00 | SUL | 25.00 | BFTE | 50.00 |
| TOL | 25.00 | SUL | 33.00 | BFTE | 42.00 |
| TOL | 25.00 | SUL | 50.00 | BFTE | 25.00 |
| TOL | 25.00 | SUL | 15.00 | FDMB | 60.00 |
| TOL | 25.00 | SUL | 25.00 | FDMB | 50.00 |
| TOL | 25.00 | SUL | 33.00 | FDMB | 42.00 |
| TOL | 25.00 | SUL | 50.00 | FDMB | 25.00 |
| TOL | 25.00 | SUL | 15.00 | ISDN | 60.00 |
| TOL | 25.00 | SUL | 25.00 | ISDN | 50.00 |
| TOL | 25.00 | SUL | 33.00 | ISDN | 42.00 |
| TOL | 25.00 | SUL | 50.00 | ISDN | 25.00 |
| TOL | 25.00 | SUL | 15.00 | TTE | 60.00 |
| TOL | 25.00 | SUL | 25.00 | TTE | 50.00 |
| TOL | 25.00 | SUL | 33.00 | TTE | 42.00 |
| TOL | 25.00 | SUL | 50.00 | TTE | 25.00 |
| TOL | 33.00 | DME | 15.00 | BFE | 52.00 |
| TOL | 33.00 | DME | 25.00 | BFE | 42.00 |
| TOL | 33.00 | DME | 33.00 | BFE | 34.00 |
| TOL | 33.00 | DME | 50.00 | BFE | 17.00 |
| TOL | 33.00 | DME | 15.00 | 3FP | 52.00 |
| TOL | 33.00 | DME | 25.00 | 3FP | 42.00 |
| TOL | 33.00 | DME | 33.00 | 3FP | 34.00 |
| TOL | 33.00 | DME | 50.00 | 3FP | 17.00 |
| TOL | 33.00 | DME | 15.00 | BFTE | 52.00 |
| TOL | 33.00 | DME | 25.00 | BFTE | 42.00 |
| TOL | 33.00 | DME | 33.00 | BFTE | 34.00 |
| TOL | 33.00 | DME | 50.00 | BFTE | 17.00 |
| TOL | 33.00 | DME | 15.00 | FDMB | 52.00 |
| TOL | 33.00 | DME | 25.00 | FDMB | 42.00 |
| TOL | 33.00 | DME | 33.00 | FDMB | 34.00 |
| TOL | 33.00 | DME | 50.00 | FDMB | 17.00 |
| TOL | 33.00 | DME | 15.00 | ISDN | 52.00 |
| TOL | 33.00 | DME | 25.00 | ISDN | 42.00 |
| TOL | 33.00 | DME | 33.00 | ISDN | 34.00 |
| TOL | 33.00 | DME | 50.00 | ISDN | 17.00 |
| TOL | 33.00 | DME | 15.00 | TTE | 52.00 |
| TOL | 33.00 | DME | 25.00 | TTE | 42.00 |
| TOL | 33.00 | DME | 33.00 | TTE | 34.00 |
| TOL | 33.00 | DME | 50.00 | TTE | 17.00 |
| TOL | 33.00 | DOL | 15.00 | BFE | 52.00 |
| TOL | 33.00 | DOL | 25.00 | BFE | 42.00 |
| TOL | 33.00 | DOL | 33.00 | BFE | 34.00 |
| TOL | 33.00 | DOL | 50.00 | BFE | 17.00 |
| TOL | 33.00 | DOL | 15.00 | 3FP | 52.00 |
| TOL | 33.00 | DOL | 25.00 | 3FP | 42.00 |
| TOL | 33.00 | DOL | 33.00 | 3FP | 34.00 |
| TOL | 33.00 | DOL | 50.00 | 3FP | 17.00 |
| TOL | 33.00 | DOL | 15.00 | BFTE | 52.00 |
| TOL | 33.00 | DOL | 25.00 | BFTE | 42.00 |
| TOL | 33.00 | DOL | 33.00 | BFTE | 34.00 |
| TOL | 33.00 | DOL | 50.00 | BFTE | 17.00 |
| TOL | 33.00 | DOL | 15.00 | FDMB | 52.00 |
| TOL | 33.00 | DOL | 25.00 | FDMB | 42.00 |
| TOL | 33.00 | DOL | 33.00 | FDMB | 34.00 |
| TOL | 33.00 | DOL | 50.00 | FDMB | 17.00 |
| TOL | 33.00 | DOL | 15.00 | ISDN | 52.00 |
| TOL | 33.00 | DOL | 25.00 | ISDN | 42.00 |
| TOL | 33.00 | DOL | 33.00 | ISDN | 34.00 |
| TOL | 33.00 | DOL | 50.00 | ISDN | 17.00 |
| TOL | 33.00 | DOL | 15.00 | TTE | 52.00 |
| TOL | 33.00 | DOL | 25.00 | TTE | 42.00 |
| TOL | 33.00 | DOL | 33.00 | TTE | 34.00 |
| TOL | 33.00 | DOL | 50.00 | TTE | 17.00 |
| TOL | 33.00 | SUL | 15.00 | BFE | 52.00 |
| TOL | 33.00 | SUL | 25.00 | BFE | 42.00 |
| TOL | 33.00 | SUL | 33.00 | BFE | 34.00 |
| TOL | 33.00 | SUL | 50.00 | BFE | 17.00 |
| TOL | 33.00 | SUL | 15.00 | 3FP | 52.00 |
| TOL | 33.00 | SUL | 25.00 | 3FP | 42.00 |
| TOL | 33.00 | SUL | 33.00 | 3FP | 34.00 |
| TOL | 33.00 | SUL | 50.00 | 3FP | 17.00 |
| TOL | 33.00 | SUL | 15.00 | BFTE | 52.00 |
| TOL | 33.00 | SUL | 25.00 | BFTE | 42.00 |
| TOL | 33.00 | SUL | 33.00 | BFTE | 34.00 |
| TOL | 33.00 | SUL | 50.00 | BFTE | 17.00 |
| TOL | 33.00 | SUL | 15.00 | FDMB | 52.00 |
| TOL | 33.00 | SUL | 25.00 | FDMB | 42.00 |
| TOL | 33.00 | SUL | 33.00 | FDMB | 34.00 |
| TOL | 33.00 | SUL | 50.00 | FDMB | 17.00 |
| TOL | 33.00 | SUL | 15.00 | ISDN | 52.00 |
| TOL | 33.00 | SUL | 25.00 | ISDN | 42.00 |
| TOL | 33.00 | SUL | 33.00 | ISDN | 34.00 |
| TOL | 33.00 | SUL | 50.00 | ISDN | 17.00 |
| TOL | 33.00 | SUL | 15.00 | TTE | 52.00 |
| TOL | 33.00 | SUL | 25.00 | TTE | 42.00 |
| TOL | 33.00 | SUL | 33.00 | TTE | 34.00 |
| TOL | 33.00 | SUL | 50.00 | TTE | 17.00 |
| TOL | 50.00 | DME | 10.00 | BFE | 40.00 |
| TOL | 50.00 | DME | 25.00 | BFE | 25.00 |
| TOL | 50.00 | DME | 33.00 | BFE | 17.00 |
| TOL | 50.00 | DME | 15.00 | 3FP | 35.00 |
| TOL | 50.00 | DME | 25.00 | 3FP | 25.00 |
| TOL | 50.00 | DME | 33.00 | 3FP | 17.00 |
| TOL | 50.00 | DME | 15.00 | BFTE | 35.00 |
| TOL | 50.00 | DME | 25.00 | BFTE | 25.00 |
| TOL | 50.00 | DME | 33.00 | BFTE | 17.00 |
| TOL | 50.00 | DME | 15.00 | FDMB | 35.00 |
| TOL | 50.00 | DME | 25.00 | FDMB | 25.00 |
| TOL | 50.00 | DME | 33.00 | FDMB | 17.00 |
| TOL | 50.00 | DME | 15.00 | ISDN | 35.00 |
| TOL | 50.00 | DME | 25.00 | ISDN | 25.00 |
| TOL | 50.00 | DME | 33.00 | ISDN | 17.00 |
| TOL | 50.00 | DME | 15.00 | TTE | 35.00 |
| TOL | 50.00 | DME | 25.00 | TTE | 25.00 |
| TOL | 50.00 | DME | 33.00 | TTE | 17.00 |
| TOL | 50.00 | DOL | 15.00 | BFE | 35.00 |
| TOL | 50.00 | DOL | 25.00 | BFE | 25.00 |
| TOL | 50.00 | DOL | 33.00 | BFE | 17.00 |
| TOL | 50.00 | DOL | 15.00 | 3FP | 35.00 |
| TOL | 50.00 | DOL | 25.00 | 3FP | 25.00 |
| TOL | 50.00 | DOL | 33.00 | 3FP | 17.00 |
| TOL | 50.00 | DOL | 15.00 | BFTE | 35.00 |
| TOL | 50.00 | DOL | 25.00 | BFTE | 25.00 |
| TOL | 50.00 | DOL | 33.00 | BFTE | 17.00 |
| TOL | 50.00 | DOL | 15.00 | FDMB | 35.00 |
| TOL | 50.00 | DOL | 25.00 | FDMB | 25.00 |
| TOL | 50.00 | DOL | 33.00 | FDMB | 17.00 |
| TOL | 50.00 | DOL | 15.00 | ISDN | 35.00 |
| TOL | 50.00 | DOL | 25.00 | ISDN | 25.00 |
| TOL | 50.00 | DOL | 33.00 | ISDN | 17.00 |
| TOL | 50.00 | DOL | 15.00 | TTE | 35.00 |
| TOL | 50.00 | DOL | 25.00 | TTE | 25.00 |
| TOL | 50.00 | DOL | 33.00 | TTE | 17.00 |
| TOL | 50.00 | SUL | 15.00 | BFE | 35.00 |
| TOL | 50.00 | SUL | 25.00 | BFE | 25.00 |
| TOL | 50.00 | SUL | 33.00 | BFE | 17.00 |
| TOL | 50.00 | SUL | 15.00 | 3FP | 35.00 |
| TOL | 50.00 | SUL | 25.00 | 3FP | 25.00 |
| TOL | 50.00 | SUL | 33.00 | 3FP | 17.00 |
| TOL | 50.00 | SUL | 15.00 | BFTE | 35.00 |
| TOL | 50.00 | SUL | 25.00 | BFTE | 25.00 |
| TOL | 50.00 | SUL | 33.00 | BFTE | 17.00 |
| TOL | 50.00 | SUL | 15.00 | FDMB | 35.00 |
| TOL | 50.00 | SUL | 25.00 | FDMB | 25.00 |
| TOL | 50.00 | SUL | 33.00 | FDMB | 17.00 |
| TOL | 50.00 | SUL | 15.00 | ISDN | 35.00 |
| TOL | 50.00 | SUL | 25.00 | ISDN | 25.00 |
| TOL | 50.00 | SUL | 33.00 | ISDN | 17.00 |
| TOL | 50.00 | SUL | 15.00 | TTE | 35.00 |
| TOL | 50.00 | SUL | 25.00 | TTE | 25.00 |
| TOL | 50.00 | SUL | 33.00 | TTE | 17.00 |

TABLE 3
Exemplary Additional Components

| Li-Ion | Conc. | Li-Ion | Conc. | | Conc. |
|---|---|---|---|---|---|
| Transport | (mol/ | Transport | (mol/ | | (mol/ |
| Compound 1 | L) | Compound 2 | L) | Enhancer | L) |
| lithium | 0.10 | none | 0.00 | guanidine | 0.10 |
| bis(trifluoro- | | | | nitrate | |
| methane | | | | | |
| sulfonyl)imide | | | | | |
| (LiTFSI) | | | | | |
| LiTFSI | 0.25 | none | 0.00 | guanidine | 0.10 |
| | | | | nitrate | |
| LiTFSI | 0.40 | none | 0.00 | guanidine | 0.10 |
| | | | | nitrate | |
| LiTFSI | 0.50 | none | 0.00 | guanidine | 0.10 |
| | | | | nitrate | |
| LiTFSI | 0.66 | none | 0.00 | guanidine | 0.10 |
| | | | | nitrate | |
| LiTFSI | 0.75 | none | 0.00 | guanidine | 0.10 |
| | | | | nitrate | |
| LiTFSI | 1.00 | none | 0.00 | guanidine | 0.10 |
| | | | | nitrate | |
| LiTFSI | 0.10 | none | 0.00 | guanidine | 0.15 |
| | | | | nitrate | |
| LiTFSI | 0.25 | none | 0.00 | guanidine | 0.15 |
| | | | | nitrate | |
| LiTFSI | 0.40 | none | 0.00 | guanidine | 0.15 |
| | | | | nitrate | |
| LiTFSI | 0.50 | none | 0.00 | guanidine | 0.15 |
| | | | | nitrate | |
| LiTFSI | 0.66 | none | 0.00 | guanidine | 0.15 |
| | | | | nitrate | |
| LiTFSI | 0.75 | none | 0.00 | guanidine | 0.15 |
| | | | | nitrate | |
| LiTFSI | 1.00 | none | 0.00 | guanidine | 0.15 |
| | | | | nitrate | |
| LiTFSI | 0.10 | lithium | 0.10 | dicyanide | 0.10 |
| | | nitrate | | diamide | |
| | | (LiNO₃) | | (DCDA) | |
| LiTFSI | 0.10 | LiNO₃ | 0.25 | DCDA | 0.10 |
| LiTFSI | 0.10 | LiNO₃ | 0.33 | DCDA | 0.10 |
| LiTFSI | 0.10 | LiNO₃ | 0.50 | DCDA | 0.10 |
| LiTFSI | 0.10 | LiNO₃ | 0.66 | DCDA | 0.10 |
| LiTFSI | 0.10 | LiNO₃ | 0.75 | DCDA | 0.10 |
| LiTFSI | 0.10 | LiNO₃ | 1.00 | DCDA | 0.10 |
| LiTFSI | 0.10 | LiNO₃ | 0.10 | DCDA | 0.15 |
| LiTFSI | 0.10 | LiNO₃ | 0.25 | DCDA | 0.15 |
| LiTFSI | 0.10 | LiNO₃ | 0.33 | DCDA | 0.15 |
| LiTFSI | 0.10 | LiNO₃ | 0.50 | DCDA | 0.15 |
| LiTFSI | 0.10 | LiNO₃ | 0.66 | DCDA | 0.15 |
| LiTFSI | 0.10 | LiNO₃ | 0.75 | DCDA | 0.15 |
| LiTFSI | 0.10 | LiNO₃ | 1.00 | DCDA | 0.15 |
| LiTFSI | 0.25 | LiNO₃ | 0.10 | DCDA | 0.10 |
| LiTFSI | 0.25 | LiNO₃ | 0.25 | DCDA | 0.10 |
| LiTFSI | 0.25 | LiNO₃ | 0.33 | DCDA | 0.10 |
| LiTFSI | 0.25 | LiNO₃ | 0.50 | DCDA | 0.10 |
| LiTFSI | 0.25 | LiNO₃ | 0.66 | DCDA | 0.10 |
| LiTFSI | 0.25 | LiNO₃ | 0.75 | DCDA | 0.10 |
| LiTFSI | 0.25 | LiNO₃ | 1.00 | DCDA | 0.10 |
| LiTFSI | 0.25 | LiNO₃ | 0.10 | DCDA | 0.15 |
| LiTFSI | 0.25 | LiNO₃ | 0.25 | DCDA | 0.15 |
| LiTFSI | 0.25 | LiNO₃ | 0.33 | DCDA | 0.15 |
| LiTFSI | 0.25 | LiNO₃ | 0.50 | DCDA | 0.15 |
| LiTFSI | 0.25 | LiNO₃ | 0.66 | DCDA | 0.15 |
| LiTFSI | 0.25 | LiNO₃ | 0.75 | DCDA | 0.15 |
| LiTFSI | 0.25 | LiNO₃ | 1.00 | DCDA | 0.15 |
| LiTFSI | 0.40 | LiNO₃ | 0.10 | DCDA | 0.10 |
| LiTFSI | 0.40 | LiNO₃ | 0.25 | DCDA | 0.10 |
| LiTFSI | 0.40 | LiNO₃ | 0.33 | DCDA | 0.10 |
| LiTFSI | 0.40 | LiNO₃ | 0.50 | DCDA | 0.10 |
| LiTFSI | 0.40 | LiNO₃ | 0.66 | DCDA | 0.10 |
| LiTFSI | 0.40 | LiNO₃ | 0.75 | DCDA | 0.10 |
| LiTFSI | 0.40 | LiNO₃ | 1.00 | DCDA | 0.10 |
| LiTFSI | 0.40 | LiNO₃ | 0.10 | DCDA | 0.15 |
| LiTFSI | 0.40 | LiNO₃ | 0.25 | DCDA | 0.15 |
| LiTFSI | 0.40 | LiNO₃ | 0.33 | DCDA | 0.15 |
| LiTFSI | 0.40 | LiNO₃ | 0.50 | DCDA | 0.15 |
| LiTFSI | 0.40 | LiNO₃ | 0.66 | DCDA | 0.15 |
| LiTFSI | 0.40 | LiNO₃ | 0.75 | DCDA | 0.15 |
| LiTFSI | 0.40 | LiNO₃ | 1.00 | DCDA | 0.15 |
| LiTFSI | 0.50 | LiNO₃ | 0.10 | DCDA | 0.10 |
| LiTFSI | 0.50 | LiNO₃ | 0.25 | DCDA | 0.10 |
| LiTFSI | 0.50 | LiNO₃ | 0.33 | DCDA | 0.10 |
| LiTFSI | 0.50 | LiNO₃ | 0.50 | DCDA | 0.10 |
| LiTFSI | 0.50 | LiNO₃ | 0.66 | DCDA | 0.10 |
| LiTFSI | 0.50 | LiNO₃ | 0.75 | DCDA | 0.10 |
| LiTFSI | 0.50 | LiNO₃ | 1.00 | DCDA | 0.10 |
| LiTFSI | 0.50 | LiNO₃ | 0.10 | DCDA | 0.15 |
| LiTFSI | 0.50 | LiNO₃ | 0.25 | DCDA | 0.15 |
| LiTFSI | 0.50 | LiNO₃ | 0.33 | DCDA | 0.15 |
| LiTFSI | 0.50 | LiNO₃ | 0.50 | DCDA | 0.15 |
| LiTFSI | 0.50 | LiNO₃ | 0.66 | DCDA | 0.15 |
| LiTFSI | 0.50 | LiNO₃ | 0.75 | DCDA | 0.15 |
| LiTFSI | 0.50 | LiNO₃ | 1.00 | DCDA | 0.15 |
| LiTFSI | 0.66 | LiNO₃ | 0.10 | DCDA | 0.10 |
| LiTFSI | 0.66 | LiNO₃ | 0.25 | DCDA | 0.10 |
| LiTFSI | 0.66 | LiNO₃ | 0.33 | DCDA | 0.10 |
| LiTFSI | 0.66 | LiNO₃ | 0.50 | DCDA | 0.10 |
| LiTFSI | 0.66 | LiNO₃ | 0.66 | DCDA | 0.10 |
| LiTFSI | 0.66 | LiNO₃ | 0.75 | DCDA | 0.10 |
| LiTFSI | 0.66 | LiNO₃ | 1.00 | DCDA | 0.10 |
| LiTFSI | 0.66 | LiNO₃ | 0.10 | DCDA | 0.15 |
| LiTFSI | 0.66 | LiNO₃ | 0.25 | DCDA | 0.15 |
| LiTFSI | 0.66 | LiNO₃ | 0.33 | DCDA | 0.15 |
| LiTFSI | 0.66 | LiNO₃ | 0.50 | DCDA | 0.15 |
| LiTFSI | 0.66 | LiNO₃ | 0.66 | DCDA | 0.15 |
| LiTFSI | 0.66 | LiNO₃ | 0.75 | DCDA | 0.15 |
| LiTFSI | 0.66 | LiNO₃ | 1.00 | DCDA | 0.15 |
| LiTFSI | 0.75 | LiNO₃ | 0.10 | DCDA | 0.10 |
| LiTFSI | 0.75 | LiNO₃ | 0.25 | DCDA | 0.10 |
| LiTFSI | 0.75 | LiNO₃ | 0.33 | DCDA | 0.10 |
| LiTFSI | 0.75 | LiNO₃ | 0.50 | DCDA | 0.10 |
| LiTFSI | 0.75 | LiNO₃ | 0.66 | DCDA | 0.10 |
| LiTFSI | 0.75 | LiNO₃ | 0.75 | DCDA | 0.10 |
| LiTFSI | 0.75 | LiNO₃ | 1.00 | DCDA | 0.10 |
| LiTFSI | 0.75 | LiNO₃ | 0.10 | DCDA | 0.15 |
| LiTFSI | 0.75 | LiNO₃ | 0.25 | DCDA | 0.15 |
| LiTFSI | 0.75 | LiNO₃ | 0.33 | DCDA | 0.15 |
| LiTFSI | 0.75 | LiNO₃ | 0.50 | DCDA | 0.15 |
| LiTFSI | 0.75 | LiNO₃ | 0.66 | DCDA | 0.15 |
| LiTFSI | 0.75 | LiNO₃ | 0.75 | DCDA | 0.15 |
| LiTFSI | 0.75 | LiNO₃ | 1.00 | DCDA | 0.15 |
| LiTFSI | 1.00 | LiNO₃ | 0.10 | DCDA | 0.10 |
| LiTFSI | 1.00 | LiNO₃ | 0.25 | DCDA | 0.10 |
| LiTFSI | 1.00 | LiNO₃ | 0.33 | DCDA | 0.10 |
| LiTFSI | 1.00 | LiNO₃ | 0.50 | DCDA | 0.10 |
| LiTFSI | 1.00 | LiNO₃ | 0.66 | DCDA | 0.10 |
| LiTFSI | 1.00 | LiNO₃ | 0.75 | DCDA | 0.10 |
| LiTFSI | 1.00 | LiNO₃ | 1.00 | DCDA | 0.10 |
| LiTFSI | 1.00 | LiNO₃ | 0.10 | DCDA | 0.15 |
| LiTFSI | 1.00 | LiNO₃ | 0.25 | DCDA | 0.15 |
| LiTFSI | 1.00 | LiNO₃ | 0.33 | DCDA | 0.15 |
| LiTFSI | 1.00 | LiNO₃ | 0.50 | DCDA | 0.15 |
| LiTFSI | 1.00 | LiNO₃ | 0.66 | DCDA | 0.15 |
| LiTFSI | 1.00 | LiNO₃ | 0.75 | DCDA | 0.15 |
| LiTFSI | 1.00 | LiNO₃ | 1.00 | DCDA | 0.15 |
| LiTFSI | 0.10 | lithium | 0.10 | guanine | 0.10 |
| | | Perchlorate | | | |
| | | (LiClO₄) | | | |
| LiTFSI | 0.10 | LiClO₄ | 0.25 | guanine | 0.10 |
| LiTFSI | 0.10 | LiClO₄ | 0.33 | guanine | 0.10 |
| LiTFSI | 0.10 | LiClO₄ | 0.50 | guanine | 0.10 |
| LiTFSI | 0.10 | LiClO₄ | 0.66 | guanine | 0.10 |
| LiTFSI | 0.10 | LiClO₄ | 0.75 | guanine | 0.10 |
| LiTFSI | 0.10 | LiClO₄ | 1.00 | guanine | 0.10 |
| LiTFSI | 0.10 | LiClO₄ | 0.10 | guanine | 0.15 |
| LiTFSI | 0.10 | LiClO₄ | 0.25 | guanine | 0.15 |
| LiTFSI | 0.10 | LiClO₄ | 0.33 | guanine | 0.15 |
| LiTFSI | 0.10 | LiClO₄ | 0.50 | guanine | 0.15 |
| LiTFSI | 0.10 | LiClO₄ | 0.66 | guanine | 0.15 |
| LiTFSI | 0.10 | LiClO₄ | 0.75 | guanine | 0.15 |
| LiTFSI | 0.10 | LiClO₄ | 1.00 | guanine | 0.15 |
| LiTFSI | 0.25 | LiClO₄ | 0.10 | guanine | 0.10 |
| LiTFSI | 0.25 | LiClO₄ | 0.25 | guanine | 0.10 |
| LiTFSI | 0.25 | LiClO₄ | 0.33 | guanine | 0.10 |
| LiTFSI | 0.25 | LiClO₄ | 0.50 | guanine | 0.10 |
| LiTFSI | 0.25 | LiClO₄ | 0.66 | guanine | 0.10 |
| LiTFSI | 0.25 | LiClO₄ | 0.75 | guanine | 0.10 |
| LiTFSI | 0.25 | LiClO₄ | 1.00 | guanine | 0.10 |
| LiTFSI | 0.25 | LiClO₄ | 0.10 | guanine | 0.15 |
| LiTFSI | 0.25 | LiClO₄ | 0.25 | guanine | 0.15 |
| LiTFSI | 0.25 | LiClO₄ | 0.33 | guanine | 0.15 |
| LiTFSI | 0.25 | LiClO₄ | 0.50 | guanine | 0.15 |
| LiTFSI | 0.25 | LiClO₄ | 0.66 | guanine | 0.15 |
| LiTFSI | 0.25 | LiClO₄ | 0.75 | guanine | 0.15 |
| LiTFSI | 0.25 | LiClO₄ | 1.00 | guanine | 0.15 |
| LiTFSI | 0.40 | LiClO₄ | 0.10 | guanine | 0.10 |
| LiTFSI | 0.40 | LiClO₄ | 0.25 | guanine | 0.10 |
| LiTFSI | 0.40 | LiClO₄ | 0.33 | guanine | 0.10 |
| LiTFSI | 0.40 | LiClO₄ | 0.50 | guanine | 0.10 |
| LiTFSI | 0.40 | LiClO₄ | 0.66 | guanine | 0.10 |
| LiTFSI | 0.40 | LiClO₄ | 0.75 | guanine | 0.10 |
| LiTFSI | 0.40 | LiClO₄ | 1.00 | guanine | 0.10 |
| LiTFSI | 0.40 | LiClO₄ | 0.10 | guanine | 0.15 |
| LiTFSI | 0.40 | LiClO₄ | 0.25 | guanine | 0.15 |
| LiTFSI | 0.40 | LiClO₄ | 0.33 | guanine | 0.15 |
| LiTFSI | 0.40 | LiClO₄ | 0.50 | guanine | 0.15 |
| LiTFSI | 0.40 | LiClO₄ | 0.66 | guanine | 0.15 |
| LiTFSI | 0.40 | LiClO₄ | 0.75 | guanine | 0.15 |
| LiTFSI | 0.40 | LiClO₄ | 1.00 | guanine | 0.15 |
| LiTFSI | 0.50 | LiClO₄ | 0.10 | guanine | 0.10 |
| LiTFSI | 0.50 | LiClO₄ | 0.25 | guanine | 0.10 |
| LiTFSI | 0.50 | LiClO₄ | 0.33 | guanine | 0.10 |
| LiTFSI | 0.50 | LiClO₄ | 0.50 | guanine | 0.10 |
| LiTFSI | 0.50 | LiClO₄ | 0.66 | guanine | 0.10 |
| LiTFSI | 0.50 | LiClO₄ | 0.75 | guanine | 0.10 |
| LiTFSI | 0.50 | LiClO₄ | 1.00 | guanine | 0.10 |
| LiTFSI | 0.50 | LiClO₄ | 0.10 | guanine | 0.15 |
| LiTFSI | 0.50 | LiClO₄ | 0.25 | guanine | 0.15 |
| LiTFSI | 0.50 | LiClO₄ | 0.33 | guanine | 0.15 |
| LiTFSI | 0.50 | LiClO₄ | 0.50 | guanine | 0.15 |
| LiTFSI | 0.50 | LiClO₄ | 0.66 | guanine | 0.15 |
| LiTFSI | 0.50 | LiClO₄ | 0.75 | guanine | 0.15 |
| LiTFSI | 0.50 | LiClO₄ | 1.00 | guanine | 0.15 |
| LiTFSI | 0.66 | LiClO₄ | 0.10 | guanine | 0.10 |
| LiTFSI | 0.66 | LiClO₄ | 0.25 | guanine | 0.10 |
| LiTFSI | 0.66 | LiClO₄ | 0.33 | guanine | 0.10 |
| LiTFSI | 0.66 | LiClO₄ | 0.50 | guanine | 0.10 |
| LiTFSI | 0.66 | LiClO₄ | 0.66 | guanine | 0.10 |
| LiTFSI | 0.66 | LiClO₄ | 0.75 | guanine | 0.10 |
| LiTFSI | 0.66 | LiClO₄ | 1.00 | guanine | 0.10 |
| LiTFSI | 0.66 | LiClO₄ | 0.10 | guanine | 0.15 |
| LiTFSI | 0.66 | LiClO₄ | 0.25 | guanine | 0.15 |
| LiTFSI | 0.66 | LiClO₄ | 0.33 | guanine | 0.15 |
| LiTFSI | 0.66 | LiClO₄ | 0.50 | guanine | 0.15 |
| LiTFSI | 0.66 | LiClO₄ | 0.66 | guanine | 0.15 |
| LiTFSI | 0.66 | LiClO₄ | 0.75 | guanine | 0.15 |
| LiTFSI | 0.66 | LiClO₄ | 1.00 | guanine | 0.15 |
| LiTFSI | 0.75 | LiClO₄ | 0.10 | guanine | 0.10 |
| LiTFSI | 0.75 | LiClO₄ | 0.25 | guanine | 0.10 |
| LiTFSI | 0.75 | LiClO₄ | 0.33 | guanine | 0.10 |
| LiTFSI | 0.75 | LiClO₄ | 0.50 | guanine | 0.10 |
| LiTFSI | 0.75 | LiClO₄ | 0.66 | guanine | 0.10 |
| LiTFSI | 0.75 | LiClO₄ | 0.75 | guanine | 0.10 |
| LiTFSI | 0.75 | LiClO₄ | 1.00 | guanine | 0.10 |
| LiTFSI | 0.75 | LiClO₄ | 0.10 | guanine | 0.15 |
| LiTFSI | 0.75 | LiClO₄ | 0.25 | guanine | 0.15 |
| LiTFSI | 0.75 | LiClO₄ | 0.33 | guanine | 0.15 |
| LiTFSI | 0.75 | LiClO₄ | 0.50 | guanine | 0.15 |
| LiTFSI | 0.75 | LiClO₄ | 0.66 | guanine | 0.15 |
| LiTFSI | 0.75 | LiClO₄ | 0.75 | guanine | 0.15 |
| LiTFSI | 0.75 | LiClO₄ | 1.00 | guanine | 0.15 |
| LiTFSI | 1.00 | LiClO₄ | 0.10 | guanine | 0.10 |
| LiTFSI | 1.00 | LiClO₄ | 0.25 | guanine | 0.10 |
| LiTFSI | 1.00 | LiClO₄ | 0.33 | guanine | 0.10 |
| LiTFSI | 1.00 | LiClO₄ | 0.50 | guanine | 0.10 |
| LiTFSI | 1.00 | LiClO₄ | 0.66 | guanine | 0.10 |
| LiTFSI | 1.00 | LiClO₄ | 0.75 | guanine | 0.10 |
| LiTFSI | 1.00 | LiClO₄ | 1.00 | guanine | 0.10 |
| LiTFSI | 1.00 | LiClO₄ | 0.10 | guanine | 0.15 |
| LiTFSI | 1.00 | LiClO₄ | 0.25 | guanine | 0.15 |
| LiTFSI | 1.00 | LiClO₄ | 0.33 | guanine | 0.15 |
| LiTFSI | 1.00 | LiClO₄ | 0.50 | guanine | 0.15 |
| LiTFSI | 1.00 | LiClO₄ | 0.66 | guanine | 0.15 |
| LiTFSI | 1.00 | LiClO₄ | 0.75 | guanine | 0.15 |
| LiTFSI | 1.00 | LiClO₄ | 1.00 | guanine | 0.15 |
| LiTFSI | 0.10 | Lithium | 0.10 | guanidine | 0.10 |
| | | trifluoroacetate | | nitrate | |
| | | (LiTFAc) | | | |
| LiTFSI | 0.10 | LiTFAc | 0.25 | guanidine | 0.10 |
| | | | | nitrate | |
| LiTFSI | 0.10 | LiTFAc | 0.33 | guanidine | 0.10 |
| | | | | nitrate | |
| LiTFSI | 0.10 | LiTFAc | 0.50 | guanidine | 0.10 |
| | | | | nitrate | |
| LiTFSI | 0.10 | LiTFAc | 0.66 | guanidine | 0.10 |
| | | | | nitrate | |
| LiTFSI | 0.10 | LiTFAc | 0.75 | guanidine | 0.10 |
| | | | | nitrate | |
| LiTFSI | 0.10 | LiTFAc | 1.00 | guanidine | 0.10 |
| | | | | nitrate | |
| LiTFSI | 0.10 | LiTFAc | 0.10 | guanidine | 0.15 |
| | | | | nitrate | |
| LiTFSI | 0.10 | LiTFAc | 0.25 | guanidine | 0.15 |
| | | | | nitrate | |
| LiTFSI | 0.10 | LiTFAc | 0.33 | guanidine | 0.15 |
| | | | | nitrate | |
| LiTFSI | 0.10 | LiTFAc | 0.50 | guanidine | 0.15 |
| | | | | nitrate | |
| LiTFSI | 0.10 | LiTFAc | 0.66 | guanidine | 0.15 |
| | | | | nitrate | |
| LiTFSI | 0.10 | LiTFAc | 0.75 | guanidine | 0.15 |
| | | | | nitrate | |
| LiTFSI | 0.10 | LiTFAc | 1.00 | guanidine | 0.15 |
| | | | | nitrate | |
| LiTFSI | 0.25 | LiTFAc | 0.10 | guanidine | 0.10 |
| | | | | nitrate | |
| LiTFSI | 0.25 | LiTFAc | 0.25 | guanidine | 0.10 |
| | | | | nitrate | |
| LiTFSI | 0.25 | LiTFAc | 0.33 | guanidine | 0.10 |
| | | | | nitrate | |
| LiTFSI | 0.25 | LiTFAc | 0.50 | guanidine | 0.10 |
| | | | | nitrate | |
| LiTFSI | 0.25 | LiTFAc | 0.66 | guanidine | 0.10 |
| | | | | nitrate | |
| LiTFSI | 0.25 | LiTFAc | 0.75 | guanidine | 0.10 |
| | | | | nitrate | |
| LiTFSI | 0.25 | LiTFAc | 1.00 | guanidine | 0.10 |
| | | | | nitrate | |
| LiTFSI | 0.25 | LiTFAc | 0.10 | guanidine | 0.15 |
| | | | | nitrate | |
| LiTFSI | 0.25 | LiTFAc | 0.25 | guanidine | 0.15 |
| | | | | nitrate | |
| LiTFSI | 0.25 | LiTFAc | 0.33 | guanidine | 0.15 |
| | | | | nitrate | |
| LiTFSI | 0.25 | LiTFAc | 0.50 | guanidine | 0.15 |
| | | | | nitrate | |
| LiTFSI | 0.25 | LiTFAc | 0.66 | guanidine | 0.15 |
| | | | | nitrate | |
| LiTFSI | 0.25 | LiTFAc | 0.75 | guanidine | 0.15 |
| | | | | nitrate | |
| LiTFSI | 0.25 | LiTFAc | 1.00 | guanidine | 0.15 |
| | | | | nitrate | |
| LiTFSI | 0.40 | LiTFAc | 0.10 | guanidine | 0.10 |
| | | | | nitrate | |
| LiTFSI | 0.40 | LiTFAc | 0.25 | guanidine | 0.10 |
| | | | | nitrate | |
| LiTFSI | 0.40 | LiTFAc | 0.33 | guanidine | 0.10 |
| | | | | nitrate | |
| LiTFSI | 0.40 | LiTFAc | 0.50 | guanidine | 0.10 |
| | | | | nitrate | |
| LiTFSI | 0.40 | LiTFAc | 0.66 | guanidine | 0.10 |
| | | | | nitrate | |
| LiTFSI | 0.40 | LiTFAc | 0.75 | guanidine | 0.10 |
| | | | | nitrate | |
| LiTFSI | 0.40 | LiTFAc | 1.00 | guanidine | 0.10 |
| | | | | nitrate | |
| LiTFSI | 0.40 | LiTFAc | 0.10 | guanidine | 0.15 |
| | | | | nitrate | |
| LiTFSI | 0.40 | LiTFAc | 0.25 | guanidine | 0.15 |
| | | | | nitrate | |
| LiTFSI | 0.40 | LiTFAc | 0.33 | guanidine | 0.15 |
| | | | | nitrate | |
| LiTFSI | 0.40 | LiTFAc | 0.50 | guanidine | 0.15 |
| | | | | nitrate | |
| LiTFSI | 0.40 | LiTFAc | 0.66 | guanidine | 0.15 |
| | | | | nitrate | |
| LiTFSI | 0.40 | LiTFAc | 0.75 | guanidine | 0.15 |
| | | | | nitrate | |
| LiTFSI | 0.40 | LiTFAc | 1.00 | guanidine | 0.15 |
| | | | | nitrate | |
| LiTFSI | 0.50 | LiTFAc | 0.10 | guanidine | 0.10 |
| | | | | nitrate | |
| LiTFSI | 0.50 | LiTFAc | 0.25 | guanidine | 0.10 |
| | | | | nitrate | |
| LiTFSI | 0.50 | LiTFAc | 0.33 | guanidine | 0.10 |
| | | | | nitrate | |
| LiTFSI | 0.50 | LiTFAc | 0.50 | guanidine | 0.10 |
| | | | | nitrate | |
| LiTFSI | 0.50 | LiTFAc | 0.66 | guanidine | 0.10 |
| | | | | nitrate | |
| LiTFSI | 0.50 | LiTFAc | 0.75 | guanidine | 0.10 |
| | | | | nitrate | |
| LiTFSI | 0.50 | LiTFAc | 1.00 | guanidine | 0.10 |
| | | | | nitrate | |
| LiTFSI | 0.50 | LiTFAc | 0.10 | guanidine | 0.15 |
| | | | | nitrate | |
| LiTFSI | 0.50 | LiTFAc | 0.25 | guanidine | 0.15 |
| | | | | nitrate | |
| LiTFSI | 0.50 | LiTFAc | 0.33 | guanidine | 0.15 |
| | | | | nitrate | |
| LiTFSI | 0.50 | LiTFAc | 0.50 | guanidine | 0.15 |
| | | | | nitrate | |
| LiTFSI | 0.50 | LiTFAc | 0.66 | guanidine | 0.15 |
| | | | | nitrate | |
| LiTFSI | 0.50 | LiTFAc | 0.75 | guanidine | 0.15 |
| | | | | nitrate | |
| LiTFSI | 0.50 | LiTFAc | 1.00 | guanidine | 0.15 |
| | | | | nitrate | |
| LiTFSI | 0.66 | LiTFAc | 0.10 | guanidine | 0.10 |
| | | | | nitrate | |
| LiTFSI | 0.66 | LiTFAc | 0.25 | guanidine | 0.10 |
| | | | | nitrate | |
| LiTFSI | 0.66 | LiTFAc | 0.33 | guanidine | 0.10 |
| | | | | nitrate | |
| LiTFSI | 0.66 | LiTFAc | 0.50 | guanidine | 0.10 |
| | | | | nitrate | |
| LiTFSI | 0.66 | LiTFAc | 0.66 | guanidine | 0.10 |
| | | | | nitrate | |
| LiTFSI | 0.66 | LiTFAc | 0.75 | guanidine | 0.10 |
| | | | | nitrate | |
| LiTFSI | 0.66 | LiTFAc | 1.00 | guanidine | 0.10 |
| | | | | nitrate | |
| LiTFSI | 0.66 | LiTFAc | 0.10 | guanidine | 0.15 |
| | | | | nitrate | |
| LiTFSI | 0.66 | LiTFAc | 0.25 | guanidine | 0.15 |
| | | | | nitrate | |
| LiTFSI | 0.66 | LiTFAc | 0.33 | guanidine | 0.15 |
| | | | | nitrate | |
| LiTFSI | 0.66 | LiTFAc | 0.50 | guanidine | 0.15 |
| | | | | nitrate | |
| LiTFSI | 0.66 | LiTFAc | 0.66 | guanidine | 0.15 |
| | | | | nitrate | |
| LiTFSI | 0.66 | LiTFAc | 0.75 | guanidine | 0.15 |
| | | | | nitrate | |
| LiTFSI | 0.66 | LiTFAc | 1.00 | guanidine | 0.15 |
| | | | | nitrate | |
| LiTFSI | 0.75 | LiTFAc | 0.10 | guanidine | 0.10 |
| | | | | nitrate | |
| LiTFSI | 0.75 | LiTFAc | 0.25 | guanidine | 0.10 |
| | | | | nitrate | |
| LiTFSI | 0.75 | LiTFAc | 0.33 | guanidine | 0.10 |
| | | | | nitrate | |
| LiTFSI | 0.75 | LiTFAc | 0.50 | guanidine | 0.10 |
| | | | | nitrate | |
| LiTFSI | 0.75 | LiTFAc | 0.66 | guanidine | 0.10 |
| | | | | nitrate | |
| LiTFSI | 0.75 | LiTFAc | 0.75 | guanidine | 0.10 |
| | | | | nitrate | |
| LiTFSI | 0.75 | LiTFAc | 1.00 | guanidine | 0.10 |
| | | | | nitrate | |
| LiTFSI | 0.75 | LiTFAc | 0.10 | guanidine | 0.15 |
| | | | | nitrate | |
| LiTFSI | 0.75 | LiTFAc | 0.25 | guanidine | 0.15 |
| | | | | nitrate | |
| LiTFSI | 0.75 | LiTFAc | 0.33 | guanidine | 0.15 |
| | | | | nitrate | |
| LiTFSI | 0.75 | LiTFAc | 0.50 | guanidine | 0.15 |
| | | | | nitrate | |
| LiTFSI | 0.75 | LiTFAc | 0.66 | guanidine | 0.15 |
| | | | | nitrate | |
| LiTFSI | 0.75 | LiTFAc | 0.75 | guanidine | 0.15 |
| | | | | nitrate | |
| LiTFSI | 0.75 | LiTFAc | 1.00 | guanidine | 0.15 |
| | | | | nitrate | |
| LiTFSI | 1.00 | LiTFAc | 0.10 | guanidine | 0.10 |
| | | | | nitrate | |
| LiTFSI | 1.00 | LiTFAc | 0.25 | guanidine | 0.10 |
| | | | | nitrate | |
| LiTFSI | 1.00 | LiTFAc | 0.33 | guanidine | 0.10 |
| | | | | nitrate | |
| LiTFSI | 1.00 | LiTFAc | 0.50 | guanidine | 0.10 |
| | | | | nitrate | |
| LiTFSI | 1.00 | LiTFAc | 0.66 | guanidine | 0.10 |
| | | | | nitrate | |
| LiTFSI | 1.00 | LiTFAc | 0.75 | guanidine | 0.10 |
| | | | | nitrate | |
| LiTFSI | 1.00 | LiTFAc | 1.00 | guanidine | 0.10 |
| | | | | nitrate | |
| LiTFSI | 1.00 | LiTFAc | 0.10 | guanidine | 0.15 |
| | | | | nitrate | |
| LiTFSI | 1.00 | LiTFAc | 0.25 | guanidine | 0.15 |
| | | | | nitrate | |
| LiTFSI | 1.00 | LiTFAc | 0.33 | guanidine | 0.15 |
| | | | | nitrate | |
| LiTFSI | 1.00 | LiTFAc | 0.50 | guanidine | 0.15 |
| | | | | nitrate | |
| LiTFSI | 1.00 | LiTFAc | 0.66 | guanidine | 0.15 |
| | | | | nitrate | |
| LiTFSI | 1.00 | LiTFAc | 0.75 | guanidine | 0.15 |
| | | | | nitrate | |
| LiTFSI | 1.00 | LiTFAc | 1.00 | guanidine | 0.15 |
| | | | | nitrate | |
| lithium | 0.10 | none | 0.00 | cyanamide | 0.10 |
| bis(fluoro- | | | | | |
| sulfonyl)imide | | | | | |
| (LiFSI) | | | | | |
| LiFSI | 0.25 | none | 0.00 | cyanamide | 0.10 |
| LiFSI | 0.40 | none | 0.00 | cyanamide | 0.10 |
| LiFSI | 0.50 | none | 0.00 | cyanamide | 0.10 |
| LiFSI | 0.66 | none | 0.00 | cyanamide | 0.10 |
| LiFSI | 0.75 | none | 0.00 | cyanamide | 0.10 |
| LiFSI | 1.00 | none | 0.00 | cyanamide | 0.10 |
| LiFSI | 0.10 | none | 0.00 | cyanamide | 0.15 |
| LiFSI | 0.25 | none | 0.00 | cyanamide | 0.15 |
| LiFSI | 0.40 | none | 0.00 | cyanamide | 0.15 |
| LiFSI | 0.50 | none | 0.00 | cyanamide | 0.15 |
| LiFSI | 0.66 | none | 0.00 | cyanamide | 0.15 |
| LiFSI | 0.75 | none | 0.00 | cyanamide | 0.15 |
| LiFSI | 1.00 | none | 0.00 | cyanamide | 0.15 |
| LiFSI | 0.10 | lithium nitrate | 0.10 | cyanamide | 0.10 |
| | | (LiNO₃) | | | |
| LiFSI | 0.10 | LiNO₃ | 0.25 | cyanamide | 0.10 |
| LiFSI | 0.10 | LiNO₃ | 0.33 | cyanamide | 0.10 |
| LiFSI | 0.10 | LiNO₃ | 0.50 | cyanamide | 0.10 |
| LiFSI | 0.10 | LiNO₃ | 0.66 | cyanamide | 0.10 |
| LiFSI | 0.10 | LiNO₃ | 0.75 | cyanamide | 0.10 |
| LiFSI | 0.10 | LiNO₃ | 1.00 | cyanamide | 0.10 |
| LiFSI | 0.10 | LiNO₃ | 0.10 | cyanamide | 0.15 |
| LiFSI | 0.10 | LiNO₃ | 0.25 | cyanamide | 0.15 |
| LiFSI | 0.10 | LiNO₃ | 0.33 | cyanamide | 0.15 |
| LiFSI | 0.10 | LiNO₃ | 0.50 | cyanamide | 0.15 |
| LiFSI | 0.10 | LiNO₃ | 0.66 | cyanamide | 0.15 |
| LiFSI | 0.10 | LiNO₃ | 0.75 | cyanamide | 0.15 |
| LiFSI | 0.10 | LiNO₃ | 1.00 | cyanamide | 0.15 |
| LiFSI | 0.25 | LiNO₃ | 0.10 | cyanamide | 0.10 |
| LiFSI | 0.25 | LiNO₃ | 0.25 | cyanamide | 0.10 |
| LiFSI | 0.25 | LiNO₃ | 0.33 | cyanamide | 0.10 |
| LiFSI | 0.25 | LiNO₃ | 0.50 | cyanamide | 0.10 |
| LiFSI | 0.25 | LiNO₃ | 0.66 | cyanamide | 0.10 |
| LiFSI | 0.25 | LiNO₃ | 0.75 | cyanamide | 0.10 |
| LiFSI | 0.25 | LiNO₃ | 1.00 | cyanamide | 0.10 |
| LiFSI | 0.25 | LiNO₃ | 0.10 | cyanamide | 0.15 |
| LiFSI | 0.25 | LiNO₃ | 0.25 | cyanamide | 0.15 |
| LiFSI | 0.25 | LiNO₃ | 0.33 | cyanamide | 0.15 |
| LiFSI | 0.25 | LiNO₃ | 0.50 | cyanamide | 0.15 |
| LiFSI | 0.25 | LiNO₃ | 0.66 | cyanamide | 0.15 |
| LiFSI | 0.25 | LiNO₃ | 0.75 | cyanamide | 0.15 |
| LiFSI | 0.25 | LiNO₃ | 1.00 | cyanamide | 0.15 |
| LiFSI | 0.40 | LiNO₃ | 0.10 | cyanamide | 0.10 |
| LiFSI | 0.40 | LiNO₃ | 0.25 | cyanamide | 0.10 |
| LiFSI | 0.40 | LiNO₃ | 0.33 | cyanamide | 0.10 |
| LiFSI | 0.40 | LiNO₃ | 0.50 | cyanamide | 0.10 |
| LiFSI | 0.40 | LiNO₃ | 0.66 | cyanamide | 0.10 |
| LiFSI | 0.40 | LiNO₃ | 0.75 | cyanamide | 0.10 |
| LiFSI | 0.40 | LiNO₃ | 1.00 | cyanamide | 0.10 |
| LiFSI | 0.40 | LiNO₃ | 0.10 | cyanamide | 0.15 |
| LiFSI | 0.40 | LiNO₃ | 0.25 | cyanamide | 0.15 |
| LiFSI | 0.40 | LiNO₃ | 0.33 | cyanamide | 0.15 |
| LiFSI | 0.40 | LiNO₃ | 0.50 | cyanamide | 0.15 |
| LiFSI | 0.40 | LiNO₃ | 0.66 | cyanamide | 0.15 |
| LiFSI | 0.40 | LiNO₃ | 0.75 | cyanamide | 0.15 |
| LiFSI | 0.40 | LiNO₃ | 1.00 | cyanamide | 0.15 |
| LiFSI | 0.50 | LiNO₃ | 0.10 | cyanamide | 0.10 |
| LiFSI | 0.50 | LiNO₃ | 0.25 | cyanamide | 0.10 |
| LiFSI | 0.50 | LiNO₃ | 0.33 | cyanamide | 0.10 |
| LiFSI | 0.50 | LiNO₃ | 0.50 | cyanamide | 0.10 |
| LiFSI | 0.50 | LiNO₃ | 0.66 | cyanamide | 0.10 |
| LiFSI | 0.50 | LiNO₃ | 0.75 | cyanamide | 0.10 |
| LiFSI | 0.50 | LiNO₃ | 1.00 | cyanamide | 0.10 |
| LiFSI | 0.50 | LiNO₃ | 0.10 | cyanamide | 0.15 |
| LiFSI | 0.50 | LiNO₃ | 0.25 | cyanamide | 0.15 |
| LiFSI | 0.50 | LiNO₃ | 0.33 | cyanamide | 0.15 |
| LiFSI | 0.50 | LiNO₃ | 0.50 | cyanamide | 0.15 |
| LiFSI | 0.50 | LiNO₃ | 0.66 | cyanamide | 0.15 |
| LiFSI | 0.50 | LiNO₃ | 0.75 | cyanamide | 0.15 |
| LiFSI | 0.50 | LiNO₃ | 1.00 | cyanamide | 0.15 |
| LiFSI | 0.66 | LiNO₃ | 0.10 | cyanamide | 0.10 |
| LiFSI | 0.66 | LiNO₃ | 0.25 | cyanamide | 0.10 |
| LiFSI | 0.66 | LiNO₃ | 0.33 | cyanamide | 0.10 |
| LiFSI | 0.66 | LiNO₃ | 0.50 | cyanamide | 0.10 |
| LiFSI | 0.66 | LiNO₃ | 0.66 | cyanamide | 0.10 |
| LiFSI | 0.66 | LiNO₃ | 0.75 | cyanamide | 0.10 |
| LiFSI | 0.66 | LiNO₃ | 1.00 | cyanamide | 0.10 |
| LiFSI | 0.66 | LiNO₃ | 0.10 | cyanamide | 0.15 |
| LiFSI | 0.66 | LiNO₃ | 0.25 | cyanamide | 0.15 |
| LiFSI | 0.66 | LiNO₃ | 0.33 | cyanamide | 0.15 |
| LiFSI | 0.66 | LiNO₃ | 0.50 | cyanamide | 0.15 |
| LiFSI | 0.66 | LiNO₃ | 0.66 | cyanamide | 0.15 |
| LiFSI | 0.66 | LiNO₃ | 0.75 | cyanamide | 0.15 |
| LiFSI | 0.66 | LiNO₃ | 1.00 | cyanamide | 0.15 |
| LiFSI | 0.75 | LiNO₃ | 0.10 | cyanamide | 0.10 |
| LiFSI | 0.75 | LiNO₃ | 0.25 | cyanamide | 0.10 |
| LiFSI | 0.75 | LiNO₃ | 0.33 | cyanamide | 0.10 |
| LiFSI | 0.75 | LiNO₃ | 0.50 | cyanamide | 0.10 |
| LiFSI | 0.75 | LiNO₃ | 0.66 | cyanamide | 0.10 |
| LiFSI | 0.75 | LiNO₃ | 0.75 | cyanamide | 0.10 |
| LiFSI | 0.75 | LiNO₃ | 1.00 | cyanamide | 0.10 |
| LiFSI | 0.75 | LiNO₃ | 0.10 | cyanamide | 0.15 |
| LiFSI | 0.75 | LiNO₃ | 0.25 | cyanamide | 0.15 |
| LiFSI | 0.75 | LiNO₃ | 0.33 | cyanamide | 0.15 |
| LiFSI | 0.75 | LiNO₃ | 0.50 | cyanamide | 0.15 |
| LiFSI | 0.75 | LiNO₃ | 0.66 | cyanamide | 0.15 |
| LiFSI | 0.75 | LiNO₃ | 0.75 | cyanamide | 0.15 |
| LiFSI | 0.75 | LiNO₃ | 1.00 | cyanamide | 0.15 |
| LiFSI | 1.00 | LiNO₃ | 0.10 | cyanamide | 0.10 |
| LiFSI | 1.00 | LiNO₃ | 0.25 | cyanamide | 0.10 |
| LiFSI | 1.00 | LiNO₃ | 0.33 | cyanamide | 0.10 |
| LiFSI | 1.00 | LiNO₃ | 0.50 | cyanamide | 0.10 |
| LiFSI | 1.00 | LiNO₃ | 0.66 | cyanamide | 0.10 |
| LiFSI | 1.00 | LiNO₃ | 0.75 | cyanamide | 0.10 |
| LiFSI | 1.00 | LiNO₃ | 1.00 | cyanamide | 0.10 |
| LiFSI | 1.00 | LiNO₃ | 0.10 | cyanamide | 0.15 |
| LiFSI | 1.00 | LiNO₃ | 0.25 | cyanamide | 0.15 |
| LiFSI | 1.00 | LiNO₃ | 0.33 | cyanamide | 0.15 |
| LiFSI | 1.00 | LiNO₃ | 0.50 | cyanamide | 0.15 |
| LiFSI | 1.00 | LiNO₃ | 0.66 | cyanamide | 0.15 |
| LiFSI | 1.00 | LiNO₃ | 0.75 | cyanamide | 0.15 |
| LiFSI | 1.00 | LiNO₃ | 1.00 | cyanamide | 0.15 |
| LiFSI | 0.10 | LiClO₄ | 0.10 | cyanamide | 0.10 |
| LiFSI | 0.10 | LiClO₄ | 0.25 | cyanamide | 0.10 |
| LiFSI | 0.10 | LiClO₄ | 0.33 | cyanamide | 0.10 |
| LiFSI | 0.10 | LiClO₄ | 0.50 | cyanamide | 0.10 |
| LiFSI | 0.10 | LiClO₄ | 0.66 | cyanamide | 0.10 |
| LiFSI | 0.10 | LiClO₄ | 0.75 | cyanamide | 0.10 |
| LiFSI | 0.10 | LiClO₄ | 1.00 | cyanamide | 0.10 |
| LiFSI | 0.10 | LiClO₄ | 0.10 | cyanamide | 0.15 |
| LiFSI | 0.10 | LiClO₄ | 0.25 | cyanamide | 0.15 |
| LiFSI | 0.10 | LiClO₄ | 0.33 | cyanamide | 0.15 |
| LiFSI | 0.10 | LiClO₄ | 0.50 | cyanamide | 0.15 |
| LiFSI | 0.10 | LiClO₄ | 0.66 | cyanamide | 0.15 |
| LiFSI | 0.10 | LiClO₄ | 0.75 | cyanamide | 0.15 |
| LiFSI | 0.10 | LiClO₄ | 1.00 | cyanamide | 0.15 |
| LiFSI | 0.25 | LiClO₄ | 0.10 | cyanamide | 0.10 |
| LiFSI | 0.25 | LiClO₄ | 0.25 | cyanamide | 0.10 |
| LiFSI | 0.25 | LiClO₄ | 0.33 | cyanamide | 0.10 |
| LiFSI | 0.25 | LiClO₄ | 0.50 | cyanamide | 0.10 |
| LiFSI | 0.25 | LiClO₄ | 0.66 | cyanamide | 0.10 |
| LiFSI | 0.25 | LiClO₄ | 0.75 | cyanamide | 0.10 |
| LiFSI | 0.25 | LiClO₄ | 1.00 | cyanamide | 0.10 |
| LiFSI | 0.25 | LiClO₄ | 0.10 | cyanamide | 0.15 |
| LiFSI | 0.25 | LiClO₄ | 0.25 | cyanamide | 0.15 |
| LiFSI | 0.25 | LiClO₄ | 0.33 | cyanamide | 0.15 |
| LiFSI | 0.25 | LiClO₄ | 0.50 | cyanamide | 0.15 |
| LiFSI | 0.25 | LiClO₄ | 0.66 | cyanamide | 0.15 |
| LiFSI | 0.25 | LiClO₄ | 0.75 | cyanamide | 0.15 |
| LiFSI | 0.25 | LiClO₄ | 1.00 | cyanamide | 0.15 |
| LiFSI | 0.40 | LiClO₄ | 0.10 | cyanamide | 0.10 |
| LiFSI | 0.40 | LiClO₄ | 0.25 | cyanamide | 0.10 |
| LiFSI | 0.40 | LiClO₄ | 0.33 | cyanamide | 0.10 |
| LiFSI | 0.40 | LiClO₄ | 0.50 | cyanamide | 0.10 |
| LiFSI | 0.40 | LiClO₄ | 0.66 | cyanamide | 0.10 |
| LiFSI | 0.40 | LiClO₄ | 0.75 | cyanamide | 0.10 |
| LiFSI | 0.40 | LiClO₄ | 1.00 | cyanamide | 0.10 |
| LiFSI | 0.40 | LiClO₄ | 0.10 | cyanamide | 0.15 |
| LiFSI | 0.40 | LiClO₄ | 0.25 | cyanamide | 0.15 |
| LiFSI | 0.40 | LiClO₄ | 0.33 | cyanamide | 0.15 |
| LiFSI | 0.40 | LiClO₄ | 0.50 | cyanamide | 0.15 |
| LiFSI | 0.40 | LiClO₄ | 0.66 | cyanamide | 0.15 |
| LiFSI | 0.40 | LiClO₄ | 0.75 | cyanamide | 0.15 |
| LiFSI | 0.40 | LiClO₄ | 1.00 | cyanamide | 0.15 |
| LiFSI | 0.50 | LiClO₄ | 0.10 | cyanamide | 0.10 |
| LiFSI | 0.50 | LiClO₄ | 0.25 | cyanamide | 0.10 |
| LiFSI | 0.50 | LiClO₄ | 0.33 | cyanamide | 0.10 |
| LiFSI | 0.50 | LiClO₄ | 0.50 | cyanamide | 0.10 |
| LiFSI | 0.50 | LiClO₄ | 0.66 | cyanamide | 0.10 |
| LiFSI | 0.50 | LiClO₄ | 0.75 | cyanamide | 0.10 |
| LiFSI | 0.50 | LiClO₄ | 1.00 | cyanamide | 0.10 |
| LiFSI | 0.50 | LiClO₄ | 0.10 | cyanamide | 0.15 |
| LiFSI | 0.50 | LiClO₄ | 0.25 | cyanamide | 0.15 |
| LiFSI | 0.50 | LiClO₄ | 0.33 | cyanamide | 0.15 |
| LiFSI | 0.50 | LiClO₄ | 0.50 | cyanamide | 0.15 |
| LiFSI | 0.50 | LiClO₄ | 0.66 | cyanamide | 0.15 |
| LiFSI | 0.50 | LiClO₄ | 0.75 | cyanamide | 0.15 |
| LiFSI | 0.50 | LiClO₄ | 1.00 | cyanamide | 0.15 |
| LiFSI | 0.66 | LiClO₄ | 0.10 | cyanamide | 0.10 |
| LiFSI | 0.66 | LiClO₄ | 0.25 | cyanamide | 0.10 |
| LiFSI | 0.66 | LiClO₄ | 0.33 | cyanamide | 0.10 |
| LiFSI | 0.66 | LiClO₄ | 0.50 | cyanamide | 0.10 |
| LiFSI | 0.66 | LiClO₄ | 0.66 | cyanamide | 0.10 |
| LiFSI | 0.66 | LiClO₄ | 0.75 | cyanamide | 0.10 |
| LiFSI | 0.66 | LiClO₄ | 1.00 | cyanamide | 0.10 |
| LiFSI | 0.66 | LiClO₄ | 0.10 | cyanamide | 0.15 |
| LiFSI | 0.66 | LiClO₄ | 0.25 | cyanamide | 0.15 |
| LiFSI | 0.66 | LiClO₄ | 0.33 | cyanamide | 0.15 |
| LiFSI | 0.66 | LiClO₄ | 0.50 | cyanamide | 0.15 |
| LiFSI | 0.66 | LiClO₄ | 0.66 | cyanamide | 0.15 |
| LiFSI | 0.66 | LiClO₄ | 0.75 | cyanamide | 0.15 |
| LiFSI | 0.66 | LiClO₄ | 1.00 | cyanamide | 0.15 |
| LiFSI | 0.75 | LiClO₄ | 0.10 | cyanamide | 0.10 |
| LiFSI | 0.75 | LiClO₄ | 0.25 | cyanamide | 0.10 |
| LiFSI | 0.75 | LiClO₄ | 0.33 | cyanamide | 0.10 |
| LiFSI | 0.75 | LiClO₄ | 0.50 | cyanamide | 0.10 |
| LiFSI | 0.75 | LiClO₄ | 0.66 | cyanamide | 0.10 |
| LiFSI | 0.75 | LiClO₄ | 0.75 | cyanamide | 0.10 |
| LiFSI | 0.75 | LiClO₄ | 1.00 | cyanamide | 0.10 |
| LiFSI | 0.75 | LiClO₄ | 0.10 | cyanamide | 0.15 |
| LiFSI | 0.75 | LiClO₄ | 0.25 | cyanamide | 0.15 |
| LiFSI | 0.75 | LiClO₄ | 0.33 | cyanamide | 0.15 |
| LiFSI | 0.75 | LiClO₄ | 0.50 | cyanamide | 0.15 |
| LiFSI | 0.75 | LiClO₄ | 0.66 | cyanamide | 0.15 |
| LiFSI | 0.75 | LiClO₄ | 0.75 | cyanamide | 0.15 |
| LiFSI | 0.75 | LiClO₄ | 1.00 | cyanamide | 0.15 |
| LiFSI | 1.00 | LiClO₄ | 0.10 | cyanamide | 0.10 |
| LiFSI | 1.00 | LiClO₄ | 0.25 | cyanamide | 0.10 |
| LiFSI | 1.00 | LiClO₄ | 0.33 | cyanamide | 0.10 |
| LiFSI | 1.00 | LiClO₄ | 0.50 | cyanamide | 0.10 |
| LiFSI | 1.00 | LiClO₄ | 0.66 | cyanamide | 0.10 |
| LiFSI | 1.00 | LiClO₄ | 0.75 | cyanamide | 0.10 |
| LiFSI | 1.00 | LiClO₄ | 1.00 | cyanamide | 0.10 |
| LiFSI | 1.00 | LiClO₄ | 0.10 | cyanamide | 0.15 |
| LiFSI | 1.00 | LiClO₄ | 0.25 | cyanamide | 0.15 |
| LiFSI | 1.00 | LiClO₄ | 0.33 | cyanamide | 0.15 |
| LiFSI | 1.00 | LiClO₄ | 0.50 | cyanamide | 0.15 |
| LiFSI | 1.00 | LiClO₄ | 0.66 | cyanamide | 0.15 |
| LiFSI | 1.00 | LiClO₄ | 0.75 | cyanamide | 0.15 |
| LiFSI | 1.00 | LiClO₄ | 1.00 | cyanamide | 0.15 |
| LiFSI | 0.10 | Lithium | 0.10 | lithium | 0.10 |
| | | trifluoroacetate | | dicyanamide | |
| | | (LiTFAc) | | | |
| LiFSI | 0.10 | LiTFAc | 0.25 | lithium | 0.10 |
| | | | | dicyanamide | |
| LiFSI | 0.10 | LiTFAc | 0.33 | lithium | 0.10 |
| | | | | dicyanamide | |
| LiFSI | 0.10 | LiTFAc | 0.50 | lithium | 0.10 |
| | | | | dicyanamide | |
| LiFSI | 0.10 | LiTFAc | 0.66 | lithium | 0.10 |
| | | | | dicyanamide | |
| LiFSI | 0.10 | LiTFAc | 0.75 | lithium | 0.10 |
| | | | | dicyanamide | |
| LiFSI | 0.10 | LiTFAc | 1.00 | lithium | 0.10 |
| | | | | dicyanamide | |
| LiFSI | 0.10 | LiTFAc | 0.10 | lithium | 0.15 |
| | | | | dicyanamide | |
| LiFSI | 0.10 | LiTFAc | 0.25 | lithium | 0.15 |
| | | | | dicyanamide | |
| LiFSI | 0.10 | LiTFAc | 0.33 | lithium | 0.15 |
| | | | | dicyanamide | |
| LiFSI | 0.10 | LiTFAc | 0.50 | lithium | 0.15 |
| | | | | dicyanamide | |
| LiFSI | 0.10 | LiTFAc | 0.66 | lithium | 0.15 |
| | | | | dicyanamide | |
| LiFSI | 0.10 | LiTFAc | 0.75 | lithium | 0.15 |
| | | | | dicyanamide | |
| LiFSI | 0.10 | LiTFAc | 1.00 | lithium | 0.15 |
| | | | | dicyanamide | |
| LiFSI | 0.25 | LiTFAc | 0.10 | lithium | 0.10 |
| | | | | dicyanamide | |
| LiFSI | 0.25 | LiTFAc | 0.25 | lithium | 0.10 |
| | | | | dicyanamide | |
| LiFSI | 0.25 | LiTFAc | 0.33 | lithium | 0.10 |
| | | | | dicyanamide | |
| LiFSI | 0.25 | LiTFAc | 0.50 | lithium | 0.10 |
| | | | | dicyanamide | |
| LiFSI | 0.25 | LiTFAc | 0.66 | lithium | 0.10 |
| | | | | dicyanamide | |
| LiFSI | 0.25 | LiTFAc | 0.75 | lithium | 0.10 |
| | | | | dicyanamide | |
| LiFSI | 0.25 | LiTFAc | 1.00 | lithium | 0.10 |
| | | | | dicyanamide | |
| LiFSI | 0.25 | LiTFAc | 0.10 | lithium | 0.15 |
| | | | | dicyanamide | |
| LiFSI | 0.25 | LiTFAc | 0.25 | lithium | 0.15 |
| | | | | dicyanamide | |
| LiFSI | 0.25 | LiTFAc | 0.33 | lithium | 0.15 |
| | | | | dicyanamide | |
| LiFSI | 0.25 | LiTFAc | 0.50 | lithium | 0.15 |
| | | | | dicyanamide | |
| LiFSI | 0.25 | LiTFAc | 0.66 | lithium | 0.15 |
| | | | | dicyanamide | |
| LiFSI | 0.25 | LiTFAc | 0.75 | lithium | 0.15 |
| | | | | dicyanamide | |
| LiFSI | 0.25 | LiTFAc | 1.00 | lithium | 0.15 |
| | | | | dicyanamide | |
| LiFSI | 0.40 | LiTFAc | 0.10 | lithium | 0.10 |
| | | | | dicyanamide | |
| LiFSI | 0.40 | LiTFAc | 0.25 | lithium | 0.10 |
| | | | | dicyanamide | |
| LiFSI | 0.40 | LiTFAc | 0.33 | lithium | 0.10 |
| | | | | dicyanamide | |
| LiFSI | 0.40 | LiTFAc | 0.50 | lithium | 0.10 |
| | | | | dicyanamide | |
| LiFSI | 0.40 | LiTFAc | 0.66 | lithium | 0.10 |
| | | | | dicyanamide | |
| LiFSI | 0.40 | LiTFAc | 0.75 | lithium | 0.10 |
| | | | | dicyanamide | |
| LiFSI | 0.40 | LiTFAc | 1.00 | lithium | 0.10 |
| | | | | dicyanamide | |
| LiFSI | 0.40 | LiTFAc | 0.10 | lithium | 0.15 |
| | | | | dicyanamide | |
| LiFSI | 0.40 | LiTFAc | 0.25 | lithium | 0.15 |
| | | | | dicyanamide | |
| LiFSI | 0.40 | LiTFAc | 0.33 | lithium | 0.15 |
| | | | | dicyanamide | |
| LiFSI | 0.40 | LiTFAc | 0.50 | lithium | 0.15 |
| | | | | dicyanamide | |
| LiFSI | 0.40 | LiTFAc | 0.66 | lithium | 0.15 |
| | | | | dicyanamide | |
| LiFSI | 0.40 | LiTFAc | 0.75 | lithium | 0.15 |
| | | | | dicyanamide | |
| LiFSI | 0.40 | LiTFAc | 1.00 | lithium | 0.15 |
| | | | | dicyanamide | |
| LiFSI | 0.50 | LiTFAc | 0.10 | lithium | 0.10 |
| | | | | dicyanamide | |
| LiFSI | 0.50 | LiTFAc | 0.25 | lithium | 0.10 |
| | | | | dicyanamide | |
| LiFSI | 0.50 | LiTFAc | 0.33 | lithium | 0.10 |
| | | | | dicyanamide | |
| LiFSI | 0.50 | LiTFAc | 0.50 | lithium | 0.10 |
| | | | | dicyanamide | |
| LiFSI | 0.50 | LiTFAc | 0.66 | lithium | 0.10 |
| | | | | dicyanamide | |
| LiFSI | 0.50 | LiTFAc | 0.75 | lithium | 0.10 |
| | | | | dicyanamide | |
| LiFSI | 0.50 | LiTFAc | 1.00 | lithium | 0.10 |
| | | | | dicyanamide | |
| LiFSI | 0.50 | LiTFAc | 0.10 | lithium | 0.15 |
| | | | | dicyanamide | |
| LiFSI | 0.50 | LiTFAc | 0.25 | lithium | 0.15 |
| | | | | dicyanamide | |
| LiFSI | 0.50 | LiTFAc | 0.33 | lithium | 0.15 |
| | | | | dicyanamide | |
| LiFSI | 0.50 | LiTFAc | 0.50 | lithium | 0.15 |
| | | | | dicyanamide | |
| LiFSI | 0.50 | LiTFAc | 0.66 | lithium | 0.15 |
| | | | | dicyanamide | |
| LiFSI | 0.50 | LiTFAc | 0.75 | lithium | 0.15 |
| | | | | dicyanamide | |
| LiFSI | 0.50 | LiTFAc | 1.00 | lithium | 0.15 |
| | | | | dicyanamide | |
| LiFSI | 0.66 | LiTFAc | 0.10 | lithium | 0.10 |
| | | | | dicyanamide | |
| LiFSI | 0.66 | LiTFAc | 0.25 | lithium | 0.10 |
| | | | | dicyanamide | |
| LiFSI | 0.66 | LiTFAc | 0.33 | lithium | 0.10 |
| | | | | dicyanamide | |
| LiFSI | 0.66 | LiTFAc | 0.50 | lithium | 0.10 |
| | | | | dicyanamide | |
| LiFSI | 0.66 | LiTFAc | 0.66 | lithium | 0.10 |
| | | | | dicyanamide | |
| LiFSI | 0.66 | LiTFAc | 0.75 | lithium | 0.10 |
| | | | | dicyanamide | |
| LiFSI | 0.66 | LiTFAc | 1.00 | lithium | 0.10 |
| | | | | dicyanamide | |
| LiFSI | 0.66 | LiTFAc | 0.10 | lithium | 0.15 |
| | | | | dicyanamide | |
| LiFSI | 0.66 | LiTFAc | 0.25 | lithium | 0.15 |
| | | | | dicyanamide | |
| LiFSI | 0.66 | LiTFAc | 0.33 | lithium | 0.15 |
| | | | | dicyanamide | |
| LiFSI | 0.66 | LiTFAc | 0.50 | lithium | 0.15 |
| | | | | dicyanamide | |
| LiFSI | 0.66 | LiTFAc | 0.66 | lithium | 0.15 |
| | | | | dicyanamide | |
| LiFSI | 0.66 | LiTFAc | 0.75 | lithium | 0.15 |
| | | | | dicyanamide | |
| LiFSI | 0.66 | LiTFAc | 1.00 | lithium | 0.15 |
| | | | | dicyanamide | |
| LiFSI | 0.75 | LiTFAc | 0.10 | lithium | 0.10 |
| | | | | dicyanamide | |
| LiFSI | 0.75 | LiTFAc | 0.25 | lithium | 0.10 |
| | | | | dicyanamide | |
| LiFSI | 0.75 | LiTFAc | 0.33 | lithium | 0.10 |
| | | | | dicyanamide | |
| LiFSI | 0.75 | LiTFAc | 0.50 | lithium | 0.10 |
| | | | | dicyanamide | |
| LiFSI | 0.75 | LiTFAc | 0.66 | lithium | 0.10 |
| | | | | dicyanamide | |
| LiFSI | 0.75 | LiTFAc | 0.75 | lithium | 0.10 |
| | | | | dicyanamide | |
| LiFSI | 0.75 | LiTFAc | 1.00 | lithium | 0.10 |
| | | | | dicyanamide | |
| LiFSI | 0.75 | LiTFAc | 0.10 | lithium | 0.15 |
| | | | | dicyanamide | |
| LiFSI | 0.75 | LiTFAc | 0.25 | lithium | 0.15 |
| | | | | dicyanamide | |
| LiFSI | 0.75 | LiTFAc | 0.33 | lithium | 0.15 |
| | | | | dicyanamide | |
| LiFSI | 0.75 | LiTFAc | 0.50 | lithium | 0.15 |
| | | | | dicyanamide | |
| LiFSI | 0.75 | LiTFAc | 0.66 | lithium | 0.15 |
| | | | | dicyanamide | |
| LiFSI | 0.75 | LiTFAc | 0.75 | lithium | 0.15 |
| | | | | dicyanamide | |
| LiFSI | 0.75 | LiTFAc | 1.00 | lithium | 0.15 |
| | | | | dicyanamide | |
| LiFSI | 1.00 | LiTFAc | 0.10 | lithium | 0.10 |
| | | | | dicyanamide | |
| LiFSI | 1.00 | LiTFAc | 0.25 | lithium | 0.10 |
| | | | | dicyanamide | |
| LiFSI | 1.00 | LiTFAc | 0.33 | lithium | 0.10 |
| | | | | dicyanamide | |
| LiFSI | 1.00 | LiTFAc | 0.50 | lithium | 0.10 |
| | | | | dicyanamide | |
| LiFSI | 1.00 | LiTFAc | 0.66 | lithium | 0.10 |
| | | | | dicyanamide | |
| LiFSI | 1.00 | LiTFAc | 0.75 | lithium | 0.10 |
| | | | | dicyanamide | |
| LiFSI | 1.00 | LiTFAc | 1.00 | lithium | 0.10 |
| | | | | dicyanamide | |
| LiFSI | 1.00 | LiTFAc | 0.10 | lithium | 0.15 |
| | | | | dicyanamide | |
| LiFSI | 1.00 | LiTFAc | 0.25 | lithium | 0.15 |
| | | | | dicyanamide | |
| LiFSI | 1.00 | LiTFAc | 0.33 | lithium | 0.15 |
| | | | | dicyanamide | |
| LiFSI | 1.00 | LiTFAc | 0.50 | lithium | 0.15 |
| | | | | dicyanamide | |
| LiFSI | 1.00 | LiTFAc | 0.66 | lithium | 0.15 |
| | | | | dicyanamide | |
| LiFSI | 1.00 | LiTFAc | 0.75 | lithium | 0.15 |
| | | | | dicyanamide | |
| LiFSI | 1.00 | LiTFAc | 1.00 | lithium | 0.15 |
| | | | | dicyanamide | |
| LiTFAc | 0.10 | none | 0.00 | lithium | 0.10 |
| | | | | dicyanamide | |
| LiTFAc | 0.25 | none | 0.00 | lithium | 0.10 |
| | | | | dicyanamide | |
| LiTFAc | 0.40 | none | 0.00 | lithium | 0.10 |
| | | | | dicyanamide | |
| LiTFAc | 0.50 | none | 0.00 | lithium | 0.10 |
| | | | | dicyanamide | |
| LiTFAc | 0.66 | none | 0.00 | lithium | 0.10 |
| | | | | dicyanamide | |
| LiTFAc | 0.75 | none | 0.00 | lithium | 0.10 |
| | | | | dicyanamide | |
| LiTFAc | 1.00 | none | 0.00 | lithium | 0.10 |
| | | | | dicyanamide | |
| LiTFAc | 0.10 | none | 0.00 | lithium | 0.15 |
| | | | | dicyanamide | |
| LiTFAc | 0.25 | none | 0.00 | lithium | 0.15 |
| | | | | dicyanamide | |
| LiTFAc | 0.40 | none | 0.00 | lithium | 0.15 |
| | | | | dicyanamide | |
| LiTFAc | 0.50 | none | 0.00 | lithium | 0.15 |
| | | | | dicyanamide | |
| LiTFAc | 0.66 | none | 0.00 | lithium | 0.15 |
| | | | | dicyanamide | |
| LiTFAc | 0.75 | none | 0.00 | lithium | 0.15 |
| | | | | dicyanamide | |
| LiTFAc | 1.00 | none | 0.00 | lithium | 0.15 |
| | | | | dicyanamide | |
| LiTFAc | 0.10 | Lithium | 0.10 | lithium | 0.10 |
| | | nitrate | | dicyanamide | |
| | | (LiNO₃) | | | |
| LiTFAc | 0.10 | LiNO₃ | 0.25 | lithium | 0.10 |
| | | | | dicyanamide | |
| LiTFAc | 0.10 | LiNO₃ | 0.33 | lithium | 0.10 |
| | | | | dicyanamide | |
| LiTFAc | 0.10 | LiNO₃ | 0.50 | lithium | 0.10 |
| | | | | dicyanamide | |
| LiTFAc | 0.10 | LiNO₃ | 0.66 | lithium | 0.10 |
| | | | | dicyanamide | |
| LiTFAc | 0.10 | LiNO₃ | 0.75 | lithium | 0.10 |
| | | | | dicyanamide | |
| LiTFAc | 0.10 | LiNO₃ | 1.00 | lithium | 0.10 |
| | | | | dicyanamide | |
| LiTFAc | 0.10 | LiNO₃ | 0.10 | lithium | 0.15 |
| | | | | dicyanamide | |
| LiTFAc | 0.10 | LiNO₃ | 0.25 | lithium | 0.15 |
| | | | | dicyanamide | |
| LiTFAc | 0.10 | LiNO₃ | 0.33 | lithium | 0.15 |
| | | | | dicyanamide | |
| LiTFAc | 0.10 | LiNO₃ | 0.50 | lithium | 0.15 |
| | | | | dicyanamide | |
| LiTFAc | 0.10 | LiNO₃ | 0.66 | lithium | 0.15 |
| | | | | dicyanamide | |
| LiTFAc | 0.10 | LiNO₃ | 0.75 | lithium | 0.15 |
| | | | | dicyanamide | |
| LiTFAc | 0.10 | LiNO₃ | 1.00 | lithium | 0.15 |
| | | | | dicyanamide | |
| LiTFAc | 0.25 | LiNO₃ | 0.10 | lithium | 0.10 |
| | | | | dicyanamide | |
| LiTFAc | 0.25 | LiNO₃ | 0.25 | lithium | 0.10 |
| | | | | dicyanamide | |
| LiTFAc | 0.25 | LiNO₃ | 0.33 | lithium | 0.10 |
| | | | | dicyanamide | |
| LiTFAc | 0.25 | LiNO₃ | 0.50 | lithium | 0.10 |
| | | | | dicyanamide | |
| LiTFAc | 0.25 | LiNO₃ | 0.66 | lithium | 0.10 |
| | | | | dicyanamide | |
| LiTFAc | 0.25 | LiNO₃ | 0.75 | lithium | 0.10 |
| | | | | dicyanamide | |
| LiTFAc | 0.25 | LiNO₃ | 1.00 | lithium | 0.10 |
| | | | | dicyanamide | |
| LiTFAc | 0.25 | LiNO₃ | 0.10 | lithium | 0.15 |
| | | | | dicyanamide | |
| LiTFAc | 0.25 | LiNO₃ | 0.25 | lithium | 0.15 |
| | | | | dicyanamide | |
| LiTFAc | 0.25 | LiNO₃ | 0.33 | lithium | 0.15 |
| | | | | dicyanamide | |
| LiTFAc | 0.25 | LiNO₃ | 0.50 | lithium | 0.15 |
| | | | | dicyanamide | |
| LiTFAc | 0.25 | LiNO₃ | 0.66 | lithium | 0.15 |
| | | | | dicyanamide | |
| LiTFAc | 0.25 | LiNO₃ | 0.75 | lithium | 0.15 |
| | | | | dicyanamide | |
| LiTFAc | 0.25 | LiNO₃ | 1.00 | lithium | 0.15 |
| | | | | dicyanamide | |
| LiTFAc | 0.40 | LiNO₃ | 0.10 | lithium | 0.10 |
| | | | | dicyanamide | |
| LiTFAc | 0.40 | LiNO₃ | 0.25 | lithium | 0.10 |
| | | | | dicyanamide | |
| LiTFAc | 0.40 | LiNO₃ | 0.33 | lithium | 0.10 |
| | | | | dicyanamide | |
| LiTFAc | 0.40 | LiNO₃ | 0.50 | lithium | 0.10 |
| | | | | dicyanamide | |
| LiTFAc | 0.40 | LiNO₃ | 0.66 | lithium | 0.10 |
| | | | | dicyanamide | |
| LiTFAc | 0.40 | LiNO₃ | 0.75 | lithium | 0.10 |
| | | | | dicyanamide | |
| LiTFAc | 0.40 | LiNO₃ | 1.00 | lithium | 0.10 |
| | | | | dicyanamide | |
| LiTFAc | 0.40 | LiNO₃ | 0.10 | lithium | 0.15 |
| | | | | dicyanamide | |
| LiTFAc | 0.40 | LiNO₃ | 0.25 | lithium | 0.15 |
| | | | | dicyanamide | |
| LiTFAc | 0.40 | LiNO₃ | 0.33 | lithium | 0.15 |
| | | | | dicyanamide | |
| LiTFAc | 0.40 | LiNO₃ | 0.50 | lithium | 0.15 |
| | | | | dicyanamide | |
| LiTFAc | 0.40 | LiNO₃ | 0.66 | lithium | 0.15 |
| | | | | dicyanamide | |
| LiTFAc | 0.40 | LiNO₃ | 0.75 | lithium | 0.15 |
| | | | | dicyanamide | |
| LiTFAc | 0.40 | LiNO₃ | 1.00 | lithium | 0.15 |
| | | | | dicyanamide | |
| LiTFAc | 0.50 | LiNO₃ | 0.10 | lithium | 0.10 |
| | | | | dicyanamide | |
| LiTFAc | 0.50 | LiNO₃ | 0.25 | lithium | 0.10 |
| | | | | dicyanamide | |
| LiTFAc | 0.50 | LiNO₃ | 0.33 | lithium | 0.10 |
| | | | | dicyanamide | |
| LiTFAc | 0.50 | LiNO₃ | 0.50 | lithium | 0.10 |
| | | | | dicyanamide | |
| LiTFAc | 0.50 | LiNO₃ | 0.66 | lithium | 0.10 |
| | | | | dicyanamide | |
| LiTFAc | 0.50 | LiNO₃ | 0.75 | lithium | 0.10 |
| | | | | dicyanamide | |
| LiTFAc | 0.50 | LiNO₃ | 1.00 | lithium | 0.10 |
| | | | | dicyanamide | |
| LiTFAc | 0.50 | LiNO₃ | 0.10 | lithium | 0.15 |
| | | | | dicyanamide | |
| LiTFAc | 0.50 | LiNO₃ | 0.25 | lithium | 0.15 |
| | | | | dicyanamide | |
| LiTFAc | 0.50 | LiNO₃ | 0.33 | lithium | 0.15 |
| | | | | dicyanamide | |
| LiTFAc | 0.50 | LiNO₃ | 0.50 | lithium | 0.15 |
| | | | | dicyanamide | |
| LiTFAc | 0.50 | LiNO₃ | 0.66 | lithium | 0.15 |
| | | | | dicyanamide | |
| LiTFAc | 0.50 | LiNO₃ | 0.75 | lithium | 0.15 |
| | | | | dicyanamide | |
| LiTFAc | 0.50 | LiNO₃ | 1.00 | lithium | 0.15 |
| | | | | dicyanamide | |
| LiTFAc | 0.66 | LiNO₃ | 0.10 | lithium | 0.10 |
| | | | | dicyanamide | |
| LiTFAc | 0.66 | LiNO₃ | 0.25 | lithium | 0.10 |
| | | | | dicyanamide | |
| LiTFAc | 0.66 | LiNO₃ | 0.33 | lithium | 0.10 |
| | | | | dicyanamide | |
| LiTFAc | 0.66 | LiNO₃ | 0.50 | lithium | 0.10 |
| | | | | dicyanamide | |
| LiTFAc | 0.66 | LiNO₃ | 0.66 | lithium | 0.10 |
| | | | | dicyanamide | |
| LiTFAc | 0.66 | LiNO₃ | 0.75 | lithium | 0.10 |
| | | | | dicyanamide | |
| LiTFAc | 0.66 | LiNO₃ | 1.00 | lithium | 0.10 |
| | | | | dicyanamide | |
| LiTFAc | 0.66 | LiNO₃ | 0.10 | lithium | 0.15 |
| | | | | dicyanamide | |
| LiTFAc | 0.66 | LiNO₃ | 0.25 | lithium | 0.15 |
| | | | | dicyanamide | |
| LiTFAc | 0.66 | LiNO₃ | 0.33 | lithium | 0.15 |
| | | | | dicyanamide | |
| LiTFAc | 0.66 | LiNO₃ | 0.50 | lithium | 0.15 |
| | | | | dicyanamide | |
| LiTFAc | 0.66 | LiNO₃ | 0.66 | lithium | 0.15 |
| | | | | dicyanamide | |
| LiTFAc | 0.66 | LiNO₃ | 0.75 | lithium | 0.15 |
| | | | | dicyanamide | |
| LiTFAc | 0.66 | LiNO₃ | 1.00 | lithium | 0.15 |
| | | | | dicyanamide | |
| LiTFAc | 0.75 | LiNO₃ | 0.10 | lithium | 0.10 |
| | | | | dicyanamide | |
| LiTFAc | 0.75 | LiNO₃ | 0.25 | lithium | 0.10 |
| | | | | dicyanamide | |
| LiTFAc | 0.75 | LiNO₃ | 0.33 | lithium | 0.10 |
| | | | | dicyanamide | |
| LiTFAc | 0.75 | LiNO₃ | 0.50 | lithium | 0.10 |
| | | | | dicyanamide | |
| LiTFAc | 0.75 | LiNO₃ | 0.66 | lithium | 0.10 |
| | | | | dicyanamide | |
| LiTFAc | 0.75 | LiNO₃ | 0.75 | lithium | 0.10 |
| | | | | dicyanamide | |
| LiTFAc | 0.75 | LiNO₃ | 1.00 | lithium | 0.10 |
| | | | | dicyanamide | |
| LiTFAc | 0.75 | LiNO₃ | 0.10 | lithium | 0.15 |
| | | | | dicyanamide | |
| LiTFAc | 0.75 | LiNO₃ | 0.25 | lithium | 0.15 |
| | | | | dicyanamide | |
| LiTFAc | 0.75 | LiNO₃ | 0.33 | lithium | 0.15 |
| | | | | dicyanamide | |
| LiTFAc | 0.75 | LiNO₃ | 0.50 | lithium | 0.15 |
| | | | | dicyanamide | |
| LiTFAc | 0.75 | LiNO₃ | 0.66 | lithium | 0.15 |
| | | | | dicyanamide | |
| LiTFAc | 0.75 | LiNO₃ | 0.75 | lithium | 0.15 |
| | | | | dicyanamide | |
| LiTFAc | 0.75 | LiNO₃ | 1.00 | lithium | 0.15 |
| | | | | dicyanamide | |
| LiTFAc | 1.00 | LiNO₃ | 0.10 | lithium | 0.10 |
| | | | | dicyanamide | |
| LiTFAc | 1.00 | LiNO₃ | 0.25 | lithium | 0.10 |
| | | | | dicyanamide | |
| LiTFAc | 1.00 | LiNO₃ | 0.33 | lithium | 0.10 |
| | | | | dicyanamide | |
| LiTFAc | 1.00 | LiNO₃ | 0.50 | lithium | 0.10 |
| | | | | dicyanamide | |
| LiTFAc | 1.00 | LiNO₃ | 0.66 | lithium | 0.10 |
| | | | | dicyanamide | |
| LiTFAc | 1.00 | LiNO₃ | 0.75 | lithium | 0.10 |
| | | | | dicyanamide | |
| LiTFAc | 1.00 | LiNO₃ | 1.00 | lithium | 0.10 |
| | | | | dicyanamide | |
| LiTFAc | 1.00 | LiNO₃ | 0.10 | lithium | 0.15 |
| | | | | dicyanamide | |
| LiTFAc | 1.00 | LiNO₃ | 0.25 | lithium | 0.15 |
| | | | | dicyanamide | |
| LiTFAc | 1.00 | LiNO₃ | 0.33 | lithium | 0.15 |
| | | | | dicyanamide | |
| LiTFAc | 1.00 | LiNO₃ | 0.50 | lithium | 0.15 |
| | | | | dicyanamide | |
| LiTFAc | 1.00 | LiNO₃ | 0.66 | lithium | 0.15 |
| | | | | dicyanamide | |
| LiTFAc | 1.00 | LiNO₃ | 0.75 | lithium | 0.15 |
| | | | | dicyanamide | |
| LiTFAc | 1.00 | LiNO₃ | 1.00 | lithium | 0.15 |
| | | | | dicyanamide | |
| LiTFAc | 0.10 | LiClO₄ | 0.10 | lithium | 0.10 |
| | | | | dicyanamide | |
| LiTFAc | 0.10 | LiClO₄ | 0.25 | lithium | 0.10 |
| | | | | dicyanamide | |
| LiTFAc | 0.10 | LiClO₄ | 0.33 | lithium | 0.10 |
| | | | | dicyanamide | |
| LiTFAc | 0.10 | LiClO₄ | 0.50 | lithium | 0.10 |
| | | | | dicyanamide | |
| LiTFAc | 0.10 | LiClO₄ | 0.66 | lithium | 0.10 |
| | | | | dicyanamide | |
| LiTFAc | 0.10 | LiClO₄ | 0.75 | lithium | 0.10 |
| | | | | dicyanamide | |
| LiTFAc | 0.10 | LiClO₄ | 1.00 | lithium | 0.10 |
| | | | | dicyanamide | |
| LiTFAc | 0.10 | LiClO₄ | 0.10 | lithium | 0.15 |
| | | | | dicyanamide | |
| LiTFAc | 0.10 | LiClO₄ | 0.25 | lithium | 0.15 |
| | | | | dicyanamide | |
| LiTFAc | 0.10 | LiClO₄ | 0.33 | lithium | 0.15 |
| | | | | dicyanamide | |
| LiTFAc | 0.10 | LiClO₄ | 0.50 | lithium | 0.15 |
| | | | | dicyanamide | |
| LiTFAc | 0.10 | LiClO₄ | 0.66 | lithium | 0.15 |
| | | | | dicyanamide | |
| LiTFAc | 0.10 | LiClO₄ | 0.75 | lithium | 0.15 |
| | | | | dicyanamide | |
| LiTFAc | 0.10 | LiClO₄ | 1.00 | lithium | 0.15 |
| | | | | dicyanamide | |
| LiTFAc | 0.25 | LiClO₄ | 0.10 | lithium | 0.10 |
| | | | | dicyanamide | |
| LiTFAc | 0.25 | LiClO₄ | 0.25 | lithium | 0.10 |
| | | | | dicyanamide | |
| LiTFAc | 0.25 | LiClO₄ | 0.33 | lithium | 0.10 |
| | | | | dicyanamide | |
| LiTFAc | 0.25 | LiClO₄ | 0.50 | lithium | 0.10 |
| | | | | dicyanamide | |
| LiTFAc | 0.25 | LiClO₄ | 0.66 | lithium | 0.10 |
| | | | | dicyanamide | |
| LiTFAc | 0.25 | LiClO₄ | 0.75 | lithium | 0.10 |
| | | | | dicyanamide | |
| LiTFAc | 0.25 | LiClO₄ | 1.00 | lithium | 0.10 |
| | | | | dicyanamide | |
| LiTFAc | 0.25 | LiClO₄ | 0.10 | lithium | 0.15 |
| | | | | dicyanamide | |
| LiTFAc | 0.25 | LiClO₄ | 0.25 | lithium | 0.15 |
| | | | | dicyanamide | |
| LiTFAc | 0.25 | LiClO₄ | 0.33 | lithium | 0.15 |
| | | | | dicyanamide | |
| LiTFAc | 0.25 | LiClO₄ | 0.50 | lithium | 0.15 |
| | | | | dicyanamide | |
| LiTFAc | 0.25 | LiClO₄ | 0.66 | lithium | 0.15 |
| | | | | dicyanamide | |
| LiTFAc | 0.25 | LiClO₄ | 0.75 | lithium | 0.15 |
| | | | | dicyanamide | |
| LiTFAc | 0.25 | LiClO₄ | 1.00 | lithium | 0.15 |
| | | | | dicyanamide | |
| LiTFAc | 0.40 | LiClO₄ | 0.10 | lithium | 0.10 |
| | | | | dicyanamide | |
| LiTFAc | 0.40 | LiClO₄ | 0.25 | lithium | 0.10 |
| | | | | dicyanamide | |
| LiTFAc | 0.40 | LiClO₄ | 0.33 | lithium | 0.10 |
| | | | | dicyanamide | |
| LiTFAc | 0.40 | LiClO₄ | 0.50 | lithium | 0.10 |
| | | | | dicyanamide | |
| LiTFAc | 0.40 | LiClO₄ | 0.66 | lithium | 0.10 |
| | | | | dicyanamide | |
| LiTFAc | 0.40 | LiClO₄ | 0.75 | lithium | 0.10 |
| | | | | dicyanamide | |
| LiTFAc | 0.40 | LiClO₄ | 1.00 | lithium | 0.10 |
| | | | | dicyanamide | |
| LiTFAc | 0.40 | LiClO₄ | 0.10 | lithium | 0.15 |
| | | | | dicyanamide | |
| LiTFAc | 0.40 | LiClO₄ | 0.25 | lithium | 0.15 |
| | | | | dicyanamide | |
| LiTFAc | 0.40 | LiClO₄ | 0.33 | lithium | 0.15 |
| | | | | dicyanamide | |
| LiTFAc | 0.40 | LiClO₄ | 0.50 | lithium | 0.15 |
| | | | | dicyanamide | |
| LiTFAc | 0.40 | LiClO₄ | 0.66 | lithium | 0.15 |
| | | | | dicyanamide | |
| LiTFAc | 0.40 | LiClO₄ | 0.75 | lithium | 0.15 |
| | | | | dicyanamide | |
| LiTFAc | 0.40 | LiClO₄ | 1.00 | lithium | 0.15 |
| | | | | dicyanamide | |
| LiTFAc | 0.50 | LiClO₄ | 0.10 | lithium | 0.10 |
| | | | | dicyanamide | |
| LiTFAc | 0.50 | LiClO₄ | 0.25 | lithium | 0.10 |
| | | | | dicyanamide | |
| LiTFAc | 0.50 | LiClO₄ | 0.33 | lithium | 0.10 |
| | | | | dicyanamide | |
| LiTFAc | 0.50 | LiClO₄ | 0.50 | lithium | 0.10 |
| | | | | dicyanamide | |
| LiTFAc | 0.50 | LiClO₄ | 0.66 | lithium | 0.10 |
| | | | | dicyanamide | |
| LiTFAc | 0.50 | LiClO₄ | 0.75 | lithium | 0.10 |
| | | | | dicyanamide | |
| LiTFAc | 0.50 | LiClO₄ | 1.00 | lithium | 0.10 |
| | | | | dicyanamide | |
| LiTFAc | 0.50 | LiClO₄ | 0.10 | lithium | 0.15 |
| | | | | dicyanamide | |
| LiTFAc | 0.50 | LiClO₄ | 0.25 | lithium | 0.15 |
| | | | | dicyanamide | |
| LiTFAc | 0.50 | LiClO₄ | 0.33 | lithium | 0.15 |
| | | | | dicyanamide | |
| LiTFAc | 0.50 | LiClO₄ | 0.50 | lithium | 0.15 |
| | | | | dicyanamide | |
| LiTFAc | 0.50 | LiClO₄ | 0.66 | lithium | 0.15 |
| | | | | dicyanamide | |
| LiTFAc | 0.50 | LiClO₄ | 0.75 | lithium | 0.15 |
| | | | | dicyanamide | |
| LiTFAc | 0.50 | LiClO₄ | 1.00 | lithium | 0.15 |
| | | | | dicyanamide | |
| LiTFAc | 0.66 | LiClO₄ | 0.10 | lithium | 0.10 |
| | | | | dicyanamide | |
| LiTFAc | 0.66 | LiClO₄ | 0.25 | lithium | 0.10 |
| | | | | dicyanamide | |
| LiTFAc | 0.66 | LiClO₄ | 0.33 | lithium | 0.10 |
| | | | | dicyanamide | |
| LiTFAc | 0.66 | LiClO₄ | 0.50 | lithium | 0.10 |
| | | | | dicyanamide | |
| LiTFAc | 0.66 | LiClO₄ | 0.66 | lithium | 0.10 |
| | | | | dicyanamide | |
| LiTFAc | 0.66 | LiClO₄ | 0.75 | lithium | 0.10 |
| | | | | dicyanamide | |
| LiTFAc | 0.66 | LiClO₄ | 1.00 | lithium | 0.10 |
| | | | | dicyanamide | |
| LiTFAc | 0.66 | LiClO₄ | 0.10 | lithium | 0.15 |
| | | | | dicyanamide | |
| LiTFAc | 0.66 | LiClO₄ | 0.25 | lithium | 0.15 |
| | | | | dicyanamide | |
| LiTFAc | 0.66 | LiClO₄ | 0.33 | lithium | 0.15 |
| | | | | dicyanamide | |
| LiTFAc | 0.66 | LiClO₄ | 0.50 | lithium | 0.15 |
| | | | | dicyanamide | |
| LiTFAc | 0.66 | LiClO₄ | 0.66 | lithium | 0.15 |
| | | | | dicyanamide | |
| LiTFAc | 0.66 | LiClO₄ | 0.75 | lithium | 0.15 |
| | | | | dicyanamide | |
| LiTFAc | 0.66 | LiClO₄ | 1.00 | lithium | 0.15 |
| | | | | dicyanamide | |
| LiTFAc | 0.75 | LiClO₄ | 0.10 | lithium | 0.10 |
| | | | | dicyanamide | |
| LiTFAc | 0.75 | LiClO₄ | 0.25 | lithium | 0.10 |
| | | | | dicyanamide | |
| LiTFAc | 0.75 | LiClO₄ | 0.33 | lithium | 0.10 |
| | | | | dicyanamide | |
| LiTFAc | 0.75 | LiClO₄ | 0.50 | lithium | 0.10 |
| | | | | dicyanamide | |
| LiTFAc | 0.75 | LiClO₄ | 0.66 | lithium | 0.10 |
| | | | | dicyanamide | |
| LiTFAc | 0.75 | LiClO₄ | 0.75 | lithium | 0.10 |
| | | | | dicyanamide | |
| LiTFAc | 0.75 | LiClO₄ | 1.00 | lithium | 0.10 |
| | | | | dicyanamide | |
| LiTFAc | 0.75 | LiClO₄ | 0.10 | lithium | 0.15 |
| | | | | dicyanamide | |
| LiTFAc | 0.75 | LiClO₄ | 0.25 | lithium | 0.15 |
| | | | | dicyanamide | |
| LiTFAc | 0.75 | LiClO₄ | 0.33 | lithium | 0.15 |
| | | | | dicyanamide | |
| LiTFAc | 0.75 | LiClO₄ | 0.50 | lithium | 0.15 |
| | | | | dicyanamide | |
| LiTFAc | 0.75 | LiClO₄ | 0.66 | lithium | 0.15 |
| | | | | dicyanamide | |
| LiTFAc | 0.75 | LiClO₄ | 0.75 | lithium | 0.15 |
| | | | | dicyanamide | |
| LiTFAc | 0.75 | LiClO₄ | 1.00 | lithium | 0.15 |
| | | | | dicyanamide | |
| LiTFAc | 1.00 | LiClO₄ | 0.10 | lithium | 0.10 |
| | | | | dicyanamide | |
| LiTFAc | 1.00 | LiClO₄ | 0.25 | lithium | 0.10 |
| | | | | dicyanamide | |
| LiTFAc | 1.00 | LiClO₄ | 0.33 | lithium | 0.10 |
| | | | | dicyanamide | |
| LiTFAc | 1.00 | LiClO₄ | 0.50 | lithium | 0.10 |
| | | | | dicyanamide | |
| LiTFAc | 1.00 | LiClO₄ | 0.66 | lithium | 0.10 |
| | | | | dicyanamide | |
| LiTFAc | 1.00 | LiClO₄ | 0.75 | lithium | 0.10 |
| | | | | dicyanamide | |
| LiTFAc | 1.00 | LiClO₄ | 1.00 | lithium | 0.10 |
| | | | | dicyanamide | |
| LiTFAc | 1.00 | LiClO₄ | 0.10 | lithium | 0.15 |
| | | | | dicyanamide | |
| LiTFAc | 1.00 | LiClO₄ | 0.25 | lithium | 0.15 |
| | | | | dicyanamide | |
| LiTFAc | 1.00 | LiClO₄ | 0.33 | lithium | 0.15 |
| | | | | dicyanamide | |
| LiTFAc | 1.00 | LiClO₄ | 0.50 | lithium | 0.15 |
| | | | | dicyanamide | |
| LiTFAc | 1.00 | LiClO₄ | 0.66 | lithium | 0.15 |
| | | | | dicyanamide | |
| LiTFAc | 1.00 | LiClO₄ | 0.75 | lithium | 0.15 |
| | | | | dicyanamide | |
| LiTFAc | 1.00 | LiClO₄ | 1.00 | lithium | 0.15 |
| | | | | dicyanamide | |
| LiTFAc | 0.10 | lithium | 0.10 | lithium | 0.10 |
| | | trifilate (LiTf) | | dicyanamide | |
| LiTFAc | 0.10 | LiTf | 0.25 | lithium | 0.10 |
| | | | | dicyanamide | |
| LiTFAc | 0.10 | LiTf | 0.33 | lithium | 0.10 |
| | | | | dicyanamide | |
| LiTFAc | 0.10 | LiTf | 0.50 | lithium | 0.10 |
| | | | | dicyanamide | |
| LiTFAc | 0.10 | LiTf | 0.66 | lithium | 0.10 |
| | | | | dicyanamide | |
| LiTFAc | 0.10 | LiTf | 0.75 | lithium | 0.10 |
| | | | | dicyanamide | |
| LiTFAc | 0.10 | LiTf | 1.00 | lithium | 0.10 |
| | | | | dicyanamide | |
| LiTFAc | 0.10 | LiTf | 0.10 | lithium | 0.15 |
| | | | | dicyanamide | |
| LiTFAc | 0.10 | LiTf | 0.25 | lithium | 0.15 |
| | | | | dicyanamide | |
| LiTFAc | 0.10 | LiTf | 0.33 | lithium | 0.15 |
| | | | | dicyanamide | |
| LiTFAc | 0.10 | LiTf | 0.50 | lithium | 0.15 |
| | | | | dicyanamide | |
| LiTFAc | 0.10 | LiTf | 0.66 | lithium | 0.15 |
| | | | | dicyanamide | |
| LiTFAc | 0.10 | LiTf | 0.75 | lithium | 0.15 |
| | | | | dicyanamide | |
| LiTFAc | 0.10 | LiTf | 1.00 | lithium | 0.15 |
| | | | | dicyanamide | |
| LiTFAc | 0.25 | LiTf | 0.10 | lithium | 0.10 |
| | | | | dicyanamide | |
| LiTFAc | 0.25 | LiTf | 0.25 | lithium | 0.10 |
| | | | | dicyanamide | |
| LiTFAc | 0.25 | LiTf | 0.33 | lithium | 0.10 |
| | | | | dicyanamide | |
| LiTFAc | 0.25 | LiTf | 0.50 | lithium | 0.10 |
| | | | | dicyanamide | |
| LiTFAc | 0.25 | LiTf | 0.66 | lithium | 0.10 |
| | | | | dicyanamide | |
| LiTFAc | 0.25 | LiTf | 0.75 | lithium | 0.10 |
| | | | | dicyanamide | |
| LiTFAc | 0.25 | LiTf | 1.00 | lithium | 0.10 |
| | | | | dicyanamide | |
| LiTFAc | 0.25 | LiTf | 0.10 | lithium | 0.15 |
| | | | | dicyanamide | |
| LiTFAc | 0.25 | LiTf | 0.25 | lithium | 0.15 |
| | | | | dicyanamide | |
| LiTFAc | 0.25 | LiTf | 0.33 | lithium | 0.15 |
| | | | | dicyanamide | |
| LiTFAc | 0.25 | LiTf | 0.50 | lithium | 0.15 |
| | | | | dicyanamide | |
| LiTFAc | 0.25 | LiTf | 0.66 | lithium | 0.15 |
| | | | | dicyanamide | |
| LiTFAc | 0.25 | LiTf | 0.75 | lithium | 0.15 |
| | | | | dicyanamide | |
| LiTFAc | 0.25 | LiTf | 1.00 | lithium | 0.15 |
| | | | | dicyanamide | |
| LiTFAc | 0.40 | LiTf | 0.10 | lithium | 0.10 |
| | | | | dicyanamide | |
| LiTFAc | 0.40 | LiTf | 0.25 | lithium | 0.10 |
| | | | | dicyanamide | |
| LiTFAc | 0.40 | LiTf | 0.33 | lithium | 0.10 |
| | | | | dicyanamide | |
| LiTFAc | 0.40 | LiTf | 0.50 | lithium | 0.10 |
| | | | | dicyanamide | |
| LiTFAc | 0.40 | LiTf | 0.66 | lithium | 0.10 |
| | | | | dicyanamide | |
| LiTFAc | 0.40 | LiTf | 0.75 | lithium | 0.10 |
| | | | | dicyanamide | |
| LiTFAc | 0.40 | LiTf | 1.00 | lithium | 0.10 |
| | | | | dicyanamide | |
| LiTFAc | 0.40 | LiTf | 0.10 | lithium | 0.15 |
| | | | | dicyanamide | |
| LiTFAc | 0.40 | LiTf | 0.25 | lithium | 0.15 |
| | | | | dicyanamide | |
| LiTFAc | 0.40 | LiTf | 0.33 | lithium | 0.15 |
| | | | | dicyanamide | |
| LiTFAc | 0.40 | LiTf | 0.50 | lithium | 0.15 |
| | | | | dicyanamide | |
| LiTFAc | 0.40 | LiTf | 0.66 | lithium | 0.15 |
| | | | | dicyanamide | |
| LiTFAc | 0.40 | LiTf | 0.75 | lithium | 0.15 |
| | | | | dicyanamide | |
| LiTFAc | 0.40 | LiTf | 1.00 | lithium | 0.15 |
| | | | | dicyanamide | |
| LiTFAc | 0.50 | LiTf | 0.10 | lithium | 0.10 |
| | | | | dicyanamide | |
| LiTFAc | 0.50 | LiTf | 0.25 | lithium | 0.10 |
| | | | | dicyanamide | |
| LiTFAc | 0.50 | LiTf | 0.33 | lithium | 0.10 |
| | | | | dicyanamide | |
| LiTFAc | 0.50 | LiTf | 0.50 | lithium | 0.10 |
| | | | | dicyanamide | |
| LiTFAc | 0.50 | LiTf | 0.66 | lithium | 0.10 |
| | | | | dicyanamide | |
| LiTFAc | 0.50 | LiTf | 0.75 | lithium | 0.10 |
| | | | | dicyanamide | |
| LiTFAc | 0.50 | LiTf | 1.00 | lithium | 0.10 |
| | | | | dicyanamide | |
| LiTFAc | 0.50 | LiTf | 0.10 | lithium | 0.15 |
| | | | | dicyanamide | |
| LiTFAc | 0.50 | LiTf | 0.25 | lithium | 0.15 |
| | | | | dicyanamide | |
| LiTFAc | 0.50 | LiTf | 0.33 | lithium | 0.15 |
| | | | | dicyanamide | |
| LiTFAc | 0.50 | LiTf | 0.50 | lithium | 0.15 |
| | | | | dicyanamide | |
| LiTFAc | 0.50 | LiTf | 0.66 | lithium | 0.15 |
| | | | | dicyanamide | |
| LiTFAc | 0.50 | LiTf | 0.75 | lithium | 0.15 |
| | | | | dicyanamide | |
| LiTFAc | 0.50 | LiTf | 1.00 | lithium | 0.15 |
| | | | | dicyanamide | |
| LiTFAc | 0.66 | LiTf | 0.10 | lithium | 0.10 |
| | | | | dicyanamide | |
| LiTFAc | 0.66 | LiTf | 0.25 | lithium | 0.10 |
| | | | | dicyanamide | |
| LiTFAc | 0.66 | LiTf | 0.33 | lithium | 0.10 |
| | | | | dicyanamide | |
| LiTFAc | 0.66 | LiTf | 0.50 | lithium | 0.10 |
| | | | | dicyanamide | |
| LiTFAc | 0.66 | LiTf | 0.66 | lithium | 0.10 |
| | | | | dicyanamide | |
| LiTFAc | 0.66 | LiTf | 0.75 | lithium | 0.10 |
| | | | | dicyanamide | |
| LiTFAc | 0.66 | LiTf | 1.00 | lithium | 0.10 |
| | | | | dicyanamide | |
| LiTFAc | 0.66 | LiTf | 0.10 | lithium | 0.15 |
| | | | | dicyanamide | |
| LiTFAc | 0.66 | LiTf | 0.25 | lithium | 0.15 |
| | | | | dicyanamide | |
| LiTFAc | 0.66 | LiTf | 0.33 | lithium | 0.15 |
| | | | | dicyanamide | |
| LiTFAc | 0.66 | LiTf | 0.50 | lithium | 0.15 |
| | | | | dicyanamide | |
| LiTFAc | 0.66 | LiTf | 0.66 | lithium | 0.15 |
| | | | | dicyanamide | |
| LiTFAc | 0.66 | LiTf | 0.75 | lithium | 0.15 |
| | | | | dicyanamide | |
| LiTFAc | 0.66 | LiTf | 1.00 | lithium | 0.15 |
| | | | | dicyanamide | |
| LiTFAc | 0.75 | LiTf | 0.10 | lithium | 0.10 |
| | | | | dicyanamide | |
| LiTFAc | 0.75 | LiTf | 0.25 | lithium | 0.10 |
| | | | | dicyanamide | |
| LiTFAc | 0.75 | LiTf | 0.33 | lithium | 0.10 |
| | | | | dicyanamide | |
| LiTFAc | 0.75 | LiTf | 0.50 | lithium | 0.10 |
| | | | | dicyanamide | |
| LiTFAc | 0.75 | LiTf | 0.66 | lithium | 0.10 |
| | | | | dicyanamide | |
| LiTFAc | 0.75 | LiTf | 0.75 | lithium | 0.10 |
| | | | | dicyanamide | |
| LiTFAc | 0.75 | LiTf | 1.00 | lithium | 0.10 |
| | | | | dicyanamide | |
| LiTFAc | 0.75 | LiTf | 0.10 | lithium | 0.15 |
| | | | | dicyanamide | |
| LiTFAc | 0.75 | LiTf | 0.25 | lithium | 0.15 |
| | | | | dicyanamide | |
| LiTFAc | 0.75 | LiTf | 0.33 | lithium | 0.15 |
| | | | | dicyanamide | |
| LiTFAc | 0.75 | LiTf | 0.50 | lithium | 0.15 |
| | | | | dicyanamide | |
| LiTFAc | 0.75 | LiTf | 0.66 | lithium | 0.15 |
| | | | | dicyanamide | |
| LiTFAc | 0.75 | LiTf | 0.75 | lithium | 0.15 |
| | | | | dicyanamide | |
| LiTFAc | 0.75 | LiTf | 1.00 | lithium | 0.15 |
| | | | | dicyanamide | |
| LiTFAc | 1.00 | LiTf | 0.10 | lithium | 0.10 |
| | | | | dicyanamide | |
| LiTFAc | 1.00 | LiTf | 0.25 | lithium | 0.10 |
| | | | | dicyanamide | |
| LiTFAc | 1.00 | LiTf | 0.33 | lithium | 0.10 |
| | | | | dicyanamide | |
| LiTFAc | 1.00 | LiTf | 0.50 | lithium | 0.10 |
| | | | | dicyanamide | |
| LiTFAc | 1.00 | LiTf | 0.66 | lithium | 0.10 |
| | | | | dicyanamide | |
| LiTFAc | 1.00 | LiTf | 0.75 | lithium | 0.10 |
| | | | | dicyanamide | |
| LiTFAc | 1.00 | LiTf | 1.00 | lithium | 0.10 |
| | | | | dicyanamide | |
| LiTFAc | 1.00 | LiTf | 0.10 | lithium | 0.15 |
| | | | | dicyanamide | |
| LiTFAc | 1.00 | LiTf | 0.25 | lithium | 0.15 |
| | | | | dicyanamide | |
| LiTFAc | 1.00 | LiTf | 0.33 | lithium | 0.15 |
| | | | | dicyanamide | |
| LiTFAc | 1.00 | LiTf | 0.50 | lithium | 0.15 |
| | | | | dicyanamide | |
| LiTFAc | 1.00 | LiTf | 0.66 | lithium | 0.15 |
| | | | | dicyanamide | |
| LiTFAc | 1.00 | LiTf | 0.75 | lithium | 0.15 |
| | | | | dicyanamide | |
| LiTFAc | 1.00 | LiTf | 1.00 | lithium | 0.15 |
| | | | | dicyanamide | |

In various approaches, the inventive structures, compositions, configurations, etc. described herein may be implemented in electrochemical cells of various types for practical utilization in a wide variety of applications. Without limitation, exemplary electrochemical cell configurations that may utilize any combination of features described herein, may be in the form of a pouch, a coin, a prismatic cell, a cylindrical configuration, or any suitable equivalent(s) thereof that would be appreciated by those having ordinary skill in the art upon reading the present disclosure.

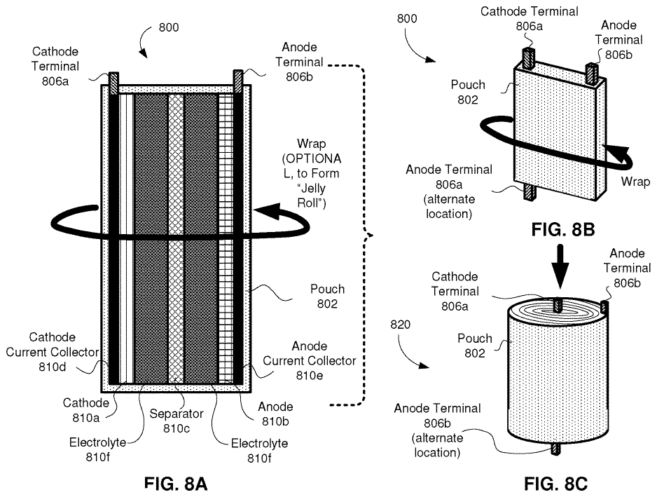

With reference to electrochemical cells having a pouch cell arrangement 800, and as shown according to exemplary embodiments in FIGS. 8A-8C, an electrochemical cell includes a cathode 810a and an anode 810b positioned on opposing sides of the pouch cell arrangement 800, and separated (physically and/or chemically) by a separator 810c. The anode 810c and cathode 810a are electronically coupled via an electrolyte 810f present in the pouch cell arrangement 800. Moreover, each electrode is electronically coupled to an external environment of the pouch cell arrangement 800 via a current collector and corresponding terminal, i.e. the cathode 810a is coupled to the external environment via cathode current collector 810d and cathode terminal 806a, while the anode 810b is coupled via anode current collector 810e and anode terminal 806b. The foregoing structures are enclosed, encased, or otherwise spatially fixed and contained via a pouch 802 surrounding the components.

The pouch 802, according to various embodiments, may take any suitable form that would be understood by those having ordinary skill in the art upon reading the present disclosure, such as a wrapping, a coating, an enclosure (soft or hard), a compressive structure (such as a metal band or mesh), etc. as would be understood by those having ordinary skill in the art upon reading the present disclosure.

Moreover, as shown in FIG. 8B, the anode terminal 806b and cathode terminal 806a extend through the pouch 802, providing electronic coupling between interior and exterior environments of the pouch cell arrangement 800. Note the anode terminal 806b may alternatively be positioned on a same side, or an opposite side, of the pouch cell arrangement 800 relative to the cathode terminal 806a. Moreover, the relative position of the anode terminal 806b and the cathode terminal 806a may be switched relative to the arrangement shown in FIGS. 8B and 8C, according to alternative implementations and without departing from the scope of the presently described inventive concepts.

As noted in FIGS. 8A and 8B, the illustrative pouch cell arrangement 800 may be wound around, e.g., its longitudinal axis, to form a spiral, folded, pleated, rolled, or otherwise at least partially overlapping configuration of the above-referenced electrochemical cell components. In preferred implementations, winding the pouch cell arrangement 800 yields a configuration known as a “jellyroll”, Shown schematically in FIG. 8C.

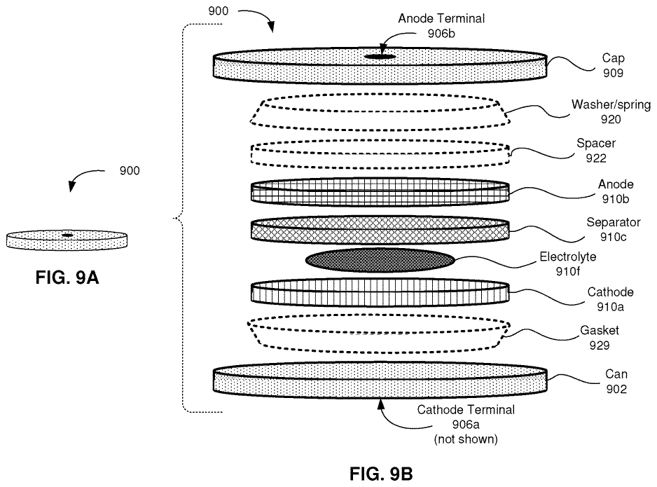

Turning now to FIGS. 9A and 9B, which depict a simplified schematic of an electrochemical cell configured according to a coin cell arrangement 900 is aptly named for its substantially flat, cylindrical shape as shown in FIG. 9A. According to various embodiments, the cylindrical cell arrangement 900 includes a can 902 and cap 904 which protect the components placed therein from mechanical damage, chemical damage (e.g. corrosion, oxidation, etc.) electrical damage, etc. and also prevent leakage of compounds within the cylindrical cell arrangement 900 into the environment.

Coupled to the cap 904 is an anode terminal 906b, and likewise coupled to the can 902 is a cathode terminal 906a (not shown in FIG. 9B). Preferably, these terminals have a composition suitable for conducting electricity generated within the coin cell arrangement 900 to an appropriately connected or coupled output, and may be inserted into a circuit to provide power thereto, as would be appreciated by those having ordinary skill in the art upon reading the present descriptions. Exemplary compositions suitable for use in cathode terminal 906a and anode terminal 906b include electrically conductive metals, such as copper, nickel, etc. as known in the art, electrically conductive carbonaceous materials, such as graphene, etc. as known in the art, or any other suitable equivalent thereof that would be appreciated by a skilled artisan upon reading the present disclosures.

Turning now to FIG. 9B, a plurality of components that may be included in a coin cell arrangement 900 are shown according to an exploded view consistent with various embodiments of the presently described inventive concepts. It shall be appreciated that components such as washer/spring 920, spacer 922, and gasket 924, represented by dotted outlines, are optional and may, but need not, be included in accordance with the inventive concepts disclosed herein. However, it shall also be appreciated that, depending on the intended application for the coin cell arrangement 900, washer/spring 920, spacer 922, and/or gasket 924 may advantageously convey mechanical strength, or convey advantageous electrical properties, on the coin cell arrangement 900. For instance, washer/spring 920 and/or gasket 924 may help secure the other depicted components in place, facilitating desired operation of the coin cell arrangement 900. Similarly, spacer 922 may cushion the anode 910b from friction or compressive force from the washer/spring 920, and/or be formed from a material that facilitates conduction of heat and/or electricity from within the coin cell arrangement 900 to the anode terminal 906b, according to the configuration shown in FIG. 9B. Of course, those having ordinary skill in the art will appreciate various advantages that may be realized via inclusion of washer/spring 920, spacer 922, and/or gasket 924, in various implementations, based on knowledge generally available at the time of the present disclosure's filing date.

With continuing reference to FIG. 9B, illustrative coin cell arrangement 900 features internal components including an anode 910b positioned toward an opposing end of the coin cell arrangement as a cathode 910a, with a separator 910c and electrolyte 910f positioned therebetween. As with all electrochemical cell arrangements shown in FIGS. 8A-11 and consistent with corresponding descriptions thereof provided herein, the anode 910b, cathode 910a, separator 910c, and electrolyte 910f may each be characterized by any composition as known in the art or as described herein that a skilled artisan would appreciate as suitable for the respective function thereof in an electrochemical cell, upon reading the present disclosure and without departing from the scope of the presently described inventive concepts. Several such exemplary compositions are provided hereinbelow, and others may be set forth elsewhere in the detailed descriptions of the inventive concepts instantly set forth. Unless expressly admitted as being known in the art, it shall be understood that any such exemplary composition described for any of the components of electrochemical cell arrangements 8A-11 is not admitted as being so well-known, but rather is considered part of the inventive concepts presented herein.

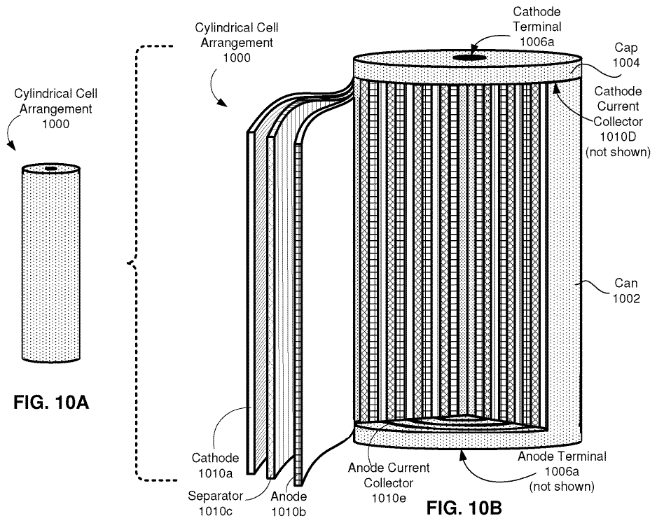

In other approaches, electrochemical cells may be characterized by a cylindrical cell arrangement 1000, e.g., as shown according to illustrative implementations in FIG. 10A (external view) and 10B (cut-out view), includes a can 1002 and a cap 1004 that contain and protect other components internal to the cylindrical cell configuration, in similar manner as described herein regarding coin cell arrangements such as coin cell arrangement 900 shown in FIGS. 9A and 9B. Also similar to other arrangements described herein, the cap 1004 and can 1002 each respectively include a terminal configured to conduct electricity generated within the cylindrical cell arrangement 1000 to an external environment, output device electrically coupled to the cylindrical cell arrangement 1000, etc., according to various embodiments and as would be appreciated by those having ordinary skill in the art upon reading the present disclosure. As shown in FIG. 10B, cap 1004 includes a cathode terminal 1006a, while can 1002 includes an anode terminal 1006b (not shown in FIG. 10B), positioned at substantially opposite ends of the cylindrical cell arrangement 1000. Of course, the relative position of the cathode terminal 1006a and anode terminal 1006b may be swapped, according to alternative embodiments of the cylindrical cell arrangement 1000.

With continuing reference to FIG. 10B, the illustrative cylindrical cell arrangement 1000 includes similar components as described herein with reference to other electrochemical cell arrangements, but structurally arranged in a unique manner. Most notably, while the cathode(s) 1010a and anode(s) 1010b are spatially separated by separator(s) 1010c, there are a plurality of such structures arranged in substantially laminar configuration and wound around a central longitudinal axis of the cylindrical cell arrangement 1000. In this manner, the cathode(s) 1010a and anode(s) 1010b are not positioned proximate to opposing ends of the cylindrical cell arrangement 1000 as is the case for pouch cell arrangement 800 and coin cell arrangement 900, but rather present throughout a volume of the cylindrical cell arrangement 1000. Regardless, consistent with pouch cell arrangement 800, the cylindrical cell arrangement 1000 includes a cathode current collector 1010d (not shown in FIG. 10B) and an anode current collector 1010e positioned at opposing ends of the cylindrical cell arrangement 1000 and electrically coupled to a corresponding terminal (i.e., either cathode terminal 1006a or anode terminal 1006b), as would be understood by those having ordinary skill in the art upon reading the present disclosures.

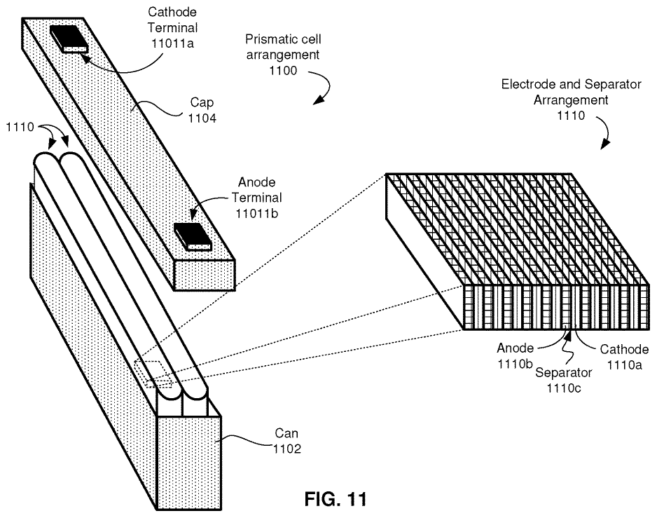

Now regarding FIG. 11, a simplified schematic of an electrochemical cell embodied in a prismatic configuration 1100 is shown, according to one aspect of the presently disclosed inventive concepts. As with other electrochemical cell arrangements described hereinabove, the prismatic cell arrangement 1100 includes a can 1102 and a cap 1104. Unique to the prismatic cell arrangement 1100, the can 1102 and cap 1104 as shown in FIG. 11 are substantially rectangular cuboidal in shape, although those having ordinary skill in the art will appreciate that a unique advantage of prismatic cell arrangements as contemplated herein is nearly unlimited flexibility with respect to the spatial configuration of the can 1102 and cap 1104. The sole limitation on such spatial configuration is the ability to fully enclose and contain the internal components, shown according to one exemplary embodiment with reference to electrode and separator arrangement 1110. This flexibility, in large part, is due to implementation of electrode and separator arrangements 1110 characterized by a laminar structure including anode(s) 1110a and cathode(s) 1110a physically and/or chemically separated by separator(s) 1110c. While the particular electrode and separator arrangement 1110 shown in FIG. 11 is a multi-layered structure (e.g., composed of a series of thin films deposited sequentially one onto the other) those having ordinary skill in the art will appreciate that according to various implementations the components of the electrode and separator arrangement 1110 (which may include components other than anode 1110b, cathode 1110a, and separator 1110c without departing from the scope of the presently disclosed inventive concepts) may be arranged in a “rolled” configuration such as shown in FIGS. 8C and 10B, or in a folded configuration, a pleated configuration, or any other configuration in which at least portion(s) of the components of the electrode and separator arrangement 1110 at least partially overlap themselves, one another, or both. Furthermore, combinations of overlapping arrangements may be implemented in electrode and separator arrangement 1110 without departing from the scope of the presently disclosed inventive concepts.

Returning to the cap 1104 of exemplary prismatic cell arrangement 1100 shown in FIG. 11, in one illustrative implementation a plurality of terminals including cathode terminal 1106a and anode terminal 1106b are disposed on an external surface of the cap 1104 and electrically coupled to the electrode and separator arrangement 1110, e.g. via one or more current collectors (not shown in FIG. 11) using any suitable means and/or mechanisms that would be understood by those having ordinary skill in the art upon reading the instant descriptions.

Several exemplary electrochemical cell arrangements have been shown and described with reference to FIGS. 8A-11, and shall be understood as illustrative rather than limiting on the scope of the inventive concepts presented herein. Moreover, certain arrangements are depicted as including or omitting certain components not expressly shown or described with reference to other arrangements (such as the washer/spring 820, spacer 822, gasket 824, electrolyte 810f, current collectors 810d and 810e, shown with reference to FIG. 8A but not expressly shown or described with reference to other arrangements set forth herein. Despite the particular components shown in FIGS. 8A-11, it shall be understood that any electrochemical cell arrangement, whether in accordance with FIGS. 8A-11 or according to a different electrochemical cell arrangement, may include any suitable combination of components described with reference to any single Figure, or components not shown in any of the Figures, but which would be appreciated as suitable for creating a functioning electrochemical cell by a person having ordinary skill in the art upon reading the instant descriptions.

Of course, the various exemplary embodiments of electrochemical cells arranged according to different configurations shown in FIGS. 8A-11 and described hereinabove are provided for illustrative purposes, and should not be interpreted as limiting on the scope of electrochemical cells in which the inventive anode structures and compositions presently disclosed may be implemented. For instance, in various approaches different electrochemical cell configurations may be used together, in any combination, to provide power to one or more machines.

Moreover, the exemplary electrochemical cell configurations described hereinabove may be modified in any suitable manner known in the art without departing from the scope of the inventive concepts described herein. For instance, various components shown above in FIGS. 8A-11 may be modified, substituted, omitted, supplemented, etc. in any manner that a skilled artisan reading the present disclosure would appreciate as suitable for producing a working electrochemical cell, without extending beyond the scope of the presently described inventive concepts.

For instance, according to various embodiments, electrochemical cells implemented in accordance with the presently described inventive concepts may include one or more (preferably at least two) electrodes, which may individually be characterized as anode(s), or cathode(s), e.g., according to electrochemical function within the overall cell, and may be formed from any suitable material(s) known in the art and appreciated, upon reading the present disclosure, as suitable for use in combination with other structures and compositions in the exemplary electrochemical cell and in accordance with the inventive concepts provided herein.

In some approaches, either or both electrode types may be configured in the form of a three-dimensional, monolithic structure that is “free-standing”. In other words, the “free-standing” electrode is “structurally self-supporting”, such that no separate substrate, framework, scaffold, foam, matrix, current collector, supporting fluid, etc. is necessary for the monolith to support its own weight and maintain defining physical characteristics (e.g., density, volume, porosity, physical dimensions, shape, chemical composition, etc.) when deposited, positioned, or otherwise placed in a working environment such as an electrochemical cell. Of course, the inventive concepts presented herein should not be interpreted as being limited in any way to inclusion of or requirement for “free standing” electrode(s), but should be understood as allowing for such structures where advantageous to the specific application(s) or intended utility for the inventive electrochemical cell of interest.

Where a “free standing” electrode structure is implemented, corresponding electrochemical cells may, and preferably do, omit a distinct current collector (or at least a distinct anode current collector), according to select implementations. Indeed, even where no “free standing” electrode structure is present, electrochemical cells in accordance with the inventive concepts described herein may still omit a distinct current collector structure or component.

For instance, according to certain implementations, the electrode itself may serve as the current collector, or the separator(s) may serve as the current collector, in addition to fulfilling additional functions described herein with respect to the separator, such as physically, chemically, electrically, etc. segregating various components of the electrochemical cell from one another to avoid undesirable chemical reactions, physical phenomena, etc. as would be understood by a person having ordinary skill in the art upon reading the present disclosure. Again, the inventive concepts presented herein shall be understood as including, but not requiring, omission of distinct current collector components, according to various embodiments.

Accordingly, electrodes of the illustrative electrochemical cell implementations may be distinct structures, such as three dimensional monoliths, which may optionally be porous, have surface(s) thereof functionalized in order to enhance, suppress, or otherwise modify functional characteristics thereof (such as permeability, reactivity, etc. to select chemical species present within the electrochemical cell) without limitation. Electrodes may optionally or additionally include indeterminate structures, such as solutions that exhibit functional characteristics of monolithic electrode structures, but are present partially or wholly in the form of a solution. Further still, electrodes may be physically arranged in various configurations, such as thin films which may be sprayed or deposited on a suitable substrate; a one or more (flat) layers which may be sprayed or deposited on a suitable substrate or as free-standing structures; as a plurality of rows and/or channels (e.g., as may be formed in a suitable electrode material, or as may be formed as a result of stacking various layers of an electrochemical cell, rolling a multilayered electrochemical cell, etc.) as would be understood by those having ordinary skill in the art upon reading the present disclosure.

Optionally, electrodes may be coated with a protective layer designed to facilitate or mitigate predetermined chemical or physical interactions with other components of the electrochemical cell, such as reactions that consume electrode active material, form dendritic structures extending from the electrode, etc. as would be understood by those having ordinary skill in the art upon reading the present disclosure. In like manner, an electrode may include a plurality of particles (e.g. of active material) dispersed within or throughout the volume of a binder such as a polymer matrix, and the binder may be or include material(s) that facilitate or mitigate desired or undesired interactions within the electrochemical cell, respectively. In still more approaches, electrolyte(s) may be operatively, chemically, or electrically coupled to a membrane or membrane(s) configured (e.g., according to physical characteristics such as porosity, lack of porosity, spatial arrangement, surface area, etc., or chemically configured, e.g. according to chemical composition, specific functionalization (e.g., of surface(s) of the membrane), etc.) to isolate the electrolyte and/or chemical species formed or derived therefrom from other components of the electrochemical cell.

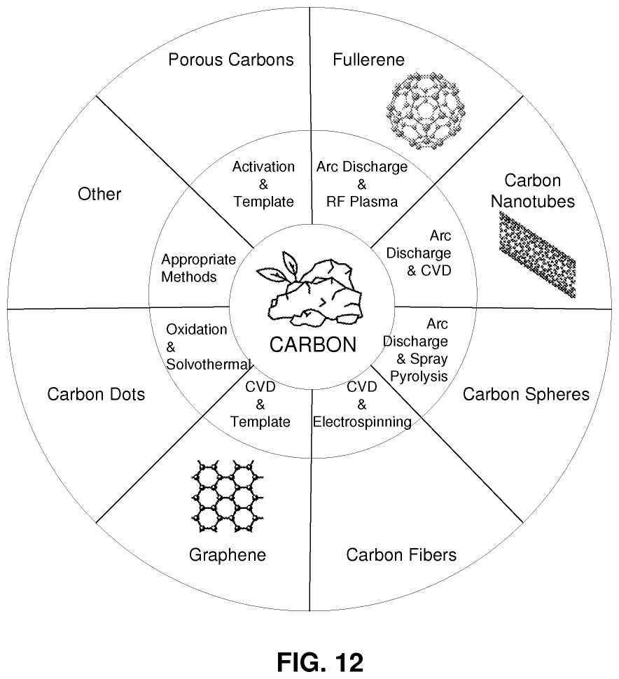

In particularly preferred approaches, electrodes may include one or more carbonaceous materials such as shown in FIG. 12 and described in greater detail hereinbelow.

It shall be appreciated that electrolytes in accordance with the presently disclosed inventive concepts may have any suitable chemical composition that would be understood by a person having ordinary skill in the art taking into consideration the particular context of the electrochemical cell, e.g., the chemical composition and structural arrangement of various other components included in the electrochemical cell.

Similarly, electrolyte(s) present in various electrochemical cells may be in liquid form, may be or include solid state electrolyte composition(s), may be or include gel-phase or gel-based electrolytes (such as gel polymer electrolytes), or any combination thereof that would be appreciated by those having ordinary skill in the art upon reading the present disclosure. Similarly, electrolytes may include semi-solid compositions such as gels, slurries, suspensions, etc. as would be appreciated by those having ordinary skill in the art upon reading the instant disclosure.

Separator(s), which may also be omitted in accordance with certain aspects of the inventive concepts described herein, may be or include any suitable composition or structure known in the art and which skilled artisans reading the present disclosure will appreciate are compatible with the inventive compositions and/or structures described herein. For instance, separator(s) may include impermeable, solid structures, semi-permeable membranes, selectively permeable compositions (i.e., compositions that are permeable to one or more predetermined chemical species, but impermeable or substantially impermeable to select, or all, other chemical species, according to various embodiments). For example, separators may be configured to physically, chemically, electrically, or otherwise functionally separate or segregate different components of the electrochemical cell from one another in order to avoid undesirable chemical reactions (such as parasitic reactions between electrolyte or derivatives thereof and electrodes, polysulfide shuttling, dendrite formation, etc. as would be understood by those having ordinary skill in the art upon reading the instant descriptions).

In addition, the exemplary electrochemical cells, in any configuration described herein or equivalents thereof that would be appreciated by those having ordinary skill in the art upon reading the instant disclosure, may include one or more mechanisms for mitigating or preventing polysulfide shuttling, dendrite formation, parasitic reactions between electrode(s) and electrolyte(s) (as well as species formed or derived from electrodes or electrolytes during operation of the electrochemical cell), or other chemical species present in the electrochemical cell environment. These mechanisms may be inherent to one or more of the exemplary structures described hereinabove (e.g., electrodes, separators, electrolytes, etc.), or may be specifically configured via specific modification, functionalization, structural arrangement, etc. of the particular components of the electrochemical cell. Any such characteristics, whether inherently present or specifically configured, are described in greater detail herein in accordance with various exemplary embodiments of the inventive concepts presently disclosed.

From the foregoing general descriptions and corresponding drawings, skilled artisans reviewing the present application will appreciate that, according to different implementations, electrochemical cells as described herein include a variety of components which each have a specific, core role in function of the electrochemical cell as a whole (e.g., electrodes facilitating electrical contact between electrolyte and an environment external to the electrochemical cell; separators serving to isolate or segregate various components, chemical species, etc. from one another within the electrochemical cell environment; and electrolyte facilitating charge transfer between electrodes of the electrochemical cell), the various components may optionally serve or convey one or more additional functions to the electrochemical cell. For instance, and as mentioned above, electrodes or separators may serve, in addition to their respective core roles, as current collectors, allowing omission of separate (often heavy, metal) structures dedicated to collecting current generated by the electrochemical cell.

In various aspects, any one or more component(s) of the electrochemical cell arrangements described herein may include one or more carbonaceous materials, including but not limited to those shown in FIG. 12. For example, certain components may include carbonaceous materials, carbonaceous materials may be included in addition to the various components shown and described with reference to FIGS. 8A-11, or both, as would be appreciated by those having ordinary skill in the art upon reading the present disclosures. In myriad embodiments, exemplary carbonaceous materials may include, without limitation, carbon black, carbon nano-onions (CNOs), necked CNOs, carbon nanospheres, graphite, pyrolytic graphite, graphene, graphene nanoparticles, graphene platelets, three-dimensional (3D) graphene, graphene oxides, fullerenes, hybrid fullerenes, single-walled nanotubes, multi-walled nanotubes, carbon dots, carbon spheres, porous carbons, carbon fibers, etc. as would be understood by skilled artisans upon reading the present descriptions. Additional details regarding the fabrication of select carbonaceous materials and characteristics thereof, particularly those shown in FIG. 12, are provided by Li, et al. “Synthesis, modification strategies and applications of coal-based materials”, Fuel Processing Tech., 230:1, 107203 (June 2022) (https://doi.org/10.1016/j.fuproc.2022.107203).

Moreover, the exemplary components of electrochemical cells described hereinabove, particularly as shown in FIGS. 8-11, may be present in a single cell “stack” (e.g., two opposing electrodes with corresponding separator, electrolyte, etc. arranged therebetween) or in a repeating (e.g., laminar) structure, according to various embodiments. A simplified repeating structure may, for example, include a first cathode (optionally coupled to a first cathode current collector) at one end of the electrochemical cell, which is immediately adjacent to a first electrolyte, which in turn is immediately adjacent to a first separator, which in turn is immediately adjacent to a second electrolyte, which in turn is immediately adjacent to a first anode (optionally coupled to a first anode current collector) positioned toward an opposing end of the electrochemical cell as the first cathode, collectively forming a single electrochemical cell layer. The repeating structure may further comprise additional electrolyte, separator, and electrode structures in a similar manner to form a multilayered, repeating pattern within the resulting electrochemical cell.

Whether including repeating structures or not, in various approaches, electrochemical cells may be manipulated, configured, arranged, etc. during fabrication of a larger structure (such as a battery). For instance, and as will be appreciated by those having ordinary skill in the art upon reviewing the inventive concepts described herein, in some approaches an electrochemical cell such as shown in FIG. 8B may be “rolled” around a central axis, forming a so-called “jelly roll” configuration, as shown in FIG. 8C according to one embodiment, which may be particularly suitable for certain arrangements or applications, such as for cylindrical or prismatic electrochemical cell embodiments, among others that skilled artisans will comprehend upon reviewing the present disclosure.

While the foregoing electrode, electrolyte, and separator components are the most common and critical aspects of the exemplary electrochemical cell as described herein, it shall be appreciated that according to various implementations electrochemical cells may, or may not, include any suitable combination or permutation of additional or alternative components, such as membranes, cans, caps, casings, wrappings, springs, wires, spacers, tabs, contacts, leads, gaskets, compressive structures or mechanisms, etc. as would be understood by a person having ordinary skill in the art upon reading the present descriptions.

Moreover, it shall be appreciated that persons having ordinary skill in the art may employ the various electrochemical cell embodiments described herein, including but not limited to coin cell arrangements, cylindrical cell arrangements, pouch cell arrangements, prismatic cell arrangements, etc. or any suitable equivalent(s) thereof that would be understood by said skilled artisan upon reading the present disclosure, in any effective permutation or combination, without departing from the scope of the inventive concepts in this disclosure. For instance, multiple of the same arrangements, combinations of different arrangements, or both, may be employed, e.g., to form a battery, or an assembly (e.g., a battery module, or a battery pack, etc. as would be understood by persons having ordinary skill in the art upon reading the present disclosure).

For example, those having ordinary skill in the art will appreciate that different arrangements described herein may have different advantages or disadvantages in the context of different applications, and may choose to employ the most advantageous arrangements of the particular application of interest. Additionally or alternatively, a skilled artisan may include different arrangements to provide robustness across different applications or working conditions to the resulting structure, providing flexibility of use, redundant failure points, or other advantage that would be understood by those having ordinary skill in the art in light of the particular application in mind.

As a concrete example, cylindrical cells are, relative to other arrangements described herein, are prone to cracking. Accordingly, a cylindrical cell arrangement such as shown in FIGS. 10A and 10B may not be applicable to or compatible with a prismatic cell configuration such as shown in FIG. 11, depending on the intended application for a given electrochemical cell, such as applications involving substantial and/or frequent application of mechanical forces (e.g. rapid acceleration/deceleration, vibration, etc. such as often experienced in vehicular applications. Similarly, pouch cell arrangements are particularly sensitive to volumetric expansion and contraction that occurs during natural operation and cycling of the electrochemical cell, and may require or benefit from additional support such as a compressive structure or internal mechanism (e.g. a polymeric support network such as described in U.S. Pat. No. 12,009,531, granted Jun. 11, 2024 and entitled “Internally enclosed support system for batteries, fabrication techniques and applications for the same”, the contents of which are herein incorporated by reference).

Moreover, while exemplary electrochemical cell arrangements expressly described herein and shown in the various Figures include a pouch cell arrangement, a coin cell arrangement, a cylindrical cell arrangement, and a prismatic cell arrangement, other arrangements and/or components may be utilized without departing from the scope of the inventive concepts presented in this disclosure. For example, electrochemical cell arrangements may additionally or alternatively include components or be characterized by arrangements such as chassis, trays, packs, modules, assemblies, casings, etc. as would be understood by those having ordinary skill in the art upon reading the present disclosure.

Of course, the electrochemical cells described herein, according to various embodiments, may include external component(s) at least partially surrounding the electrochemical cell. For instance, exemplary external components may be selected from the group consisting of an external casing enclosing the electrochemical cell, a module operatively coupled to the electrochemical cell, an assembly operatively coupled to the electrochemical cell, a pack enclosing the electrochemical cell, a pouch enclosing the electrochemical cell, a can enclosing the electrochemical cell, a tray operatively coupled to the electrochemical cell, a pan operatively coupled to the electrochemical cell, and combinations thereof. The assembly may comprise: a parallel assembly, an in-series assembly, or a cell-to-chassis assembly. In still further embodiments, an electrochemical cell may be integrated into, or may be a part of, a structural component of the device to which the electrochemical cell is providing power, such as being integrated into a structural component of an electric vehicle.

The presently described inventive concepts include fabricating electrochemical cells of various types using additive manufacturing techniques, injection molding techniques, compression molding techniques, hybrid injection/compression molding techniques, preforming techniques, hand layup techniques, casting techniques, infusion techniques, sintering techniques, or any combination thereof that would be appreciated by a skilled artisan upon reading the present disclosure.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

For instance, in accordance with one implementation, the inventive concepts presented herein include one or more of the following compounds, features, configurations, etc., in any suitable combination or permutation that would be understood by a person having ordinary skill in the art upon reading the present disclosures: an electrolyte system comprising: at least one solvent; at least one electron withdrawing compound; at least one performance enhancing additive; and at least one lithium ion-transporting compound. The at least one solvent may include at least one ether, and preferably is selected from the group consisting of: dimethoxyethane (DME), dioxolane (DOL), dimethyl sulfoxide (DMSO), dimethyl formamide (DMF), toluene, tetramethyl urea (TMU), tetrabutylammonium hydroxide (TBA), dimethylacetamide (DMA), tetrahydrofuran (THF), diethylene glycol dimethyl ether (diglyme or DEGDME), acetonitrile (ACN), dimethyl trisulfide (DMTS), diisopropyl ether (DIPE), tetrahydrofuran (THF), 1,2-diaminopropane (DAP), triethylene glycol dimethyl ether (Triglyme/trigDME), tetraethylene glycol dimethyl ether (Tetraglyme/TEGDME), sulfolane (SUL), methyl tert-butyl ether (MTBE), 2,2,3,3-tetrafluoro-1,4-dimethoxybutane (FDMB), bis(2,2,2, trifluoroethyl) ether (BTFE), 1H,1H,5H-octafluoropentyl 1,1,2,2-tetrafluoroethyl ether (OFE), (1,1,2,2-tetrafluoroethyl 2,2,3,3-tetrafluoropropyl ether (TTE), 2,2,2-trifluoroethyl 1,1,2,2-tetrafluoroethyl ether (TFETFE), 1,1,2,2-tetrafluoroethyl isobutyl ether (TFEIE), 1,1,2,3,3,3-hexafluoropropyl 2,2,2-trifluoroethyl ether (THE), methoxyperfluorobutane (MPB), bis(2,2-difluoroethyl) ether (DFE), 2,2,2-trifluoroethyl methyl ether (TFEME), bis(2-fluoroethyl) ether (BFE), bis(2,2,2, trifluoroethyl) ether (BTFE), 3-fluoropyridine (3FP), 1,2-(1,1,2,2-tetrafluoroethoxy) ethane (TFEE), 1,2-dimethoxy-1,1,2,2-tetrafluoroethane (DMETF), 2-methyl-1(1,1,2,2-tetrafluoroethoxy) propane (TFEIBE), bis(2,2,3,3,3-pentafluoropropyl) ether (BPFPE), allyl 2,2,3,3,3-pentafluoropropyl ether (APFPE), hydrocarbons, and combinations thereof. The at least one solvent is cumulatively present in an amount ranging from greater than 0 vol % of the electrolyte system to about 75 vol % of the electrolyte system. Moreover, the at least one electron withdrawing group comprises at least one compound characterized by an alpha-hydrogenated, beta-functionalized motif, and preferably includes at least one electron withdrawing compound is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. The at least one electron withdrawing compound is cumulatively present in an amount preferably ranging from greater than 0 vol % of the electrolyte system to about 75 vol % of the electrolyte system. The at least one performance-enhancing additive comprises dicyandiamide (DCDA), and is present in an amount ranging from about 0.01 M to about 0.2 M. The at least one lithium ion-transporting compound comprises at least one lithium salt, and preferably is selected from the group consisting of: lithium bis(trifluoromethanesulfonyl)imide (LiTFSI), lithium nitrate (LiNO₃), lithium Perchlorate (LiClO₄), lithium difluoro(oxalato)borate (LiFOB), lithium bis (oxalato)borate (LiBOB), lithium trifilate (LiTf, lithium bis(pentafluoroethanesulfonyl)imide (LiBETi), lithium bis(fluorosulfonyl)imide (LiFSI), lithium trifluoroacetate (LiTFAc), and combinations thereof. The lithium ion-transporting compound is present in an amount ranging from about 0.1 M to about 10 M. Moreover, the electrolyte system may include at least one chalcogenide, which is preferably selected from the group consisting of: dimethyl diselenide (DMDSe), dipheyl diselenide (DPDSe), dimethyl ditelluride (DMDTe), diphenyl ditelluride (DPDTe), and combination(s) thereof, and is preferably present in an amount ranging from about 0.1 wt % to about 3.0 wt %. The inventive electrolyte system may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

According to another implementation, the inventive concepts presented herein include one or more of the following compounds, features, configurations, etc., in any suitable combination or permutation that would be understood by a person having ordinary skill in the art upon reading the present disclosures: an electrolyte system comprising: a solvent system; at least one electron withdrawing compound; and at least one lithium ion-transporting compound. The solvent system includes at least one solvent, which preferably is selected from the group consisting of: dimethoxyethane (DME), dioxolane (DOL), dimethyl sulfoxide (DMSO), dimethyl formamide (DMF), toluene, tetramethyl urea (TMU), tetrabutylammonium hydroxide (TBA), dimethylacetamide (DMA), tetrahydrofuran (THF), diethylene glycol dimethyl ether (diglyme or DEGDME), acetonitrile (ACN), dimethyl trisulfide (DMTS), diisopropyl ether (DIPE), tetrahydrofuran (THF), 1,2-diaminopropane (DAP), triethylene glycol dimethyl ether (Triglyme/trigDME), tetraethylene glycol dimethyl ether (Tetraglyme/TEGDME), sulfolane (SUL), methyl tert-butyl ether (MTBE), 2,2,3,3-tetrafluoro-1,4-dimethoxybutane (FDMB), bis(2,2,2, trifluoroethyl) ether (BTFE), 1H,1H,5H-octafluoropentyl 1,1,2,2-tetrafluoroethyl ether (OFE), (1,1,2,2-tetrafluoroethyl 2,2,3,3-tetrafluoropropyl ether (TTE), 2,2,2-trifluoroethyl 1,1,2,2-tetrafluoroethyl ether (TFETFE), 1,1,2,2-tetrafluoroethyl isobutyl ether (TFEIE), 1,1,2,3,3,3-hexafluoropropyl 2,2,2-trifluoroethyl ether (THE), methoxyperfluorobutane (MPB), bis(2,2-difluoroethyl) ether (DFE), 2,2,2-trifluoroethyl methyl ether (TFEME), bis(2-fluoroethyl) ether (BFE), bis(2,2,2, trifluoroethyl) ether (BTFE), 3-fluoropyridine (3FP), 1,2-(1,1,2,2-tetrafluoroethoxy) ethane (TFEE), 1,2-dimethoxy-1,1,2,2-tetrafluoroethane (DMETF), 2-methyl-1(1,1,2,2-tetrafluoroethoxy) propane (TFEIBE), bis(2,2,3,3,3-pentafluoropropyl) ether (BPFPE), allyl 2,2,3,3,3-pentafluoropropyl ether (APFPE), hydrocarbons, and combinations thereof. The solvent system comprises greater than 0 vol % of the electrolyte system to about 75 vol % of the electrolyte system. Moreover, the at least one electron withdrawing group comprises at least one compound characterized by an alpha-hydrogenated, beta-functionalized motif, and preferably includes at least one electron withdrawing compound is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. The at least one electron withdrawing compound is cumulatively present in an amount preferably ranging from greater than 0 vol % of the electrolyte system to about 75 vol % of the electrolyte system. The at least one electron withdrawing compound comprises at least one alpha-hydrogenated, selectively beta-modified motif, and the at least one alpha-hydrogenated, selectively beta-modified motif excludes fluorine. In other aspects, the at least one electron withdrawing compound excludes fluorine. The at least one lithium ion-transporting compound comprises at least one lithium salt, and preferably is selected from the group consisting of: lithium bis(trifluoromethanesulfonyl)imide (LiTFSI), lithium nitrate (LiNO₃), lithium Perchlorate (LiClO₄), lithium difluoro(oxalato)borate (LiFOB), lithium bis (oxalato)borate (LiBOB), lithium trifilate (LiTf), lithium bis(pentafluoroethanesulfonyl)imide (LiBETi), lithium bis(fluorosulfonyl)imide (LiFSI), lithium trifluoroacetate (LiTFAc), and combinations thereof. The at least one lithium ion-transporting compound is present in an amount ranging from about 0.1 M to about 10 M. The inventive electrolyte system may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

In still yet more implementations, a lithium-based anode includes one or more of the following compounds, features, configurations, etc., in any suitable combination or permutation that would be understood by a person having ordinary skill in the art upon reading the present disclosures: an interphase formed on surface(s) of the lithium-based anode, wherein the interphase is formed by interaction between an active material of the lithium-based anode and a derivative of at least one electron withdrawing compound. The at least one electron withdrawing compound preferably comprises at least one alpha-hydrogenated, selectively beta-modified motif, where the at least one alpha-hydrogenated, selectively beta-modified motif excludes fluorine and/or the at least one electron withdrawing compound excludes fluorine as a whole. Preferably, the at least one electron withdrawing compound is includes at least one electron withdrawing compound that is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. An active material of the lithium-based anode preferably comprises elemental lithium or a lithium alloy, where the lithium alloy comprises lithium-magnesium, lithium-sulfur, or a combination thereof. The inventive anode may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

In still yet more implementations, a electrolyte system includes one or more of the following compounds, features, configurations, etc., in any suitable combination or permutation that would be understood by a person having ordinary skill in the art upon reading the present disclosures: a solvent system; at least one electron withdrawing compound; at least one lithium ion-transporting compound; and at least one chalcogenide. The solvent system includes at least one solvent, which preferably is selected from the group consisting of: dimethoxyethane (DME), dioxolane (DOL), dimethyl sulfoxide (DMSO), dimethyl formamide (DMF), toluene, tetramethyl urea (TMU), tetrabutylammonium hydroxide (TBA), dimethylacetamide (DMA), tetrahydrofuran (THF), diethylene glycol dimethyl ether (diglyme or DEGDME), acetonitrile (ACN), dimethyl trisulfide (DMTS), diisopropyl ether (DIPE), tetrahydrofuran (THF), 1,2-diaminopropane (DAP), triethylene glycol dimethyl ether (Triglyme/trigDME), tetraethylene glycol dimethyl ether (Tetraglyme/TEGDME), sulfolane (SUL), methyl tert-butyl ether (MTBE), 2,2,3,3-tetrafluoro-1,4-dimethoxybutane (FDMB), bis(2,2,2, trifluoroethyl) ether (BTFE), 1H,1H,5H-octafluoropentyl 1,1,2,2-tetrafluoroethyl ether (OFE), (1,1,2,2-tetrafluoroethyl 2,2,3,3-tetrafluoropropyl ether (TTE), 2,2,2-trifluoroethyl 1,1,2,2-tetrafluoroethyl ether (TFETFE), 1,1,2,2-tetrafluoroethyl isobutyl ether (TFEIE), 1,1,2,3,3,3-hexafluoropropyl 2,2,2-trifluoroethyl ether (THE), methoxyperfluorobutane (MPB), bis(2,2-difluoroethyl) ether (DFE), 2,2,2-trifluoroethyl methyl ether (TFEME), bis(2-fluoroethyl) ether (BFE), bis(2,2,2, trifluoroethyl) ether (BTFE), 3-fluoropyridine (3FP), 1,2-(1,1,2,2-tetrafluoroethoxy) ethane (TFEE), 1,2-dimethoxy-1,1,2,2-tetrafluoroethane (DMETF), 2-methyl-1(1,1,2,2-tetrafluoroethoxy) propane (TFEIBE), bis(2,2,3,3,3-pentafluoropropyl) ether (BPFPE), allyl 2,2,3,3,3-pentafluoropropyl ether (APFPE), hydrocarbons, and combinations thereof. The solvent system comprises greater than 0 vol % of the electrolyte system to about 75 vol % of the electrolyte system. Moreover, the at least one electron withdrawing group comprises at least one compound characterized by an alpha-hydrogenated, beta-functionalized motif, and preferably includes at least one electron withdrawing compound is selected from the group consisting of: 2,2-dimethoxy-4-trifluoromethyl-1,3-dioxolane ether (DTDL), 1,1,1-trifluoro-2-(2-(2-(2,2,2-trifluoroethoxy)ethoxy) ethoxy)ethane (FDG), 1,1,1,14,14,14-hexafluoro-3,6,9,12-tetraoxatetradecane (FTrG), 1,1,1,17,17,17-hexafluoro-3,6,9,12,15-pentaoxaheptadecane (FTeG), bis(2,2-difluoroethyl) ether (BDE), bis(2,2,2, trifluoroethyl) ether (BTFE), 2,2,2-trifluoroethyl 2-fluoroethyl ether (TFFE), 1,1-difluoroethyl-2-fluoroethyl ether (DFE), fluorinated 1,4-dimethoxylbutane (FDMB), 3-fluoropyridine (3FP), 1,1,2,2-tetrafluoroethyl 2,2,3,3-tetrafluororopyl ether (TTE), bis(2,2,3,3-tetrafluoropropyl)ether) (BTFPE), 2,2,2-trifluoroethyl 1,1,2,2-tetrafluoroethyl ether (TFTFE), tris(2,2,2-trifluoroethyl) phosphate, bis(2,2,2-trifluoroethyl) methylphosphonate, isosorbide dinitrate (ISDN), bis(2-fluoroethyl) ether (BFE), and combinations thereof. The at least one electron withdrawing compound is cumulatively present in an amount preferably ranging from greater than 0 vol % of the electrolyte system to about 75 vol % of the electrolyte system. The at least one electron withdrawing compound comprises at least one alpha-hydrogenated, selectively beta-modified motif, and the at least one alpha-hydrogenated, selectively beta-modified motif excludes fluorine. In other aspects, the at least one electron withdrawing compound excludes fluorine. The at least one lithium ion-transporting compound comprises at least one lithium salt, and preferably is selected from the group consisting of: lithium bis(trifluoromethanesulfonyl)imide (LiTFSI), lithium nitrate (LiNO₃), lithium Perchlorate (LiClO₄), lithium difluoro(oxalato)borate (LiFOB), lithium bis (oxalato)borate (LiBOB), lithium trifilate (LiTf), lithium bis(pentafluoroethanesulfonyl)imide (LiBETi), lithium bis(fluorosulfonyl)imide (LiFSI), lithium trifluoroacetate (LiTFAc), and combinations thereof. The lithium ion-transporting compound is present in an amount ranging from about 0.1 M to about 10 M. The at least one chalcogenide is selected from the group consisting of: dimethyl diselenide (DMDSe), dipheyl diselenide (DPDSe), dimethyl ditelluride (DMDTe), diphenyl ditelluride (DPDTe), and combination(s) thereof, and is preferably present in an amount ranging from about 0.1 wt % to about 3.0 wt %. The inventive electrolyte system may be embodied in an electrochemical cell, which may have a configuration such as described herein, including a pouch configuration, a coin configuration, a cylindrical configuration, or a prismatic configuration. Said electrochemical cells may or may not include a distinct structure serving as a current collector.

### Phenyl-Based Chalcogenide Redox Mediators Embodiments

The present disclosure relates to the field of lithium-sulfur battery technology, and more particularly to electrolyte systems incorporating phenyl-based chalcogenide compounds as redox mediators to enhance electrochemical performance. Lithium-sulfur batteries represent a promising energy storage technology due to their high theoretical specific capacity of approximately 1675 mAh/g and the natural abundance of sulfur as a cathode material, making them attractive candidates for applications requiring high energy density such as electric vehicles and unmanned aerial systems.

Despite their theoretical advantages, lithium-sulfur batteries face substantial practical limitations that have hindered their widespread commercial adoption. During discharge, the sluggish reaction kinetics of lithium polysulfides and the accumulation of inactive Li2S on the cathode surface limit the practically achievable capacity. The insulating nature of Li2S creates a barrier to electron transfer, particularly for Li2S particles that are not in direct contact with conductive surfaces, rendering portions of the active material electrochemically inaccessible. Prior approaches including catalysis and electrolyte tuning have attempted to address these kinetic limitations, but have not fully resolved the underlying problems associated with polysulfide conversion and Li2S utilization.

The present disclosure addresses these challenges through the employment of phenyl-based chalcogenide compounds, including Diphenyl sulfide (Ph2S), Diphenyl diselenide (Ph2Se2), and Diphenyl ditelluride (Ph2Te2), as redox mediators in lithium-sulfur battery electrolyte systems. These redox mediators possess redox potentials close to the Li—S redox potential of approximately 2.15V, enabling them to undergo reduction at the cathode surface and subsequently diffuse through the electrolyte to mediate electron transfer to lithium polysulfides and isolated Li2S particles that are not in direct contact with the current collector. This mechanism facilitates the conversion of lithium polysulfides to Li2S, thereby improving reaction kinetics and increasing active material utilization.

The present disclosure further provides that Diphenyl ditelluride (Ph2Te2) demonstrates superior performance among the tested mediators, increasing cell capacity (such as but not limited to around 15%, etc.) across various C-rates ranging from 0.1 C to 1 C. The redox mediators may be incorporated either as electrolyte additives at concentrations between about 0.10 M and 0.30 M, or directly into the cathode during fabrication, providing flexibility in implementation. The solvent system may comprise ether-based solvents such as 1,3-dioxolane (DOL) and 1,2-dimethoxyethane (DME), with lithium bis(trifluoromethanesulfonyl)imide (LiTFSI), lithium bis(fluorosulfonyl)imide (LiFSI), and/or lithium perchlorate (LiClO4), serving as the lithium ion-transporting compound, and the redox mediators remain electrochemically active across multiple charge-discharge cycles while maintaining capacity enhancement across a range of practical operating conditions.

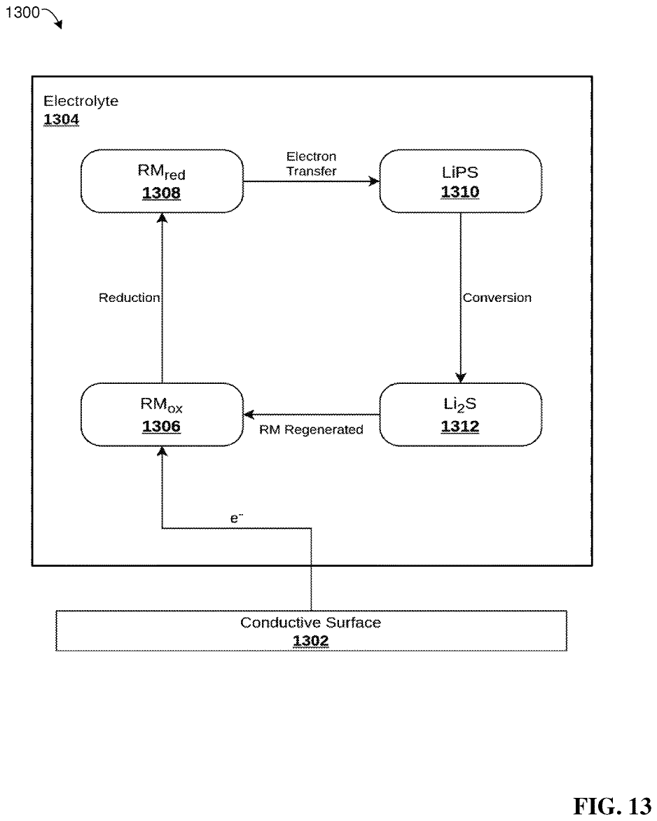

FIG. 13 illustrates a redox mediator system 1300, in accordance with one embodiment. As an option, the redox mediator system 1300 may be implemented in the context of any one or more of the embodiments set forth in any previous and/or subsequent Figures and/or description thereof. Of course, however, the redox mediator system 1300 may be implemented in the context of any desired environment. Further, the aforementioned definitions may equally apply to the description below.

As shown, the redox mediator system 1300 includes a conductive surface 1302 which may comprise a cathode surface or current collector that serves as an electron source during discharge of a lithium-sulfur battery. In one embodiment, the conductive surface 1302 provides electrons to redox mediator species within the redox mediator system 1300, thereby initiating the electron transfer cascade that facilitates polysulfide conversion. The conductive surface 1302 may comprise carbon-based materials, metallic foils, or other electrically conductive substrates suitable for use in lithium-sulfur battery cathodes.

The redox mediator system 1300 further includes an electrolyte 1304 may comprise a solvent system and at least one lithium ion-transporting compound, as described previously. In one embodiment, the electrolyte 1304 may contain at least one redox mediator comprising a phenyl-based chalcogenide compound selected from the group consisting of Diphenyl sulfide (Ph2S), Diphenyl diselenide (Ph2Se2), and Diphenyl ditelluride (Ph2Te2). The redox mediator may be soluble in the solvent system, enabling the redox mediator to diffuse freely throughout the electrolyte 1304 and access lithium polysulfide species that are not in direct contact with the conductive surface 1302.

An oxidized redox mediator 1306 within the electrolyte 1304 represents the phenyl-based chalcogenide compound in its oxidized state prior to receiving electrons from the conductive surface 1302. In one embodiment, the oxidized redox mediator 1306 has a redox potential between about 2.0V and 2.3V vs. Li/Li+, which corresponds closely to the Li—S redox potential of approximately 2.15V. This proximity in redox potentials enables the oxidized redox mediator 1306 to undergo reduction at potentials relevant to lithium polysulfide conversion, thereby facilitating electron transfer within the electrochemical window of the lithium-sulfur battery.

The redox mediator system 1300 includes a reduced redox mediator 1308 that represents a phenyl-based chalcogenide compound after undergoing reduction at the conductive surface 1302. As shown in FIG. 13, the redox mediator undergoes reduction to form a reduced species that diffuses through the solvent system to reduce lithium polysulfides. The reduced redox mediator 1308 carries electrons from the conductive surface 1302 into the bulk of the electrolyte 1304, where the reduced redox mediator 1308 may contact and reduce lithium polysulfide species. In this manner, the redox mediator acts as an electron transfer agent between a conductive cathode surface and lithium polysulfides.

A lithium polysulfide 1310 represents intermediate sulfur species (Li2Sx, where x>2) formed during discharge of the lithium-sulfur battery. In one embodiment, the reduced species of the redox mediator diffuses through the solvent system to contact lithium polysulfides not in direct contact with a current collector. This diffusion-mediated electron transfer enables the reduced redox mediator 1308 to reach lithium polysulfide 1310 species that would otherwise remain electrochemically inaccessible due to their physical separation from the conductive surface 1302.

The redox mediator system 1300 further includes a lithium sulfide 1312, which represents the final discharge product formed upon complete reduction of the lithium polysulfide 1310. As shown in FIG. 13, the redox mediator facilitates conversion of lithium polysulfides to Li2S. The conversion of lithium polysulfide 1310 to lithium sulfide 1312 proceeds through electron transfer from the reduced redox mediator 1308 to the lithium polysulfide 1310. Upon transferring electrons to the lithium polysulfide 1310, the reduced redox mediator 1308 becomes oxidized and regenerates back to the oxidized redox mediator 1306, as indicated by the regeneration pathway shown in FIG. 13.

With continued reference to FIG. 13, the cyclic regeneration process enables continuous electron shuttling between the conductive surface 1302 and the lithium polysulfide 1310 species throughout the discharge process. The oxidized redox mediator 1306 receives electrons at the conductive surface 1302 to form the reduced redox mediator 1308, which then diffuses through the electrolyte 1304 to reduce the lithium polysulfide 1310 to lithium sulfide 1312. Upon electron transfer, the reduced redox mediator 1308 regenerates to the oxidized redox mediator 1306, which may then return to the conductive surface 1302 to repeat the cycle. This cyclic mechanism enables the redox mediator to transfer multiple electrons per molecule over the course of battery operation.

The electron transfer mechanism illustrated in FIG. 13 addresses the problem of sluggish reaction kinetics in lithium-sulfur batteries. The redox mediator reduces accumulation of inactive Li2S on a cathode during discharge and improves reaction kinetics of lithium polysulfide conversion. By providing an alternative electron transfer pathway through the electrolyte 1304, the redox mediator system 1300 enables conversion of lithium polysulfide 1310 species that are physically separated from the conductive surface 1302. Additionally, the redox mediator increases active material utilization by facilitating electron transfer to isolated Li2S particles, thereby enabling the lithium-sulfur battery to approach its theoretical capacity of approximately 1675 mAh/g.

The redox mediator system 1300 exemplifies a resolution to the prior art problem of limited polysulfide conversion in lithium-sulfur batteries. Prior approaches relied on direct electron transfer from the cathode surface to lithium polysulfides, which limited conversion to species in physical contact with conductive surfaces. The redox mediator system 1300 overcomes this limitation by employing soluble phenyl-based chalcogenide compounds that diffuse through the electrolyte 1304 to mediate electron transfer to remote lithium polysulfide 1310 species.

The redox mediator system 1300 further addresses the accumulation of insulating Li2S on the cathode surface that progressively passivates the electrode during discharge. By facilitating conversion of lithium polysulfides throughout the electrolyte 1304 rather than solely at the conductive surface 1302, the redox mediator system 1300 distributes the formation of lithium sulfide 1312 more uniformly and reduces localized passivation. This distributed conversion mechanism maintains electrochemical accessibility of the cathode surface throughout discharge.

In various embodiments, the redox mediator system 1300 may be modified to incorporate different phenyl-based chalcogenide compounds depending on the desired electrochemical characteristics. For example, Diphenyl ditelluride (Ph2Te2) may be employed when enhanced capacity improvement is desired, while Diphenyl sulfide (Ph2S) or Diphenyl diselenide (Ph2Se2) may be employed in applications where different redox potential matching or solubility characteristics are preferred. The selection of the phenyl-based chalcogenide compound may be tailored to the specific solvent system and operating conditions of the lithium-sulfur battery.

In various embodiments, the concentration of the redox mediator within the electrolyte 1304 may be adjusted to optimize the electron transfer kinetics and capacity enhancement. Higher concentrations of the redox mediator may increase the rate of electron shuttling between the conductive surface 1302 and the lithium polysulfide 1310 species, while lower concentrations may be employed to minimize any potential side reactions or viscosity effects. The redox mediator concentration may be selected based on the specific cell design, discharge rate requirements, and/or desired capacity enhancement.

In various embodiments, the redox mediator system 1300 may be combined with other cathode modifications or electrolyte additives to further enhance lithium-sulfur battery performance. For example, the phenyl-based chalcogenide redox mediator may be employed in conjunction with carbon-based conductive additives in the cathode, sulfur host materials, and/or lithium nitrate additives in the electrolyte. The redox mediator system 1300 may also be implemented in various cell formats including coin cells and/or pouch cells, with the electron transfer mechanism operating analogously across different form factors.

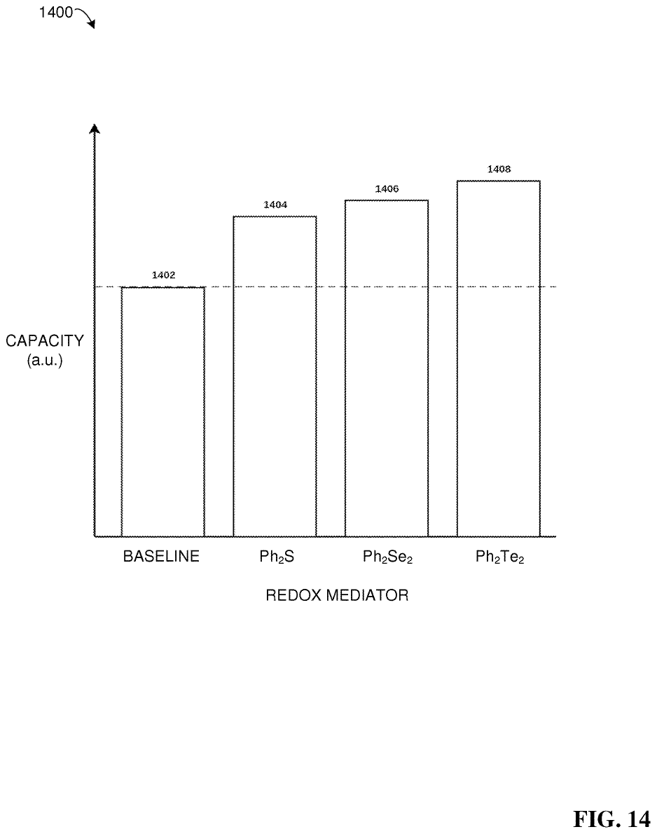

FIG. 14 illustrates a bar chart 1400 showing cell capacity enhancement with different chalcogenide redox mediators versus a baseline, in accordance with one embodiment. As an option, the bar chart 1400 may be implemented in the context of any one or more of the embodiments set forth in any previous and/or subsequent Figures and/or description thereof. Of course, however, the bar chart 1400 may be implemented in the context of any desired environment. Further, the aforementioned definitions may equally apply to the description below.

As shown, the bar chart 1400 includes a baseline capacity bar 1402 representing the capacity of a lithium-sulfur cell without any redox mediator additive. The baseline capacity bar 1402 establishes a reference point against which the capacity improvements achieved by the phenyl-based chalcogenide redox mediators may be compared. In one embodiment, the baseline capacity bar 1402 corresponds to a lithium-sulfur battery employing an electrolyte system comprising a solvent system and a lithium ion-transporting compound, where the lithium ion-transporting compound comprises a lithium salt such as lithium bis(trifluoromethanesulfonyl)imide (LiTFSI), as described previously. The baseline capacity bar 1402 reflects the capacity limitations arising from sluggish reaction kinetics of lithium polysulfides and accumulation of inactive Li2S on the cathode surface in the absence of redox mediator additives.

The bar chart 1400 further includes a Ph2S capacity bar 1404 showing the capacity when Diphenyl sulfide (Ph2S) is used as the redox mediator. The Ph2S capacity bar 1404 demonstrates an increase over the baseline capacity bar 1402, indicating that the phenyl-based chalcogenide compound comprising Diphenyl sulfide (Ph2S) provides capacity enhancement relative to the baseline condition. In one embodiment, the Diphenyl sulfide undergoes reduction at the conductive surface 1302 to form a reduced sulfide species that diffuses through the electrolyte 1304 to mediate electron transfer to the lithium polysulfide 1310 species. The capacity improvement shown by the Ph2S capacity bar 1404 reflects the enhanced conversion of lithium polysulfides to lithium sulfide 1312 facilitated by the Diphenyl sulfide redox mediator.

With continued reference to FIG. 14, a Ph2Se2 capacity bar 1406 illustrates the capacity achieved with Diphenyl diselenide (Ph2Se2) as the redox mediator. The Ph2Se2 capacity bar 1406 shows further improvement compared to both the baseline capacity bar 1402 and the Ph2S capacity bar 1404. In one embodiment, the phenyl-based chalcogenide compound comprises Diphenyl diselenide (Ph2Se2), which undergoes reduction at the cathode surface to form a reduced selenide species that mediates electron transfer to lithium polysulfides. The enhanced capacity demonstrated by the Ph2Se2 capacity bar 1406 may be attributed to the electrochemical properties of the diselenide bond and the redox potential of Diphenyl diselenide relative to the Li—S redox potential of approximately 2.15V.

The bar chart 1400 includes a Ph2Te2 capacity bar 1408 representing the capacity when Diphenyl ditelluride (Ph2Te2) is employed as the redox mediator. The Ph2Te2 capacity bar 1408 exhibits the highest capacity among all the tested redox mediators, demonstrating that the phenyl-based chalcogenide compound comprising Diphenyl ditelluride (Ph2Te2) provides the greatest capacity enhancement. As shown in FIG. 14, a dashed horizontal line extends across the bar chart 1400 at the level of the baseline capacity bar 1402 to facilitate comparison of the capacity improvements achieved by each redox mediator.

In one embodiment, each of the phenyl-based chalcogenide compounds undergoes reduction at the cathode surface to form a respective reduced chalcogenide species—a reduced sulfide species from Diphenyl sulfide, a reduced selenide species from Diphenyl diselenide, and a reduced telluride species from Diphenyl ditelluride. Each reduced species diffuses through the electrolyte 1304 to contact the lithium polysulfide 1310 species and facilitate conversion to lithium sulfide 1312. Upon electron transfer, each reduced species regenerates to the oxidized redox mediator 1306, enabling continuous electron shuttling. As demonstrated by the Ph2S capacity bar 1404, the Ph2Se2 capacity bar 1406, and the Ph2Te2 capacity bar 1408, each compound provides capacity enhancement over the baseline capacity bar 1402.

The comparative data presented in the bar chart 1400 demonstrates that all three phenyl-based chalcogenide compounds improve capacity relative to the baseline, with increasing enhancement progressing from Diphenyl sulfide to Diphenyl diselenide to Diphenyl ditelluride corresponding to the progression down the chalcogen group from sulfur to selenium to tellurium. Each compound exhibits redox potentials and electron transfer kinetics suited to mediating lithium polysulfide conversion, with the identity of the chalcogen element influencing the degree of capacity enhancement achieved.

In various embodiments, the selection of the phenyl-based chalcogenide compound may be tailored based on the desired capacity enhancement and/or other performance characteristics. Each of Diphenyl sulfide, Diphenyl diselenide, and Diphenyl ditelluride may be selected based on the specific electrochemical requirements, solubility characteristics, and/or performance targets of the lithium-sulfur battery application, with each compound providing improvement over the baseline capacity bar 1402 as shown by the Ph2S capacity bar 1404, the Ph2Se2 capacity bar 1406, and the Ph2Te2 capacity bar 1408.

In various embodiments, combinations of the phenyl-based chalcogenide compounds may be employed within the electrolyte system to achieve intermediate capacity enhancement characteristics and/or to leverage complementary electrochemical properties. The electrolyte system may comprise Diphenyl sulfide, Diphenyl diselenide, and/or Diphenyl ditelluride in various ratios depending on the specific performance requirements of the lithium-sulfur battery application.

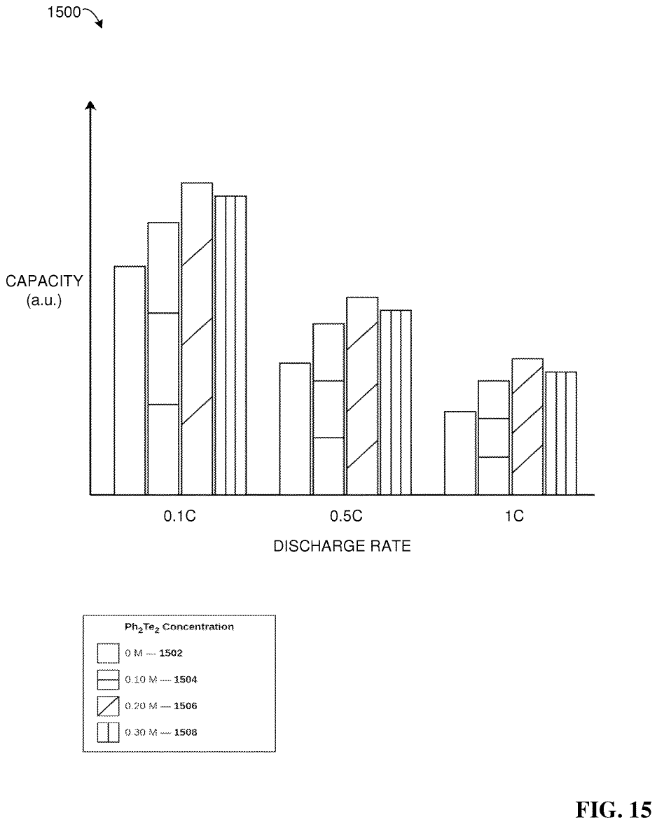

FIG. 15 illustrates a concentration dependency graph 1500 showing the relationship between Ph2Te2 concentration and cell capacity at various discharge rates, in accordance with one embodiment. As an option, the concentration dependency graph 1500 may be implemented in the context of any one or more of the embodiments set forth in any previous and/or subsequent Figures and/or description thereof. Of course, however, the concentration dependency graph 1500 may be implemented in the context of any desired environment. Further, the aforementioned definitions may equally apply to the description below.

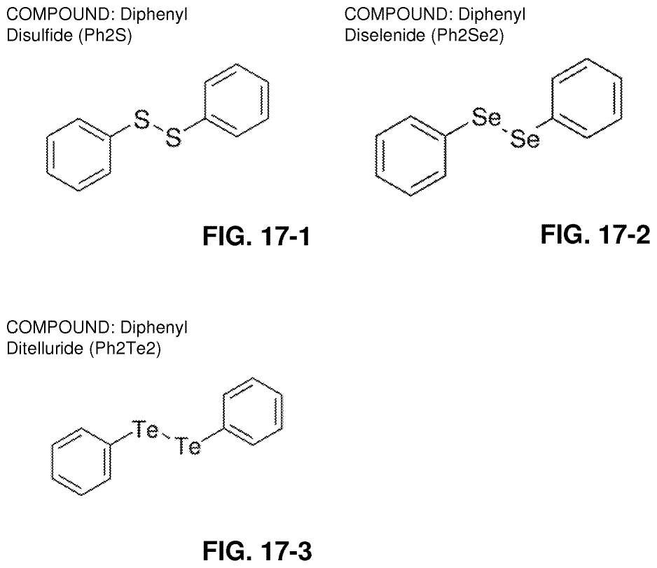

As shown, the concentration dependency graph 1500 displays capacity in arbitrary units (a.u.) on the vertical axis and discharge rate on the horizontal axis, with three discharge rate conditions shown: 0.1 C, 0.5 C, and 1 C. At each discharge rate, four bars represent different Ph2Te2 concentrations within the electrolyte system. The concentration dependency graph 1500 demonstrates that the electrolyte system maintains capacity enhancement across discharge rates ranging from 0.1 C to 1 C. It is to be appreciated that although the discharge rates are shown exclusively with respect to Ph2Te2, other compounds (such as those shown in FIG. 17) may additional be used, with similar capacity achieved.

The concentration dependency graph 1500 includes a 0 M concentration bar 1502 at each discharge rate condition, representing the baseline condition without Ph2Te2 additive. The 0 M concentration bar 1502 corresponds to the baseline capacity bar 1402 described previously with reference to FIG. 14, establishing a reference point against which the capacity improvements achieved by the Diphenyl ditelluride redox mediator may be compared. At each of the 0.1 C, 0.5 C, and 1 C discharge rates, the 0 M concentration bar 1502 reflects the capacity limitations arising from sluggish reaction kinetics of the lithium polysulfide 1310 and accumulation of inactive lithium sulfide 1312 on the cathode surface in the absence of redox mediator additives.

With continued reference to FIG. 15, a 0.10 M concentration bar 1504 shows capacity with 0.10 M Ph2Te2 concentration at each discharge rate. The 0.10 M concentration bar 1504 demonstrates capacity enhancement relative to the 0 M concentration bar 1502 across all three discharge rate conditions. In one embodiment, the redox mediator is present at a concentration between about 0.10 M and 0.30 M, with the 0.10 M concentration representing the lower end of this concentration range. The capacity improvement shown by the 0.10 M concentration bar 1504 indicates that even at the lower concentration limit, the Diphenyl ditelluride redox mediator provides enhanced conversion of the lithium polysulfide 1310 to the lithium sulfide 1312 through the electron transfer mechanism described with reference to the redox mediator system 1300.

A 0.20 M concentration bar 1506 indicates capacity at 0.20 M Ph2Te2 concentration at each discharge rate condition shown in the concentration dependency graph 1500. The 0.20 M concentration bar 1506 demonstrates further capacity enhancement relative to both the 0 M concentration bar 1502 and the 0.10 M concentration bar 1504. The 0.20 M concentration represents an intermediate concentration within the range between about 0.10 M and 0.30 M. In one embodiment, the redox mediator is soluble in the solvent system and undergoes reversible oxidation and reduction during battery cycling, enabling the Diphenyl ditelluride to continuously shuttle electrons between the conductive surface 1302 and the lithium polysulfide 1310 species throughout multiple charge-discharge cycles.

The concentration dependency graph 1500 further includes a 0.30 M concentration bar 1508 representing capacity at 0.30 M Ph2Te2 concentration. The 0.30 M concentration bar 1508 represents the upper end of the concentration range between about 0.10 M and 0.30 M. As shown in FIG. 15, the 0.30 M concentration bar 1508 demonstrates capacity enhancement at each of the 0.1 C, 0.5 C, and 1 C discharge rates. The capacity values represented by the 0.30 M concentration bar 1508 indicate that increasing the redox mediator concentration to 0.30 M provides capacity enhancement (compared to the 0 M concentration bar 1502), and that cell capacity may be tuned by adjusting the Ph2Te2 concentration within the electrolyte system.

With continued reference to FIG. 15, the concentration dependency graph 1500 demonstrates that adding Ph2Te2 increases capacity by approximately 15% at all C-rates. The approximately 15% capacity increase is observed across the discharge rate range from 0.1 C to 1 C, indicating that the capacity enhancement provided by the Diphenyl ditelluride redox mediator is maintained across varying discharge conditions. In one embodiment, the solvent system comprises an ether-based solvent and the redox mediator remains electrochemically active across multiple charge-discharge cycles, enabling sustained capacity enhancement throughout the operational lifetime of the lithium-sulfur battery.

The concentration dependency graph 1500 illustrates that the capacity enhancement achieved by the Diphenyl ditelluride redox mediator may be adjusted by varying the concentration of the redox mediator within the electrolyte 1304. At each discharge rate condition, the progression from the 0 M concentration bar 1502 through the 0.10 M concentration bar 1504, the 0.20 M concentration bar 1506, and the 0.30 M concentration bar 1508 demonstrates increased capacity with increasing redox mediator concentration compared to the 0 M concentration bar 1502. This concentration-dependent behavior enables optimization of the electrolyte system for specific lithium-sulfur battery applications by selecting the appropriate Ph2Te2 concentration within the range between about 0.10 M and 0.30 M.

In various embodiments, the redox mediator concentration may be adjusted in combination with other electrolyte parameters to optimize the overall performance of the lithium-sulfur battery. The solvent system comprising an ether-based solvent provides a medium in which the Diphenyl ditelluride redox mediator remains soluble and electrochemically active. The lithium ion-transporting compound comprising a lithium salt such as lithium bis(trifluoromethanesulfonyl)imide (LiTFSI), as described previously, provides ionic conductivity within the electrolyte 1304. The relative concentrations of the redox mediator and the lithium salt may be adjusted to achieve the desired balance of electron transfer mediation and ionic transport.

In various embodiments, the concentration dependency demonstrated in the concentration dependency graph 1500 may be leveraged to design electrolyte systems tailored for specific lithium-sulfur battery applications. For applications in unmanned aerial systems where high energy density and capacity are desired, higher concentrations of the Diphenyl ditelluride redox mediator within the range between about 0.10 M and 0.30 M may be employed. The redox mediator remains electrochemically active across multiple charge-discharge cycles, enabling the capacity enhancement to be maintained throughout the operational lifetime of the battery in demanding applications.

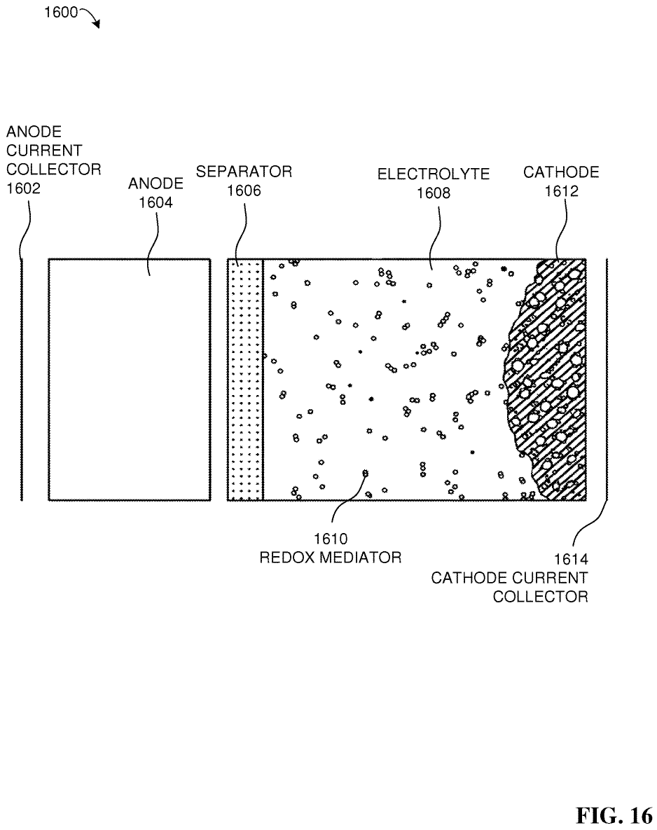

FIG. 16 illustrates a lithium-sulfur battery cell 1600, in accordance with one embodiment. As an option, the lithium-sulfur battery cell 1600 may be implemented in the context of any one or more of the embodiments set forth in any previous and/or subsequent Figures and/or description thereof. Of course, however, the lithium-sulfur battery cell 1600 may be implemented in the context of any desired environment. Further, the aforementioned definitions may equally apply to the description below.

As shown, the lithium-sulfur battery cell 1600 includes an anode current collector 1602 positioned at one end of the lithium-sulfur battery cell 1600. The anode current collector 1602 provides electrical connection between an anode 1604 and external circuitry, enabling electron flow during charge and discharge operations.

The lithium-sulfur battery cell 1600 further includes the anode 1604 positioned adjacent to the anode current collector 1602. In one embodiment, the anode 1604 comprises lithium metal that serves as the source of lithium ions during discharge and the destination for lithium ions during charge. The anode 1604 provides the lithium ions that combine with sulfur species at the cathode 1612 to form the lithium polysulfide 1310 and the lithium sulfide 1312 described previously with reference to the redox mediator system 1300.

With continued reference to FIG. 16, a separator 1606 is positioned adjacent to the anode 1604 and serves to physically separate the anode 1604 from a cathode 1612 while permitting ion transport between the anode 1604 and the cathode 1612. The separator 1606 prevents direct electrical contact between the anode 1604 and the cathode 1612, which would result in short-circuiting of the lithium-sulfur battery cell 1600. In one embodiment, the separator 1606 comprises a porous polymeric membrane that allows lithium ions to pass through while blocking electron flow. The separator 1606 may be wetted with an electrolyte 1608 to enable ionic conduction between the anode 1604 and the cathode 1612.

The lithium-sulfur battery cell 1600 includes the electrolyte 1608 that occupies the region between the separator 1606 and the cathode 1612. The electrolyte 1608 comprises a solvent system and at least one lithium ion-transporting compound, as described previously. In one embodiment, the solvent system comprises an ether-based solvent and the lithium ion-transporting compound comprises lithium bis(trifluoromethanesulfonyl)imide (LiTFSI). The solvent system may comprise 1,3-dioxolane (DOL), 1,2-dimethoxyethane (DME), or a combination thereof, providing a medium in which the lithium salt and redox mediator species remain soluble and electrochemically active.

As shown in FIG. 16, a redox mediator 1610 is distributed throughout the electrolyte 1608. The redox mediator 1610 is represented by various circular symbols dispersed within the electrolyte 1608, indicating the presence of phenyl-based chalcogenide compounds that facilitate electron transfer between conductive surfaces and the lithium polysulfide 1310 during discharge.

In one embodiment, the redox mediator 1610 comprises at least one phenyl-based chalcogenide compound selected from the group consisting of Diphenyl sulfide (Ph2S), Diphenyl diselenide (Ph2Se2), and Diphenyl ditelluride (Ph2Te2). The redox mediator 1610 has a redox potential proximate to the Li—S redox potential of approximately 2.15V and facilitates the conversion of the lithium polysulfide 1310 to the lithium sulfide 1312, thereby improving reaction kinetics and increasing cell capacity as demonstrated in the bar chart 1400 and the concentration dependency graph 1500.

The lithium-sulfur battery cell 1600 further includes the cathode 1612 positioned toward the opposing end of the lithium-sulfur battery cell 1600 from the anode 1604. As depicted in FIG. 16, the cathode 1612 is shown with a cross-hatched pattern indicating the material composition of the cathode 1612. In one embodiment, the cathode 1612 comprises a sulfur-based active material and a carbon-based conductive material. The sulfur-based active material provides the electrochemically active sulfur species that undergo reduction during discharge to form the lithium polysulfide 1310 and the lithium sulfide 1312. The carbon-based conductive material provides electrical conductivity within the cathode 1612, enabling electron transfer to the sulfur-based active material.

With continued reference to FIG. 16, a cathode current collector 1614 is positioned adjacent to the cathode 1612 at the opposing end of the lithium-sulfur battery cell 1600 from the anode current collector 1602. The cathode current collector 1614 provides electrical connection between the cathode 1612 and external circuitry, enabling electron flow to and from the cathode 1612 during charge and discharge operations. The cathode current collector 1614 functions analogously to the conductive surface 1302 described previously with reference to the redox mediator system 1300, providing electrons to the oxidized redox mediator 1306 during discharge.

In one embodiment, the cathode 1612 comprises a portion of the phenyl-based chalcogenide compound incorporated into the cathode 1612 during fabrication, such that the redox mediator 1610 is distributed both within the cathode 1612 and dissolved in the solvent system. The redox mediator 1610 may be directly added to the cathode 1612 during cathode fabrication instead of being added as an electrolyte additive, providing an alternative incorporation method. When the phenyl-based chalcogenide compound is incorporated into the cathode 1612 during fabrication, the redox mediator 1610 may be positioned in close proximity to the sulfur-based active material, enabling localized electron transfer mediation at the cathode 1612 surface.

The distribution of the redox mediator 1610 within the electrolyte 1608 enables the electron transfer mechanism described previously with reference to the redox mediator system 1300. The redox mediator 1610 undergoes reduction at the cathode 1612 surface to form the reduced redox mediator 1308, which diffuses through the electrolyte 1608 to contact the lithium polysulfide 1310 species that are not in direct contact with the cathode current collector 1614. Upon transferring electrons to the lithium polysulfide 1310, the reduced redox mediator 1308 regenerates to the oxidized redox mediator 1306, which may return to the cathode 1612 surface to repeat the electron shuttling cycle.

The lithium-sulfur battery cell 1600 may be configured in a coin cell format or a pouch cell format for testing and operation. In the coin cell format, the anode current collector 1602, the anode 1604, the separator 1606, the electrolyte 1608 containing the redox mediator 1610, the cathode 1612, and the cathode current collector 1614 are assembled within a coin-shaped housing that provides mechanical support and electrical isolation, enabling laboratory-scale testing and evaluation of the capacity enhancement provided by the phenyl-based chalcogenide redox mediators. In the pouch cell format, the components are assembled within a flexible pouch housing that provides a lightweight and compact form factor, enabling scaling to larger capacities suitable for applications such as unmanned aerial systems and electric vehicles. The redox mediator 1610 distributed within the electrolyte 1608 operates analogously in both formats, facilitating conversion of the lithium polysulfide 1310 to the lithium sulfide 1312 through the electron transfer mechanism described previously.

The lithium-sulfur battery cell 1600 exemplifies a resolution to the prior art problem of limited polysulfide conversion arising from the insulating nature of the lithium sulfide 1312 discharge product. Prior lithium-sulfur battery configurations relied on direct electron transfer from the cathode 1612 surface to the lithium polysulfide 1310 species, which limited conversion to species in physical contact with conductive surfaces. The lithium-sulfur battery cell 1600 incorporating the redox mediator 1610 within the electrolyte 1608 overcomes this limitation by enabling electron transfer to the lithium polysulfide 1310 species throughout the electrolyte 1608 volume.

The lithium-sulfur battery cell 1600 further addresses the prior art limitation of capacity degradation arising from accumulation of inactive lithium sulfide 1312 on the cathode 1612 surface. By facilitating conversion of the lithium polysulfide 1310 throughout the electrolyte 1608 rather than solely at the cathode 1612 surface, the redox mediator 1610 distributes the formation of the lithium sulfide 1312 more uniformly and reduces localized passivation of the cathode 1612. The capacity enhancement demonstrated in the bar chart 1400 and the concentration dependency graph 1500 reflects the improved active material utilization achieved through the redox mediator mechanism.

In various embodiments, the lithium-sulfur battery cell 1600 may be modified to incorporate different configurations of the redox mediator 1610 distribution. The redox mediator 1610 may be incorporated solely within the electrolyte 1608 as an electrolyte additive, solely within the cathode 1612 during cathode fabrication, and/or distributed between both the electrolyte 1608 and the cathode 1612. The distribution of the redox mediator 1610 may be selected based on the specific performance requirements and/or manufacturing considerations for the lithium-sulfur battery cell 1600.

In various embodiments, the concentration of the redox mediator 1610 within the electrolyte 1608 may be adjusted within the range between about 0.10 M and 0.30 M as demonstrated in the concentration dependency graph 1500. The 0.10 M concentration bar 1504, the 0.20 M concentration bar 1506, and the 0.30 M concentration bar 1508 demonstrate that capacity enhancement may be achieved across this concentration range. The concentration of the redox mediator 1610 may be selected to balance capacity enhancement with other electrolyte properties such as viscosity and/or ionic conductivity within the lithium-sulfur battery cell 1600.

In various embodiments, the lithium-sulfur battery cell 1600 may be combined with other cell design modifications to further enhance performance. The cathode 1612 may incorporate various carbon-based conductive materials including carbon black, carbon nanotubes, and/or graphene to enhance electrical conductivity. The separator 1606 may incorporate coatings and/or modifications to reduce polysulfide shuttling between the cathode 1612 and the anode 1604. The electrolyte 1608 may incorporate additional additives such as lithium nitrate to stabilize the anode 1604 surface. These modifications may be combined with the redox mediator 1610 to achieve synergistic performance improvements in the lithium-sulfur battery cell 1600.

FIG. 17-1, FIG. 17-2, and FIG. 17-3 illustrate chemical structure diagrams of phenyl-based chalcogenide compounds that function as redox mediators, in accordance with one embodiment. As an option, the chemical structure diagrams may be implemented in the context of any one or more of the embodiments set forth in any previous and/or subsequent Figures and/or description thereof. Of course, however, the chemical structure diagrams may be implemented in the context of any desired environment. Further, the aforementioned definitions may equally apply to the description below.

Referring to FIGS. 17-1, 17-2, and 17-3, the three phenyl-based chalcogenide compounds each share a common molecular architecture featuring two phenyl rings linked through a chalcogen-chalcogen bond. FIG. 17-1 depicts Diphenyl Disulfide (Ph2S2), in which two phenyl rings are connected by a disulfide bond (—S—S—) formed by two sulfur atoms. FIG. 17-2 depicts Diphenyl Diselenide (Ph2Se2), in which two phenyl rings are connected by a diselenide bond (—Se—Se—) formed by two selenium atoms. FIG. 17-3 depicts Diphenyl Ditelluride (Ph2Te2), in which two phenyl rings are connected by a ditelluride bond (—Te—Te—) formed by two tellurium atoms. In each compound, the phenyl groups are positioned on opposite ends of the chalcogen-chalcogen bond, with each phenyl ring comprising a six-membered aromatic carbon ring.

The chalcogen-chalcogen bond in each compound provides a redox-active center that undergoes reversible oxidation and reduction at potentials between about 2.0V and 2.3V vs. Li/Li+, proximate to the Li—S redox potential of approximately 2.15V. The phenyl ring substituents provide solubility characteristics that enable each compound to dissolve in ether-based solvent systems comprising 1,3-dioxolane (DOL), 1,2-dimethoxyethane (DME), or combinations thereof, and to remain electrochemically active across multiple charge-discharge cycles. In one embodiment, each compound undergoes reduction at the cathode surface to cleave the respective chalcogen-chalcogen bond and form reduced chalcogenide species—reduced sulfide species from Diphenyl Disulfide, reduced selenide species from Diphenyl Diselenide, and reduced telluride species from Diphenyl Ditelluride—that diffuse through the solvent system to mediate electron transfer to lithium polysulfides not in direct contact with a current collector.

The chalcogen element varies from sulfur to selenium to tellurium progressing down the chalcogen group of the periodic table, resulting in different bond energies and electron transfer kinetics for each compound.

The three chemical structures depicted in FIG. 17-1, FIG. 17-2, and FIG. 17-3 share a common molecular architecture featuring two benzene rings linked through a chalcogen-chalcogen bond, with the chalcogen element varying from sulfur to selenium to tellurium moving down the periodic table group. This structural similarity enables comparison of the electrochemical performance of the three phenyl-based chalcogenide compounds as redox mediators in lithium-sulfur batteries. The progression from sulfur to selenium to tellurium corresponds to the trend of increasing capacity enhancement observed in the comparative data (such as shown in FIG. 14), indicating that the identity of the chalcogen element influences the effectiveness of the redox mediator in facilitating lithium polysulfide conversion.

In various embodiments, alternative chalcogenide compounds may be employed as redox mediators for improving reaction kinetics in lithium-sulfur batteries. The redox mediator may comprise Dimethyl Sulfide as an alternative chalcogenide compound, in which two methyl groups replace the phenyl groups of Diphenyl Disulfide. The redox mediator may comprise Dimethyl Selenide as an alternative chalcogenide compound, in which two methyl groups are bonded to a single selenium atom. The substitution of methyl groups for phenyl groups modifies the solubility characteristics and molecular weight of the redox mediator compound while maintaining the chalcogen-based redox-active center.

In various embodiments, the redox mediator may comprise Dimethyl diselenide as an alternative chalcogenide compound for improving reaction kinetics in lithium-sulfur batteries. Dimethyl diselenide features two methyl groups connected by a diselenide bond formed by two selenium atoms, providing a molecular architecture analogous to Diphenyl Diselenide with reduced molecular weight. The redox mediator may comprise Dimethyl ditelluride as an alternative chalcogenide compound, in which two methyl groups are connected by a ditelluride bond formed by two tellurium atoms. The methyl-substituted chalcogenide compounds may exhibit different solubility characteristics and/or diffusion rates within the electrolyte compared to the phenyl-substituted compounds.

In various embodiments, the redox mediator may comprise Diethyl telluride as an alternative chalcogenide compound for improving reaction kinetics in lithium-sulfur batteries. Diethyl telluride features two ethyl groups bonded to a single tellurium atom, providing a tellurium-based redox-active center with alkyl substituents. The redox mediator may comprise Tellurophene as an alternative chalcogenide compound, in which a tellurium atom is incorporated into a five-membered aromatic ring structure. Tellurophene provides a cyclic molecular architecture in which the tellurium atom forms part of the aromatic ring system, differing from the acyclic structures of the diphenyl and dialkyl chalcogenide compounds. These alternative chalcogenide compounds may be employed individually and/or in combination with the phenyl-based chalcogenide compounds to achieve desired electrochemical characteristics for redox mediation in lithium-sulfur batteries.

Notwithstanding the above discussion, it is to be appreciated that other compounds (beyond those shown in FIGS. 17-1, 17-2, and 17-3) may be used as redox mediators within the context of the present description. For example, in various embodiments, the redox mediator may comprise alternative chalcogenide compounds such as but not limited to alkyl-substituted chalcogenide compounds such as Dimethyl Sulfide, Dimethyl Selenide, Dimethyl diselenide (DMDSe), Dimethyl ditelluride (DMDTe), and/or Diethyl telluride, in which methyl or ethyl groups replace the phenyl groups while maintaining the chalcogen-based redox-active center. The redox mediator may also comprise cyclic chalcogenide compounds such as Tellurophene, in which a tellurium atom is incorporated into a five-membered aromatic ring structure. Additionally, the redox mediator may comprise aryl-substituted chalcogenide compounds such as Diphenyl diselenide (DPDSe) and Diphenyl ditelluride (DPDTe), as well as mixed organochalcogenide compounds comprising combinations of different chalcogen elements and/or different organic substituents. These alternative chalcogenide compounds may be employed individually, in combination with one another, and/or in combination with the phenyl-based chalcogenide compounds depicted in FIGS. 17-1, 17-2, and 17-3 to achieve desired redox potentials, solubility characteristics, diffusion rates, and/or electron transfer kinetics for mediating lithium polysulfide conversion in lithium-sulfur battery electrolyte systems.

### Additional Embodiments

In various embodiments, the redox mediator system 1300 may operate during both discharge and charge processes of the lithium-sulfur battery. During the charge process, the redox mediator may facilitate the reverse conversion, mediating oxidation of lithium sulfide 1312 back to lithium polysulfide 1310 species. In the charge direction, the oxidized redox mediator 1306 may diffuse through the electrolyte 1304 to contact lithium sulfide 1312 particles and mediate electron removal therefrom, converting the lithium sulfide 1312 to lithium polysulfide 1310 intermediates. The reduced redox mediator 1308 generated during this charge-direction electron transfer may then return to the conductive surface 1302 to be re-oxidized, completing the reverse catalytic cycle. This bidirectional mediation capability enables the redox mediator to improve both discharge capacity and charge efficiency of the lithium-sulfur battery.

In various embodiments, the redox mediator 1610 may transfer electrons between the cathode current collector 1614 and both lithium polysulfide 1310 species and isolated lithium sulfide 1312 particles as distinct electrochemical targets. The lithium polysulfide 1310 species represent intermediate sulfur compounds formed during discharge that may be further reduced to lithium sulfide 1312, while the isolated lithium sulfide 1312 particles represent previously deposited discharge products that have become electrically disconnected from the conductive surface. The redox mediator 1610 may access both types of species through diffusion within the electrolyte 1608, thereby increasing the overall conversion ability of the lithium-sulfur battery cell 1600 and enabling more complete utilization of the sulfur-based active material within the cathode 1612.

In various embodiments, the phenyl-based chalcogenide compound may be incorporated directly into the cathode 1612 during cathode fabrication as an alternative to or in addition to incorporation as an electrolyte additive. When the redox mediator 1610 is added to the cathode 1612 during fabrication, the effects on cell performance may vary depending on the cathode processing conditions, including temperature, mixing parameters, and/or the composition of other cathode components such as binders and conductive additives. The cathode processing conditions may influence the distribution, chemical stability, and/or electrochemical accessibility of the phenyl-based chalcogenide compound within the cathode 1612 structure.

In various embodiments, the phenyl-based chalcogenide redox mediators may be compatible with various electrolyte formulations beyond the exemplary DOL/DME/LiTFSI system described herein. The redox mediators may be employed in different electrolyte formulations comprising alternative ether-based solvents, alternative lithium salts, and/or additional electrolyte additives, with the redox mediation mechanism operating analogously across different formulations provided that the redox mediator remains soluble and electrochemically active within the selected solvent system. The selection of the electrolyte formulation may be tailored based on the specific performance requirements, operating conditions, and/or cell format of the lithium-sulfur battery application.

In various embodiments, cell capacity may be tuned further by adjusting the concentration of the phenyl-based chalcogenide redox mediator beyond the exemplary concentrations demonstrated in the concentration dependency graph 1500. While the concentration range between about 0.10 M and 0.30 M has been demonstrated to provide capacity enhancement, concentrations outside this range may also be employed depending on the specific cell design and performance requirements. The capacity tunability provided by the redox mediator concentration adjustment enables optimization of the electrolyte system for specific lithium-sulfur battery applications where different balances of capacity enhancement, electrolyte viscosity, and/or ionic conductivity may be desired.

In various embodiments, the redox mediator may be present at a concentration below about 0.10 M or above about 0.30 M. For example, the redox mediator may be present at a concentration between about 0.01 M and about 0.40 M. Concentrations below about 0.10 M may provide moderate capacity enhancement while minimizing the impact of the redox mediator on electrolyte viscosity and/or ionic conductivity. Concentrations above about 0.30 M and up to about 0.40 M may provide additional capacity enhancement in cell designs where higher redox mediator loading is compatible with the solvent system and lithium ion-transporting compound concentrations. The selection of the redox mediator concentration within the broader range from about 0.01 M to about 0.40 M may be based on the specific cell format, discharge rate requirements, solvent system composition, and/or desired balance between capacity enhancement and electrolyte transport properties.

### Use Case Scenario

In various embodiments, the phenyl-based chalcogenide redox mediators disclosed herein may enable significant advancements across multiple industries where high-energy-density battery systems are critical to operational performance and commercial viability.

In various embodiments, unmanned aerial system (UAS) manufacturers may benefit from the capacity enhancements provided by the redox mediator technology, as increased energy density directly translates to extended flight duration, expanded operational range, and improved payload capacity for commercial drone applications including logistics, surveillance, and infrastructure inspection.

In various embodiments, electric vehicle (EV) manufacturers may leverage the improved lithium-sulfur battery performance enabled by the redox mediators to achieve longer driving ranges, reduced battery pack weight, and lower material costs compared to conventional lithium-ion chemistries, thereby accelerating adoption of next-generation energy storage in the automotive sector.

In various embodiments, grid-scale energy storage providers may utilize the enhanced cycle efficiency and capacity retention provided by the phenyl-based chalcogenide redox mediators to improve the economic viability of stationary storage installations, enabling more effective integration of renewable energy sources and supporting grid stability applications where high energy throughput and long operational lifetimes are essential.

### Improvements Over Existing Systems

The present disclosure addresses significant challenges in lithium-sulfur battery technology that have limited the practical implementation of these high-energy-density systems. Prior art solutions have struggled to effectively manage the sluggish reaction kinetics of lithium polysulfides and the accumulation of inactive Li2S on cathode surfaces during discharge. These conventional systems face fundamental limitations arising from the insulating nature of Li2S, which creates a barrier to electron transfer for Li2S particles that are not in direct physical contact with conductive surfaces. As a result, prior approaches relying on direct electron transfer from the cathode surface have failed to achieve complete utilization of the active sulfur material, with portions of the electrochemically active material becoming inaccessible and reducing the practical capacity that can be extracted from the cell. Academic researchers and industry participants have attempted to address these kinetic limitations through strategies such as catalysis and electrolyte tuning, but these methods have not fully resolved the underlying problems associated with polysulfide conversion and Li2S utilization, leaving lithium-sulfur batteries unable to approach their theoretical specific capacity of approximately 1675 mAh/g.

The disclosed electrolyte system overcomes these deficiencies through the employment of phenyl-based chalcogenide compounds, such as including but not limited solely to Diphenyl sulfide (Ph2S), Diphenyl diselenide (Ph2Se2), and Diphenyl ditelluride (Ph2Te2), as redox mediators, which, in various embodiments, may possess redox potentials close to the Li—S redox potential of approximately 2.15V. By undergoing reduction at the cathode surface and subsequently diffusing through the electrolyte to mediate electron transfer to lithium polysulfides and isolated Li2S particles not in direct contact with the current collector, the phenyl-based chalcogenide redox mediators provide an alternative electron transfer pathway that enables conversion of lithium polysulfide species throughout the electrolyte volume rather than solely at the cathode surface. This mechanism facilitates the conversion of lithium polysulfides to Li2S, thereby improving reaction kinetics and increasing active material utilization.

The disclosed system achieves capacity enhancement of approximately 15% across discharge rates ranging from 0.1 C to 1 C, with Diphenyl ditelluride demonstrating superior performance among the tested mediators. Furthermore, the redox mediators remain electrochemically active across multiple charge-discharge cycles, providing sustained capacity enhancement throughout the operational lifetime of the battery while reducing the accumulation of inactive Li2S that has plagued prior art systems.

### System Implementation Embodiments

A number of implementations have been described. Nevertheless, it will be understood that various modifications may be made without departing from the spirit and scope of the disclosure. Accordingly, other implementations are within the scope of the following claims.

What is claimed is:

1. An electrolyte system for a lithium-sulfur battery, comprising:
a solvent system;
at least one redox mediator comprising a phenyl-based chalcogenide compound selected from the group consisting of Diphenyl sulfide (Ph2S), Diphenyl diselenide (Ph2Se2), and Diphenyl ditelluride (Ph2Te2); and
at least one lithium ion-transporting compound,
wherein the redox mediator facilitates conversion of lithium polysulfides to Li₂S.

2. The electrolyte system of claim 1, wherein the phenyl-based chalcogenide compound comprises Diphenyl ditelluride (Ph2Te2).

3. The electrolyte system of claim 1, wherein the phenyl-based chalcogenide compound comprises Diphenyl diselenide (Ph2Se2).

4. The electrolyte system of claim 1, wherein the phenyl-based chalcogenide compound comprises Diphenyl sulfide (Ph2S).

5. The electrolyte system of claim 1, wherein the redox mediator has a redox potential between about 2.OV and 2.3V vs. Li/Li+.

6. The electrolyte system of claim 1, wherein the redox mediator is soluble in the solvent system.

7. The electrolyte system of claim 1, wherein the lithium ion-transporting compound comprises a lithium salt.

8. The electrolyte system of claim 1, wherein the redox mediator is present at a concentration between about 0.10 M and 0.30 M.

9. The electrolyte system of claim 1, wherein the redox mediator acts as an electron transfer agent between a conductive cathode surface and lithium polysulfides.

10. The electrolyte system of claim 1, wherein the redox mediator undergoes reduction to form a reduced species that diffuses through the solvent system to reduce lithium polysulfides.

11. The electrolyte system of claim 2, wherein the Diphenyl ditelluride undergoes reduction at the cathode surface to form a reduced telluride species that mediates electron transfer to lithium polysulfides.

12. The electrolyte system of claim 5, wherein the redox mediator is soluble in the solvent system and undergoes reversible oxidation and reduction during battery cycling.

13. The electrolyte system of claim 1, wherein the solvent system comprises an ether-based solvent and the lithium ion-transporting compound comprises at least one lithium salt selected from the group consisting of lithium bis(trifluoromethanesulfonyl)imide (LiTFSI), lithium bis(fluorosulfonyl)imide (LiFSI), lithium Perchlorate (LiClO4), lithium nitrate (LiNO3), and combinations thereof.

14. The electrolyte system of claim 6, wherein the reduced species of the redox mediator diffuses through the solvent system to contact lithium polysulfides not in direct contact with a current collector.

15. The electrolyte system of claim 1, wherein the redox mediator increases active material utilization by facilitating electron transfer to isolated Li2S particles.

16. The electrolyte system of claim 2, wherein the solvent system comprises 1,3-dioxolane (DOL), 1,2-dimethoxyethane (DME), or a combination thereof.

17. The electrolyte system of claim 1, wherein the redox mediator reduces accumulation of inactive Li2S on a cathode during discharge and improves reaction kinetics of lithium polysulfide conversion.

18. The electrolyte system of claim 8, wherein the solvent system comprises an ether-based solvent and the redox mediator remains electrochemically active across multiple charge-discharge cycles.

19. The electrolyte system of claim 1, wherein the electrolyte system maintains capacity enhancement across discharge rates ranging from 0.02 C to 2 C.

20. The electrolyte system of claim 1, further comprising a cathode in contact with the electrolyte system, wherein the cathode comprises a sulfur-based active material, a carbon-based conductive material, and a portion of the phenyl-based chalcogenide compound incorporated into the cathode during fabrication, such that the redox mediator is distributed both within the cathode and dissolved in the solvent system.

21. The electrolyte system of claim 1, wherein the electrolyte system further comprises at least one additional redox mediator selected from the group consisting of Dimethyl Sulfide, Dimethyl Selenide, Dimethyl diselenide, Dimethyl ditelluride, Diethyl telluride, Tellurophene, and combinations thereof.
